(19) United States
(12) Patent Application Publication
(10) Pub. No.: US 2025/0348897 A1
(43) Pub. Date: Nov. 13, 2025

(54) FORECASTING USING TOPOLOGICAL HIERARCHICAL DECOMPOSITION

(71) Applicant: Mined XAI LLC, Dayton, OH (US)

(72) Inventors: Ryan Kramer, Bellbrook, OH (US); Kyle Siegrist, Cincinnati, OH (US)

(73) Assignee: Mined XAI LLC, Dayton, OH (US)

(21) Appl. No.: 19/201,891

(22) Filed: May 7, 2025

Related U.S. Application Data
(60) Provisional application No. 63/643,892, filed on May 7, 2024.

(51) Int. Cl. G06Q 30/0202; G06F 17/16; G06Q 10/087

(52) U.S. Cl. CPC G06Q 30/0202; G06F 17/16; G06Q 10/087

(57) ABSTRACT

An example computer-implemented method for temporal data analysis and forecasting utilizes topological hierarchical decompositions to process historical and future time windows. The method receives temporal data and generates multiple sets of historical time subsets with varying lengths, where information in shorter subsets is duplicated in longer ones. Future time windows are also generated in a similar manner. Future time windows are chronologically after a given initial time. The method creates past and future topological hierarchical decompositions and directed graph adjacency arrays. Customer attention matrices are generated for past and future windows, and matrix multiplications are performed to create self-attention arrays. These arrays are then multiplied together. The method culminates in providing a dashboard for forecasting demand after an initial time point, enabling comprehensive temporal data analysis and prediction.

### CROSS-REFERENCE TO RELATED APPLICATION

This application claims priority to U.S. Provisional Patent Application No. 63/643,892, filed on May 7, 2024, and entitled “Forecasting using Topological Hierarchical Decomposition,” which is incorporated in its entirety herein by reference.

### FIELD OF THE INVENTION(S)

Embodiments of the present invention(s) are generally related to insight discovery using artificial intelligence approaches for forecasting and in particular, to generating component-connected architectures of underlying data to generate explainable insights for forecasting.

### BACKGROUND

As the collection and storage of data have increased, there is an increased need to analyze the data for explainable insights. Examples of large datasets may be found in financial services companies, flavor analysis, biotech, and academia. Unfortunately, previous methods of analysis of large multidimensional datasets tend to be insufficient (if possible at all) to identify important relationships.

Previous methods of analysis often use clustering. Clustering is generally too blunt an instrument to identify important relationships in the data (i.e., inherent relationships in the data may be lost within the analysis or noise created by the approach). Similarly, linear regression, projection pursuit, principal component analysis, and multidimensional scaling often do not reveal important relationships. Existing linear algebraic and analytic methods are too sensitive to large-scale distances and, as a result, lose detail.

### SUMMARY

An example non-transitory computer-readable medium comprises executable instructions. The executable instructions may be executable by one or more processors to perform a method. An example method may comprise receiving information with temporal data, initial time, and a time unit, the temporal data including any information with time data over a duration, generating historical time windows including a first set of historical time subsets each of a first length, and a second set of historical time subsets each of a second length, the second length being longer than the first length, the information contained in both the first set of historical time subsets being duplicated in the second set of historical time subsets, the first set of historical time subsets including a consecutive number of non-overlapping historical time subsets ending in the initial time, each of the first set of historical time subsets being of the first length equal to the time unit, the second set of historical time subsets including overlapping historical time subsets ending in the initial time, the first subset of the second set of historical time subsets ending at the initial time and the second subset of the second set of historical time subsets ending at the duration of a time unit before the initial time, the information contained in the first subset and the second subset of the second set of historical time subsets including at least one unit of duplicate information, the historical time windows including information being chronologically before the initial time, generating future time windows including a first set of future time subsets each of the first length, the first set of future time subsets including a consecutive number of non-overlapping future time subsets beginning at the initial time, each of the first set of future time subsets being of the first length equal to the time unit, the first set of future time subsets including information being chronologically after the initial time, creating past topological hierarchical decompositions for the first set of historical time subsets and the second set of historical time subsets, creating future topological hierarchical decompositions for the first set of future time subsets, creating a past directed graph adjacency array using weights derived from a distance as applied to embeddings from the past topological hierarchical decompositions, and creating a future directed graph adjacency array using weights derived from the distance as applied to embeddings from the future topological hierarchical decompositions, generating a past window customer attention matrix identifying entity membership of groups across historical time subsets using the embeddings from the past topological hierarchical decompositions, and generating a future window customer attention matrix identifying the entity membership of groups across future time subsets using the embeddings from the future topological hierarchical decompositions, performing matrix multiplication to multiply the past window customer attention matrix to the past directed graph adjacency array and a transpose of the past window customer attention matrix to create a past customer self-attention array performing the matrix multiplication to multiply the future window customer attention matrix to the future directed graph adjacency array and a transpose of the future window customer attention matrix to create a future customer self-attention array, performing matrix multiplication of the past customer self-attention array to the future customer self-attention array, and providing a dashboard forecasting demand after the initial time.

In some embodiments, the information with temporal data includes a plurality of customers over time as well as customer purchasing of a plurality of products, the dashboard forecasting demand including a forecast of demand based on purchasing decisions over time before and after the initial time. The method may further comprise generating and providing an alert to a user when inventory is above a particular threshold or below a particular threshold based on forecasting to enable the user to purchase or not purchase one or more products based on forecasted demand such that inventory levels are not critically low or extremely high relative to demand.

In some embodiments, the method may further comprise receiving incentive offers from a manufacturer of at least one product, the incentive offering a bonus for sales of the at least one product and generating and providing an alert to a user when forecasted demand for the at least one product is at or above an incentive threshold to enable the user to make changes to further increase sales of the at least one product. In various embodiments, the method may further comprise receiving a plurality of incentive offers from a plurality of manufacturer for volume sales of a plurality of products, each of the incentives of the plurality of incentive offers offering a bonus for sales of at least one product of the plurality of products, at least a subset of the plurality of incentive offers including different expiration dates after which a particular incentive is no longer available, for each of the plurality of incentive offers, identifying forecasted demand for the applicable product of the plurality of products, comparing forecasted demand for different products, and generating and providing an alert to a user when forecasted demand for at least one of the plurality of products is higher than the other products of the plurality of products before a particular expiration date expires.

The method may optionally further comprise receiving a plurality of incentive offers from a plurality of manufacturer for volume sales of a plurality of products, each of the incentives of the plurality of incentive offers offering a bonus for sales of at least one product of the plurality of products, at least a subset of the plurality of incentive offers including different expiration dates after which a particular incentive is no longer available, for each of the plurality of incentive offers, identifying forecasted demand for the applicable product of the plurality of products, comparing forecasted demand for different products, comparing overall incentive for a particular number of different products with high forecasted demand relative to forecasted demand of the different products, generating and providing an alert to a user when forecasted demand for at least one of the plurality of products is higher than the other products of the plurality of products before a particular expiration date expires and when the overall incentive if above an incentive threshold. Creating past topological hierarchical decompositions for the first set of historical time subsets may comprise projecting the information to a first embedding based on at least one metric, determining a first lowest cover resolution of the first embedding that identifies non-overlapping secondary coverings based on sets within one of the covers of the first embedding, identifying a branch point of a first connected-component network based on the non-overlapping secondary coverings, generating subsets from the branch point based on the non-overlapping secondary coverings, if a network generation threshold has not been met, then for each subset from the branch point, determining a second lowest cover resolution that identifies non-overlapping secondary coverings based on the sets within one of the covers of a particular subset to identify a new branch point and new subsets from that branch point of the first connected-component network, for each leaf of the connected-component network, identify embeddings of a feature space and generate a local object embedding space using a transposition of segmented features with related objects, adding coordinates of objects within each leaf of the local object embedding to a data array, projecting array data from the data array to a second embedding, determining a third lowest cover resolution of the second embedding that identifies non-overlapping secondary coverings based on sets within one of the covers of the second embedding, identifying a branch point of a second connected-component network based on the non-overlapping secondary coverings, generating subsets from the branch point based on the non-overlapping secondary coverings, if a network generation threshold has not been met, then for each subset from the branch point, determining a second lowest cover resolution that identifies non-overlapping secondary coverings based on the sets within one of the covers of a particular subset to identify a new branch point and new subsets from that branch point of the second connected-component network, and generating at least one past topological hierarchical decomposition.

In some embodiments, the method may further comprise generating the secondary coverings by determining, for each set that has data within the cover, a centroid and determining a radius based on the centroid that covers at least that particular set. The centroid for a particular set may be determined based on the data within that particular set.

An example system comprises at least one processor and memory containing instructions. The instructions being executable by the at least one processor to: receive information with temporal data, initial time, and a time unit, the temporal data including any information with time data over a duration, generate historical time windows including a first set of historical time subsets each of a first length, and a second set of historical time subsets each of a second length, the second length being longer than the first length, the information contained in both the first set of historical time subsets being duplicated in the second set of historical time subsets, the first set of historical time subsets including a consecutive number of non-overlapping historical time subsets ending in the initial time, each of the first set of historical time subsets being of the first length equal to the time unit, the second set of historical time subsets including overlapping historical time subsets ending in the initial time, the first subset of the second set of historical time subsets ending at the initial time and the second subset of the second set of historical time subsets ending at the duration of a time unit before the initial time, the information contained in the first subset and the second subset of the second set of historical time subsets including at least one unit of duplicate information, the historical time windows including information being chronologically before the initial time, generate future time windows including a first set of future time subsets each of the first length, the first set of future time subsets including a consecutive number of non-overlapping future time subsets beginning at the initial time, each of the first set of future time subsets being of the first length equal to the time unit, the first set of future time subsets including information being chronologically after the initial time, create past topological hierarchical decompositions for the first set of historical time subsets and the second set of historical time subsets, create future topological hierarchical decompositions for the first set of future time subsets, create a past directed graph adjacency array using weights derived from a distance as applied to embeddings from the past topological hierarchical decompositions, and creating a future directed graph adjacency array using weights derived from the distance as applied to embeddings from the future topological hierarchical decompositions, generate a past window customer attention matrix identifying entity membership of groups across historical time subsets using the embeddings from the past topological hierarchical decompositions, and generating a future window customer attention matrix identifying the entity membership of groups across future time subsets using the embeddings from the future topological hierarchical decompositions, perform matrix multiplication to multiply the past window customer attention matrix to the past directed graph adjacency array and a transpose of the past window customer attention matrix to create a past customer self-attention array, perform the matrix multiplication to multiply the future window customer attention matrix to the future directed graph adjacency array and a transpose of the future window customer attention matrix to create a future customer self-attention array, perform matrix multiplication of the past customer self-attention array to the future customer self-attention array, and provide a dashboard forecasting demand after the initial time.

The information with temporal data may include a plurality of customers over time as well as customer purchasing of a plurality of products, the dashboard forecasting demand including a forecast of demand based on purchasing decisions over time before and after the initial time. The instructions may be further executable by the at least one processor to generate and provide an alert to a user when inventory is above a particular threshold or below a particular threshold based on forecasting to enable the user to purchase or not purchase one or more products based on forecasted demand such that inventory levels are not critically low or extremely high relative to demand. In some embodiments, the instructions are further executable by the at least one processor to: receive incentive offers from a manufacturer of at least one product, the incentive offering a bonus for sales of the at least one product, and generate and provide an alert to a user when forecasted demand for the at least one product is at or above an incentive threshold to enable the user to make changes to further increase sales of the at least one product.

In some embodiments, the instructions are further executable by the at least one processor to: receive a plurality of incentive offers from a plurality of manufacturer for volume sales of a plurality of products, each of the incentives of the plurality of incentive offers offering a bonus for sales of at least one product of the plurality of products, at least a subset of the plurality of incentive offers including different expiration dates after which a particular incentive is no longer available, for each of the plurality of incentive offers, identify forecasted demand for the applicable product of the plurality of products, compare forecasted demand for different products and generate and provide an alert to a user when forecasted demand for at least one of the plurality of products is higher than the other products of the plurality of products before a particular expiration date expires. In some embodiments, the instructions are further executable by the at least one processor to: receive a plurality of incentive offers from a plurality of manufacturer for volume sales of a plurality of products, each of the incentives of the plurality of incentive offers offering a bonus for sales of at least one product of the plurality of products, at least a subset of the plurality of incentive offers including different expiration dates after which a particular incentive is no longer available, for each of the plurality of incentive offers, identify forecasted demand for the applicable product of the plurality of products, compare forecasted demand for different products, compare overall incentive for a particular number of different products with high forecasted demand relative to forecasted demand of the different products, and generate and provide an alert to a user when forecasted demand for at least one of the plurality of products is higher than the other products of the plurality of products before a particular expiration date expires and when the overall incentive if above an incentive threshold

The instructions may be executable by the at least one processor to create past topological hierarchical decompositions for the first set of historical time subsets comprises the instructions being executable by the at least one processor to: project the information to a first embedding based on at least one metric, determine a first lowest cover resolution of the first embedding that identifies non-overlapping secondary coverings based on sets within one of the covers of the first embedding, identify a branch point of a first connected-component network based on the non-overlapping secondary coverings, generate subsets from the branch point based on the non-overlapping secondary coverings, if a network generation threshold has not been met, then for each subset from the branch point, determine a second lowest cover resolution that identifies non-overlapping secondary coverings based on the sets within one of the covers of a particular subset to identify a new branch point and new subsets from that branch point of the first connected-component network, for each leaf of the connected-component network, identify embeddings of a feature space and generate a local object embedding space using a transposition of segmented features with related objects, add coordinates of objects within each leaf of the local object embedding to a data array, project array data from the data array to a second embedding, determine a third lowest cover resolution of the second embedding that identifies non-overlapping secondary coverings based on sets within one of the covers of the second embedding, identify a branch point of a second connected-component network based on the non-overlapping secondary coverings, generate subsets from the branch point based on the non-overlapping secondary coverings, if a network generation threshold has not been met, then for each subset from the branch point, determine a second lowest cover resolution that identifies non-overlapping secondary coverings based on the sets within one of the covers of a particular subset to identify a new branch point and new subsets from that branch point of the second connected-component network, and generate at least one past topological hierarchical decomposition.

In some embodiments, the instructions are further executable by the at least one processor to: generate the secondary coverings by determining, for each set that has data within the cover, a centroid and determining a radius based on the centroid that covers at least that particular set. The centroid for a particular set may be determined based on the data within that particular set.

An example method comprises: receiving information with temporal data, initial time, and a time unit, the temporal data including any information with time data over a duration, generating historical time windows including a first set of historical time subsets each of a first length, and a second set of historical time subsets each of a second length, the second length being longer than the first length, the information contained in both the first set of historical time subsets being duplicated in the second set of historical time subsets, the first set of historical time subsets including a consecutive number of non-overlapping historical time subsets ending in the initial time, each of the first set of historical time subsets being of the first length equal to the time unit, the second set of historical time subsets including overlapping historical time subsets ending in the initial time, the first subset of the second set of historical time subsets ending at the initial time and the second subset of the second set of historical time subsets ending at the duration of a time unit before the initial time, the information contained in the first subset and the second subset of the second set of historical time subsets including at least one unit of duplicate information, the historical time windows including information being chronologically before the initial time, generating future time windows including a first set of future time subsets each of the first length, the first set of future time subsets including a consecutive number of non-overlapping future time subsets beginning at the initial time, each of the first set of future time subsets being of the first length equal to the time unit, the first set of future time subsets including information being chronologically after the initial time, creating past topological hierarchical decompositions for the first set of historical time subsets and the second set of historical time subsets, creating future topological hierarchical decompositions for the first set of future time subsets, creating a past directed graph adjacency array using weights derived from a distance as applied to embeddings from the past topological hierarchical decompositions, and creating a future directed graph adjacency array using weights derived from the distance as applied to embeddings from the future topological hierarchical decompositions, generating a past window customer attention matrix identifying entity membership of groups across historical time subsets using the embeddings from the past topological hierarchical decompositions, and generating a future window customer attention matrix identifying the entity membership of groups across future time subsets using the embeddings from the future topological hierarchical decompositions, performing matrix multiplication to multiply the past window customer attention matrix to the past directed graph adjacency array and a transpose of the past window customer attention matrix to create a past customer self-attention array, performing the matrix multiplication to multiply the future window customer attention matrix to the future directed graph adjacency array and a transpose of the future window customer attention matrix to create a future customer self-attention array, performing matrix multiplication of the past customer self-attention array to the future customer self-attention array, and providing a dashboard forecasting demand after the initial time.

### BRIEF DESCRIPTION OF THE DRAWINGS

FIG. 1 depicts an overview of construction of a network for explanation generation in some embodiments.

FIG. 2 depicts an example environment for an explainable machine learning system in some embodiments.

FIG. 3 depicts a block diagram of an explainable machine learning system in some embodiments.

FIG. 4A depicts a method for generating explainable insights using component-connected architecture(s) in some embodiments.

FIG. 4B depicts a method for generating component-connected architectures in some embodiments.

FIG. 5 depicts an initial approximation of the recursive hierarchical decomposition (RHD) of the dataset in some embodiments.

FIG. 6 depicts a tower of covers utilizing stepwise resolution increases in some embodiments.

FIG. 7 depicts subspace clustering of feature space in some embodiments.

FIG. 8 depicts a recursive hierarchical decomposition (e.g., a first connected-component network) of the feature space in some embodiments.

FIG. 9 depicts a reference frame context in some embodiments.

FIG. 10 depicts a second layer of the network (e.g., DTNN) in some embodiments.

FIG. 11 depicts the optional creation of metafeatures to explain segmentation in some embodiments.

FIG. 12 depicts the explanation element showing group membership for a local feature space in some embodiments.

FIG. 13 depicts the utilization of local embedding coordinates as novel features across the local transposed elements in some embodiments.

FIG. 14 depicts local clustering group information that is encoded as membership to hierarchically defined groups in some embodiments.

FIG. 15 depicts creation of an RHD summary in some embodiments.

FIG. 16 depicts leaf node centroids of global object space RHD in some embodiments.

FIG. 17 depicts subset node centroids of global object space RHD 1704 in some embodiments.

FIG. 18 depicts leaf and subset centroid placements within the embedding for each layer of the RHD in some embodiments.

FIG. 19 depicts a topological summary of global object space RHD 1902 in some embodiments.

FIG. 20 depicts an interactive visualization of the topological summary in some embodiments.

FIG. 21 depicts a statistical feature and metafeature summary of the RHD leaf node in some embodiments.

FIG. 22 depicts the hybrid EET1/EET2 showing group membership for selected local object space feature(s) in some embodiments.

FIG. 23 depicts an interactive visualization in some embodiments.

FIG. 24 is an example of a feature description for bourbons that is derived from the feature space RHD.

FIG. 25 depicts an example UMAP pre-embedding (HDBSCAN clusters).

FIG. 26 depicts an example UMAP pre-embedding (run order).

FIG. 27 depicts an example UMAP post-embedding (HDBSCAN clusters).

FIG. 28 depicts an example UMAP post-embedding (run order).

FIG. 29 depicts an example original spectra (control sequence). In this example, intensity is along the y-axis and retention time normalized spectra is along the x-axis.

FIG. 30 depicts an example retention time normalized spectra (run order) along the x-axis and intensity along the y-axis.

FIG. 31 depicts an example retention time normalized spectra (run order) along the x-axis and intensity along the y-axis.

FIG. 32 depicts an example retention time along the x-axis and intensity along the y-axis.

FIG. 33 depicts example spectra quotients (e.g., from the gas chromatograph). Median quotients are along the y-axis and the retention time (median quotient regression) is along the x-axis.

FIG. 34 depicts an example graph of SOP and control with the median quotient along the y-axis and the barrel number (e.g., for the specific barrel of bourbon) along the x-axis.

FIG. 35 depicts an example wheat-to-rye graph.

FIG. 36 depicts a proof 105 to proof 125 graph.

FIG. 37 depicts an example graph for seasoning of staves (e.g., comparison of 6 to 12 months).

FIG. 38 depicts an example graph of grain comparison (e.g., tight, average, coarse, and control).

FIG. 39 depicts an example storage graph for comparison of wooden to concrete).

FIG. 40 depicts an example char graph for comparing type #3 char to type #4 char.

FIG. 41 depicts an example tree graph for comparison of top of tree to bottom of tree.

FIG. 42 depicts an example ring graph for comparison of the number of rings.

FIG. 43 depicts an example distill graph for comparison of different distillation dates.

FIG. 44 depict a run order graph for a comparison of different run orders.

FIG. 45 depicts a block diagram of an example digital device 4500 according to some embodiments.

FIG. 46 is an example of IPAD forecasting for sales using a linear regression in the prior art.

FIG. 47 is a continued example of forecasting using non-linear topological regression in the prior art.

FIG. 48 depicts a block diagram of an explainable machine learning system in some embodiments.

FIG. 49 is a diagram of an overall summary of temporal windows captured in some embodiments.

FIG. 50 is another example of window sizes based on a THD toy example overview in some embodiments.

FIG. 51 is an example of a DTM architecture in a toy example overview. Here, two separate THDs are generated.

FIG. 52 depicts the same THD groups but with certain edges removed in order to eliminate edges that otherwise would be connected between impossible future states.

FIG. 53 depicts the same THD groups in an example that illustrates attention in one example.

FIG. 54 depicts the same THD groups in an example that illustrates attention in a step forward in time relative to the future time in FIG. 53.

FIG. 55 depicts the same THD groups in an example that illustrates attention in a step forward in time relative to the future time in FIG. 54.

FIG. 56 depicts the same THD groups 5102, 5104, and 5106 in an example that illustrates attention in a step forward in time relative to the future time in FIG. 55 (and three steps forward relative to FIG. 53).

FIG. 57 depicts the same THD groups in an example that illustrates attention in a step forward in time relative to the future time in FIG. 56 (and four steps forward relative to FIG. 53). In this example, the attention is point is at the start of a declining line.

FIG. 58 depicts the same THD groups in an example that illustrates attention in a step forward in time relative to the future time in FIG. 57 (and five steps forward relative to FIG. 53).

FIG. 59 depicts the same THD groups 5102, 5104, and 5106 in an example that illustrates attention in a step forward in time relative to the future time in FIG. 58 (and six steps forward relative to FIG. 53). In this example, the attention is point is at the continuation of the flat line.

FIG. 60 depicts the same THD groups in an example that illustrates attention in a step forward in time relative to the future time in FIG. 59 (and seven steps forward relative to FIG. 53).

FIG. 61 is a flow chart for topological transformation used for forecasting in some embodiments.

FIG. 62 depicts an example of individual historical and future THDs capturing sales patterns in some embodiments.

FIG. 64 depicts individual past and future THDs with a different signal in this example. For this branch, there is an indication of people who did not buy four weeks ago but are buying more as T₀ approaches.

FIGS. 65 through 67 depicts different branches and different averages of purchasing as time approaches T₀ in some embodiments.

FIG. 68A depicts a THD relationship matrix (e.g., a “key”) construction in one example.

FIG. 68B depicts another example of the THD relational matrix construction for the toy example.

FIG. 69 depicts a past window customer attention matrix in some embodiments.

FIG. 70 is an attention encoding in some embodiments.

FIG. 71 depicts an example of a past attention matrix in some embodiments.

FIG. 72 depicts a past window customer attention matrix in another example.

FIG. 73 depicts a future window activation in step 5 of FIG. 61 in one example.

FIG. 74 depicts a future window activation utilizing the future attention encoding matrix Q_{f}×K_{f}, where Q_{f} is the query, Kris from FIG. 73.

FIG. 75 depicts another future window activation utilizing the matrix Q_{f}×K_{f}, where Q_{f} is the query T+N group membership, and Kris T+N key.

FIG. 76 is an example of a co-activation matrix for the toy example in some embodiments.

FIG. 77 depicts a single attention head output forecast which may be applied to forecast results after the initial time.

Throughout the drawings, like reference numerals will be understood to refer to like parts, components, and structures.

### DETAILED DESCRIPTION

As discussed herein, various embodiments of systems and methods include generation of a component-connected architecture. Components of the component-connected architecture may define features, feature/object metadata, and/or object relationships. The component-connected architecture may enable the discovery of relationships of features within high-dimensional spaces.

In one example of the component-connected architecture, dimensionality-reduced feature sets are used to create a local transpose of the isolated features to derive local relationships of the objects within the feature space. A hierarchical representation of the objects may be generated using the local transpose embedding coordinates that feed into the object space hierarchical understanding to create topological summaries of hierarchical information. The topological summaries of hierarchical information may provide explanation information (e.g., through generation of new component-connected architectures across subsets of the previous component-connected architecture). The explanation information suggests or explains relationships within the underlying data.

An interactive visualization may be optionally generated to enable selection of data within the topological summaries of hierarchical information and/or statistical interrogation to display explainable information of complex relationships at a simplified lower Dimensional representation. The interactive visualization may, in some embodiments, enable annotation.

Alternatively for additionally, reports may be generated that includes topological summaries of hierarchical information and/or statistical data explaining complex relationships at a simplified lower dimensional representation.

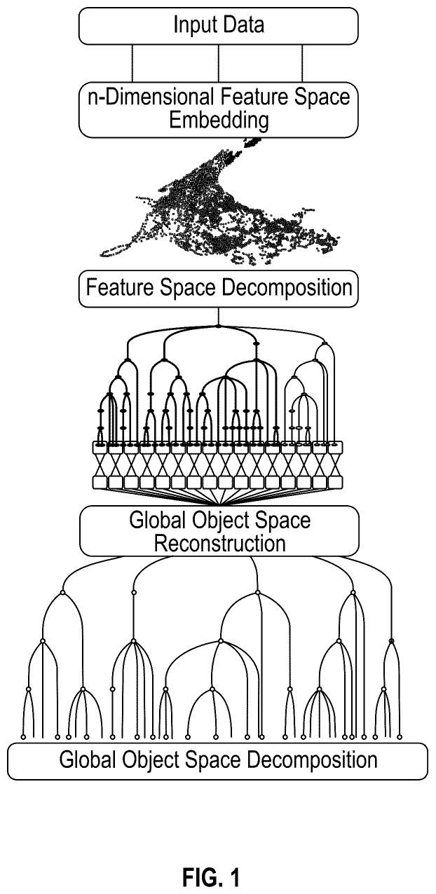

FIG. 1 depicts an overview of construction of a network for explanation generation in some embodiments. In various embodiments, an explainable machine learning system constructs a network (e.g., a deep topological neural network (DTNN)) for automating explainable machine learning methods for data discovery and insight generation. Utilizing topological data analysis and hierarchical processing methods, the explainable machine learning system constructs a component-connected architecture that:
(i) discovers relationships of features in high-dimensional spaces,
(ii) utilizes dimensionality-reduced feature sets to create a local transpose of the isolated features to derive local relationships of the objects within the feature space, and
(iii) formulates a hierarchical representation of the objects using the local transpose embedding coordinates that feed into a complete object space hierarchical understanding.

The explainable machine learning system may create methods for hierarchically structuring information and creating topological summaries of hierarchical information for explanation generation. As discussed herein, the overall process may create components for defining features, feature/object metadata, and object relationships that enable automated processing, statistical interrogation, and/or explainable demonstration of complex relationships at a simplified lower dimensional representation for human evaluation and annotation. In some embodiments, as opposed to competing methods, the explainable machine learning system may establish embedded metafeatures created within the layers of the neural network to contribute to machine learning explainability.

It will be appreciated that the representation may or may not be visualized.

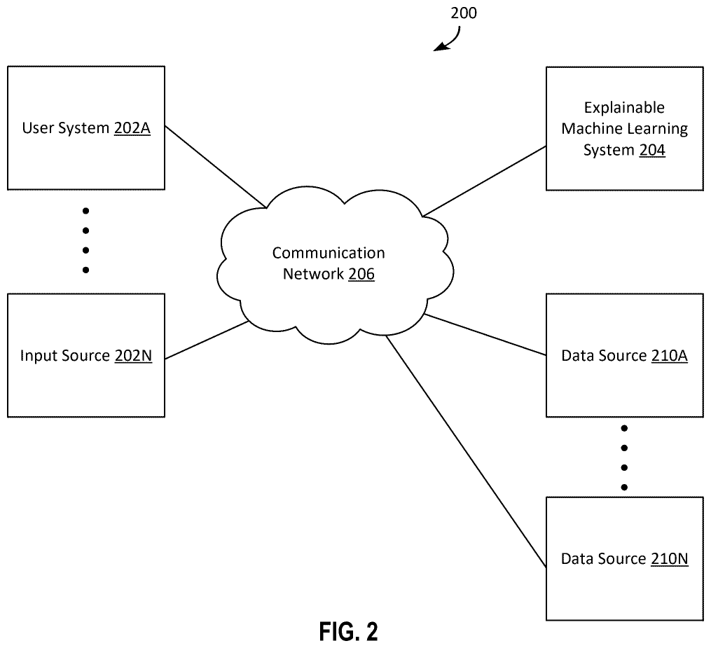

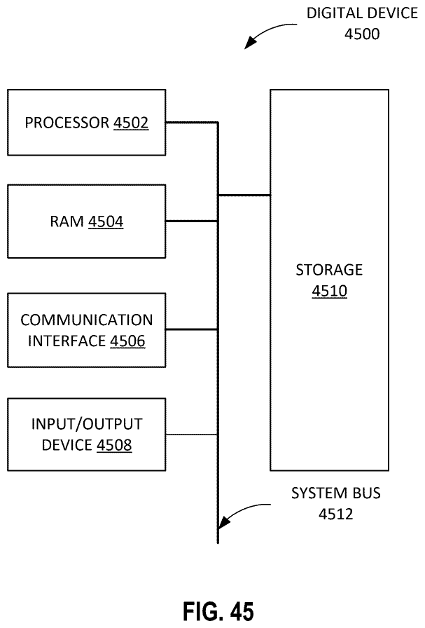

FIG. 2 depicts an example environment 200 for an explainable machine learning system in some embodiments. The example environment 200 includes an explainable machine learning system 204, user systems 202A-N, data sources 210A-N, and a communication network 206. Each of the explainable machine learning system 204, user systems 202A-N, and data sources 210A-N may be or include any number of digital devices. A digital device is any device with at least one processor and memory. Digital devices are further discussed herein, for example, with reference to FIG. 45.

The explainable machine learning system 204 may receive data from any number of data sources for analysis as generally discussed with reference to FIG. 1. The explainable machine learning system 204 may retrieve information, prepare the information for analysis, identify segments of data that preserve and/or highlight significant features, determine features/meta-features for embedding, and identify explainable elements. Explainable machine learning system 204 may further generate a visualization or generate a report to display information and insights. In some embodiments, the visualization may be interactive thereby allowing users to make selections of nodes (centroids) of the generated networks. The interactive visualization is further discussed herein.

One or more of the user systems 202A-N may display interfaces to a user that the user may utilize to control the explainable machine learning system 204. For example, a user of the user system 202A may provide instructions to identify data retained by data sources 210A-N for retrieval, provide metrics/filters, and inspect insights and visualizations from the explainable machine learning system 204.

One or more of the data sources 210A-N may retain information for analysis by the explainable machine learning system 204. In some embodiments, the explainable machine learning system 204 may provide transformed databases, tables, analysis, reports, and/or the like to any number of the data sources 210A-N. In some examples, the data sources 210A-N may include data warehouses, data links, cloud storage, local storage, or any combination thereof.

In some embodiments, the communication network 206 may represent one or more computer networks (for example, LAN, WAN, and/or the like). The communication network 206 may provide communication between any of the explainable machine learning system 204, user systems 202A-N, and/or data sources 210A-N. In some implementations, the communication network 206 comprises computer devices, routers, cables, uses, and/or other network topologies. In some embodiments, the communication network 206 may be wired and/or wireless. In various embodiments, the communication network 206 may comprise the Internet, one or more networks that may be public, private, IP-based, non-IP based, and so forth.

It will be appreciated that any number of unrelated users (e.g., users from different and unrelated enterprises, commercial entities, research institutions, governments, and/or the like) perform analysis on unrelated data sets from any number of data sources by the same explainable machine learning system 204. In some embodiments, explainable machine learning system 204 may provide insights and analysis on a variety of different data sets on behalf of any number of different users.

In various environments, a particular user with privileged data rights to confidential information may provide the information (e.g., encrypted, protected, unprotected, and/or the like) for analysis by the explainable machine learning system 204. The explainable machine learning system 204 may maintain a record of all actions performed on the database, stored any information related to the analysis of the original data within required unprotected data storage, and/or authenticate users or devices as required.

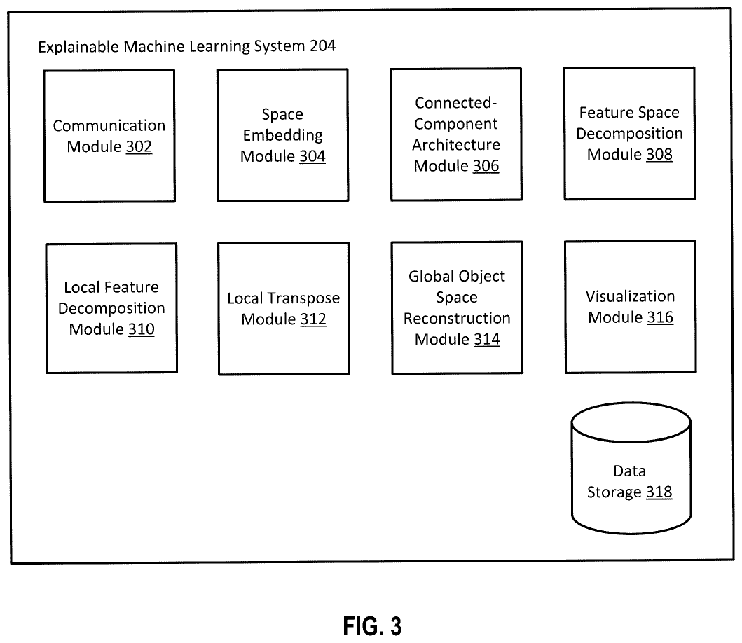

FIG. 3 depicts a block diagram of an explainable machine learning system 204 in some embodiments. The explainable machine learning system 204 comprises a communication module 302, a space embedding module 304, a connected-component network module 306, a feature space decomposition module 308, a local feature decomposition module 310, a local transpose module 312, a global object space reconstruction module 314, a visualization module 316, and a data storage 318.

The communication module 302 may send and/or receive requests and/or data from the data source(s) 110A-110N and/or user devices 102A-N. In one example, the communication module 302 receives data to be analyzed from data source 110A.

The communication module 302 may receive requests and/or data from the user system 106, the input source system 108, and the output destination system 110. The communication module 302 may also send requests and/or data to the user system 106, the input source system 108, and the output destination system 110.

The communication module 302 may receive or provide data or requests to any of the modules of the explainable machine learning system 204. In some buttons, the communication module 302 may receive or provide data to the user devices 102A-N and/or data sources 110A-N.

In various embodiments, the communications module 302 receives or retrieves n-dimensional matrix. The n-dimensional matrix may be any data from any number of data sources. In various embodiments, the communications module 302 retrieves data from two or more different data sources 110A-N. The communications module 302 may combine the data from the different data sources to generate the n-dimensional matrix.

The feature space embedding module 304 may generate a lower dimensional embedding feature space by projecting the data based on metrics and/or filters discussed herein.

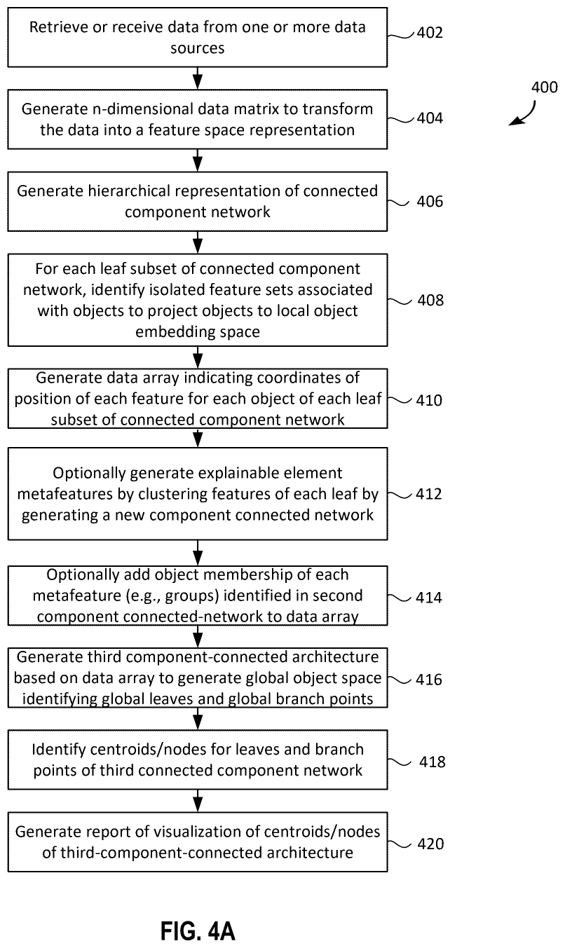

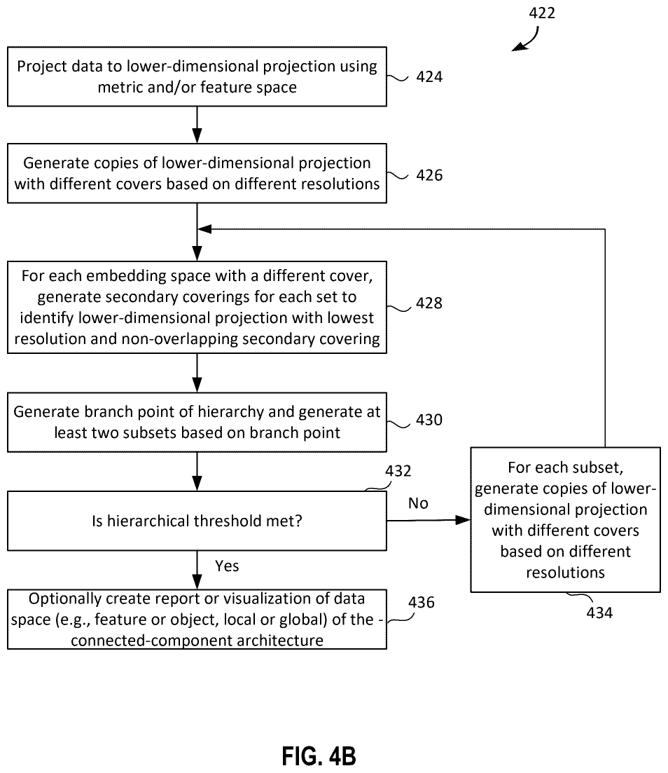

The connected-component network module 306 may generate connected-component networks (e.g., using the “tower of covers” approach discussed herein). The process is discussed with regard to FIG. 4B.

The feature space decomposition module 308 may generate a lower dimensional embedding of the feature space as described herein for each leaf of the first connected-component network as described herein.

The connected-component network module 306 may identify segment (branch) points of the embedded space at different thresholds. The subset of connected components (e.g., derived from the tower covers) may create data subsets for repeating (e.g., nested) above method to produce a hierarchy of local feature sets of common similarity measures. As a result, a recursive hierarchical decomposition (RHD) of the feature space is generated.

In some embodiments, the local features of the RHD group subsets can be visualized back within their reference frame, establishing an explanatory element.

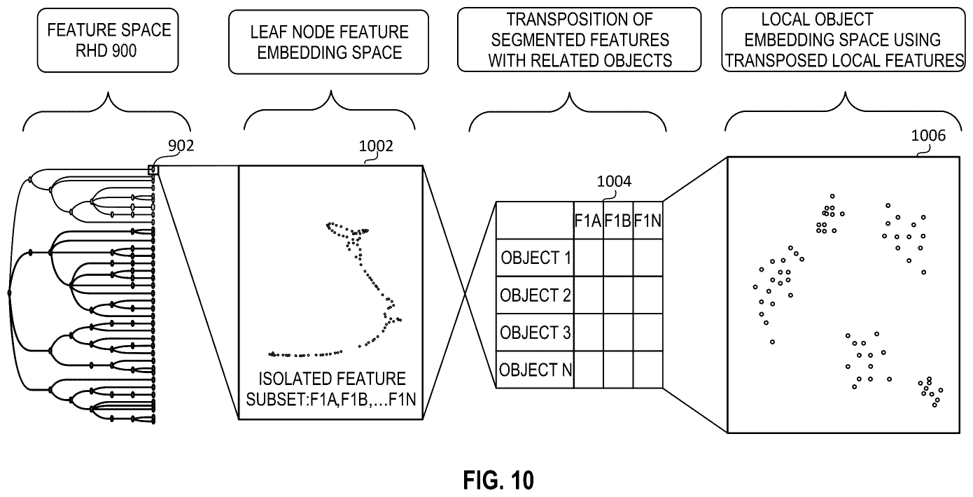

The local feature decomposition module 310 may assist in identifying features in individual leaves of the feature space for embedding in the leaf node feature embedding space or generating the local object embedding space used to transpose local features as discussed with regard to FIG. 10.

The local transpose module 312 is configured to locally transpose the RHD isolated feature sets (e.g., objects as rows and RHD isolated features as columns) as discussed herein.

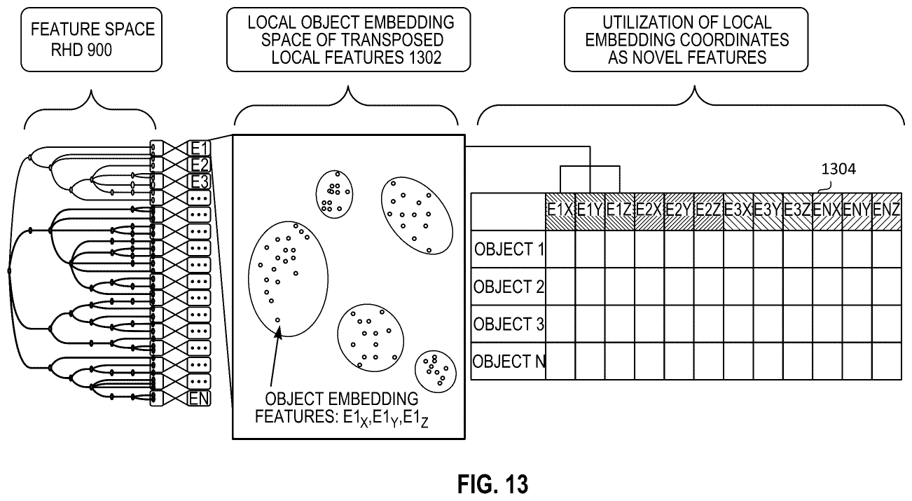

The global object space reconstruction module 314 may generate the global object space, the top node embedding of the global object space RHD 1504, and/or the topological summary of global object space RHD 1902 as described with regard to FIG. 13-19.

FIG. 3 depicts an example method for explainable analysis in some embodiments. The steps of the method depicted in FIG. 3 will be further described in FIGS. 4-23.

As discussed herein, various embodiments of systems and methods include generation of a component-connected architecture. The component-connected architecture may enable the discovery of relationships of features within high-dimensional spaces.

FIG. 4A depicts a method for generating explainable insights using component-connected architecture(s) in some embodiments.

In step 402, the communication module 302 retrieves or receives data from one or more data sources (e.g., data sources 110A-N). The data may be in any form or organization.

In step 404, the communication module 302 and/or the feature space embedding module 304 may generate an n-dimensional data matrix to transform the data into a feature space representation.

The feature space representation may include features as rows and objects as columns. In various embodiments, the communications module 302 may perform processing on any of the data received from the data sources. For example, the communications module 302 may normalize data, create new features, perform calculations to generate new features, and/or the like. In another example, the communications module 302 may convert data received from one or more data sources into the feature space representation (e.g., features as rows and objects as columns). In some embodiments, the communications module 302 may combine data sets from any number of data sources once each of the data sets are in the feature space representation.

In step 406, the explainable machine learning system tool for may generate a connected-component architecture and a hierarchical representation of the first component-connected architecture based on the feature space representation of the data received from the data sources or user devices. FIG. 4B depicts a method for generating a connected architecture.

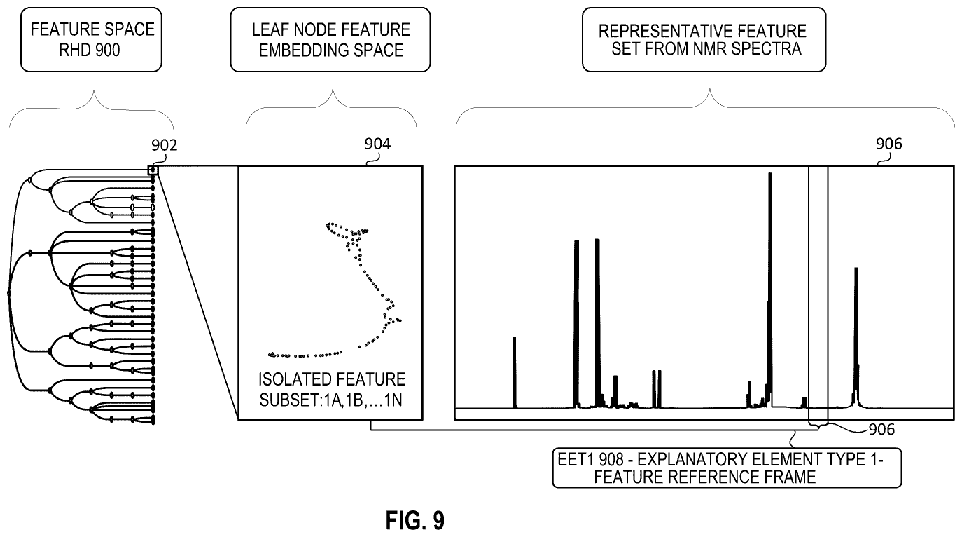

After the first connected-component network is generated based on the feature space representation, in step 408, for each leaf subset of the connected component network, the feature space decomposition module 308 may identify isolated feature sets the social of objects and/or project those objects to a local object embedding space. This process is discussed with regard to FIGS. 9 and 10.

Each leaf (e.g., leaf node) identifies an embedding of the feature space. For example, a leaf node may include an isolated featured subset. The isolated featured subset may be used to generate a transposition of segmented features with related objects. In this example, each row includes the original objects and columns are for each feature of the isolated featured subset for that leaf.

In step 410, the feature space decomposition module 308, the local feature decomposition module 310, or the local transpose module 312 may generate a data array indicating coordinates of a position of each feature for each object of each leaf subset of the connected component network. This process is further discussed with regard to FIGS. 10 and 13.

In step 412, the local transpose module 312 may optionally generate explainable element meta-features by clustering features of each leaf. In one example, a local object embedding space may be generated using the transposition of segmented features with related objects. In one example, metrics and/or filters (e.g., the same metrics and/or filters used to generate one or more other projections) may be used to project the objects into the local object embedding space.

For each leaf node, a coordinate position of an object in its related local object embedding space is identified and included in the data array. The data array includes rows of objects as well as columns identifying coordinates of that object in each local object embedding space of one or more (e.g., all) leaf nodes.

For optional step 412, another component connected architecture using the methodologies described herein may be created for each local object embedding space to identify clusters or groups within the local object embedding space. For example, different coverings can be applied to one or more embedding spaces to identify nonoverlapping secondary coverings (e.g., using the methods described herein). The nonoverlapping secondary coverings identify subset branch points and two or more subsets within the embedding space may be similarly assessed (e.g., for each subset from the branch point, different covers can be applied to identify nonoverlapping secondary coverings to further identify branch points for further analysis) until a threshold is reached. The threshold may be any limiting determination of function including, for example, a number of subsets found, a statistical measure based on the original data set, a number of groups based on the data within the local object embedding space, and/or the like.

In this optional example, an object may be a member of a group which may be termed as a meta-feature.

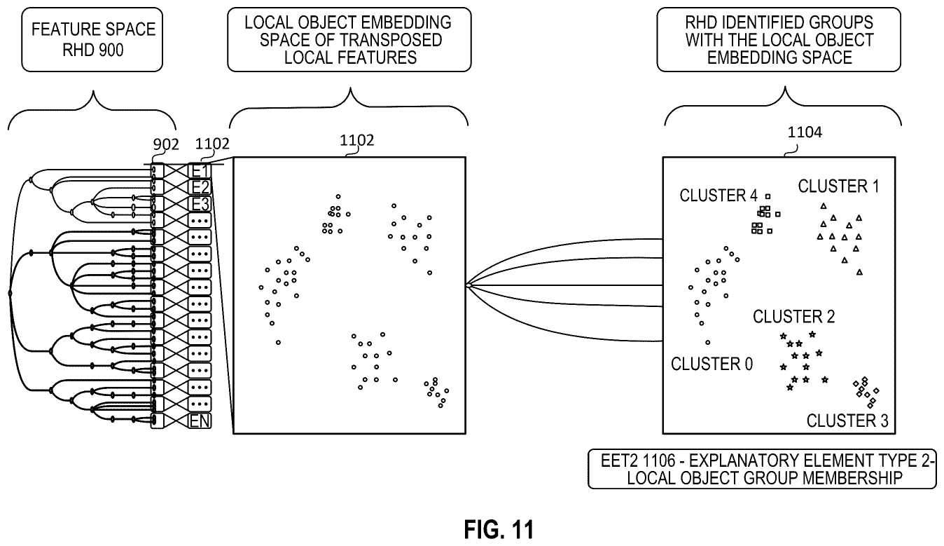

In step 414, each meta-feature may be uniquely identified (e.g., MF1-N) for each local space and membership of that meta-feature group for each object across all local embedding spaces may be added to the data array (e.g., the same data array that contains object coordinates across the leaves of the first connected-component network). This process is further described with reference to FIGS. 11-14.

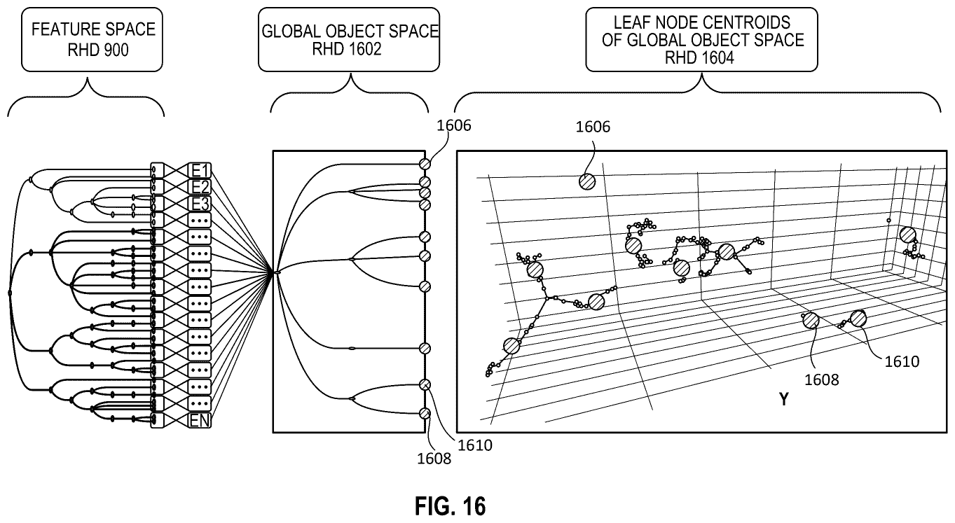

In step 416, the connected-component network module 306 may generate a third connected-component network based on the data array from step 410 or steps 410-414 (e.g., including or not including the metafeatures described herein) to generate a global object space that includes global leaves and global branch points. This process is similar to that described with regard to FIG. 4B but utilizes the data array. This process is further described with reference to FIG. 16.

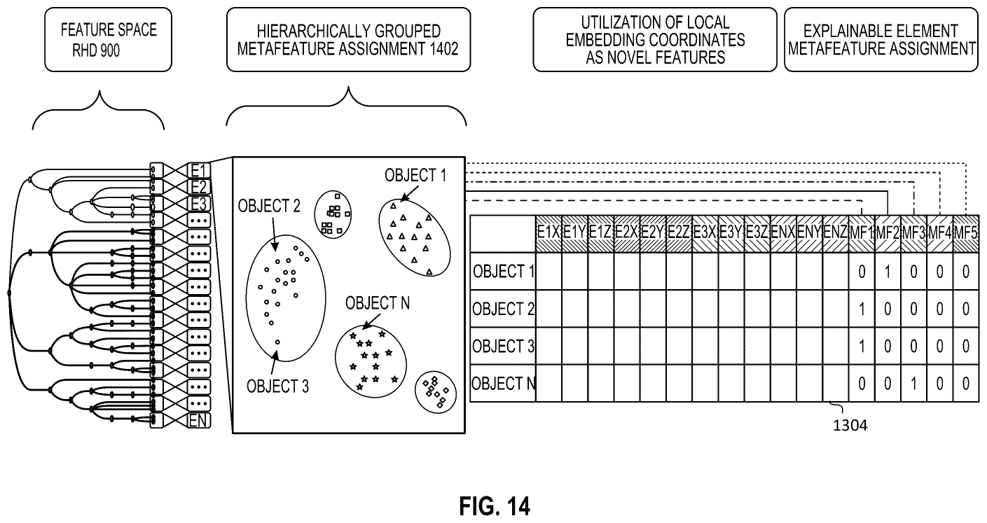

In step 418, the global object space reconstruction module 314 identifies centroids (i.e., nodes) for leaves and branch points of the third connected-component network. This process is further described with regard to FIGS. 14-20.

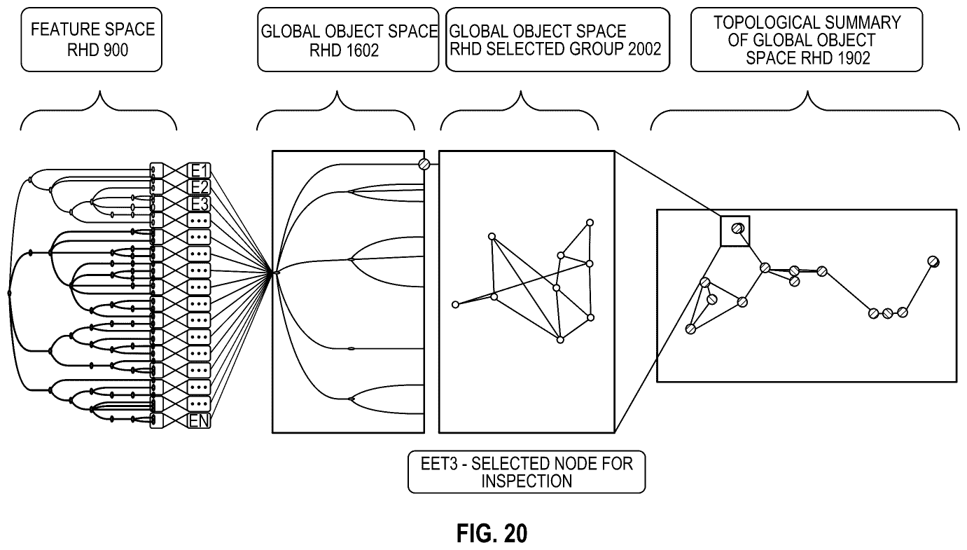

In step 420, the visualization module 316 may generate a report or visualization of the centroids (e.g., nodes) of the third connected-component network (e.g., as depicted in FIG. 20). In some embodiments, the visualization module 316 may generate an interactive visualization interactive visualization to enable selection of data within the topological summaries of hierarchical information and/or statistical interrogation to display explainable information of complex relationships at a simplified lower Dimensional representation. The interactive visualization may, in some embodiments, enable annotation.

Alternatively, for additionally, reports may be generated that includes topological summaries of hierarchical information and/or statistical data explaining complex relationships at a simplified lower dimensional representation.

FIG. 4B depicts a method for generating component-connected networks in some embodiments. It will be appreciated that this process may be titled a “tower of covers” approach to network generation.

In step 424, the space embedding module 304 may project data from the received data (e.g., from the feature space representation or data array discussed herein) into an embedding space. The space embedding module 304 may project the data using any number of ways. For example, the space embedding module 304 may utilize one or more metrics and/or filters (e.g., receipt from the user device) to make the projection.

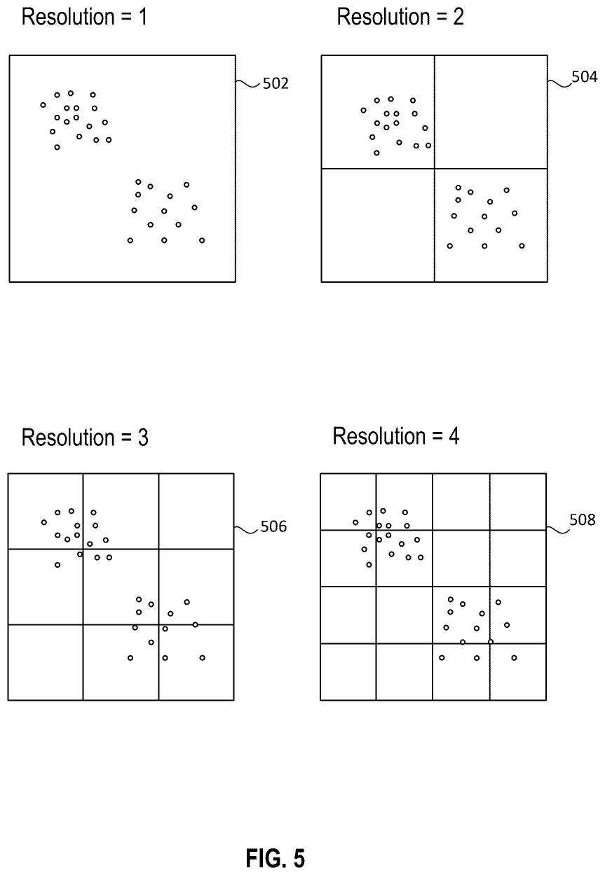

The connected-component network module 306 may perform steps 426 through 444 to generate the connected-component network. In step 426, the connected-component network module 306 may apply different covers of the embedding space to identify nonoverlapping secondary coverings for branch identification. The connected-component network module 306 may generate sequentially apply each different covering to the embedding space and/or generate copies of the embedding space and apply a different covering to each of the embedding spaces. FIG. 5 includes an example of the different coverings applied to the same embedding space (e.g., the projection of the data generated in step 424).

It will be appreciated that each cover may create one or more sets (e.g., individual squares covering the embedding space as depicted in FIG. 5).

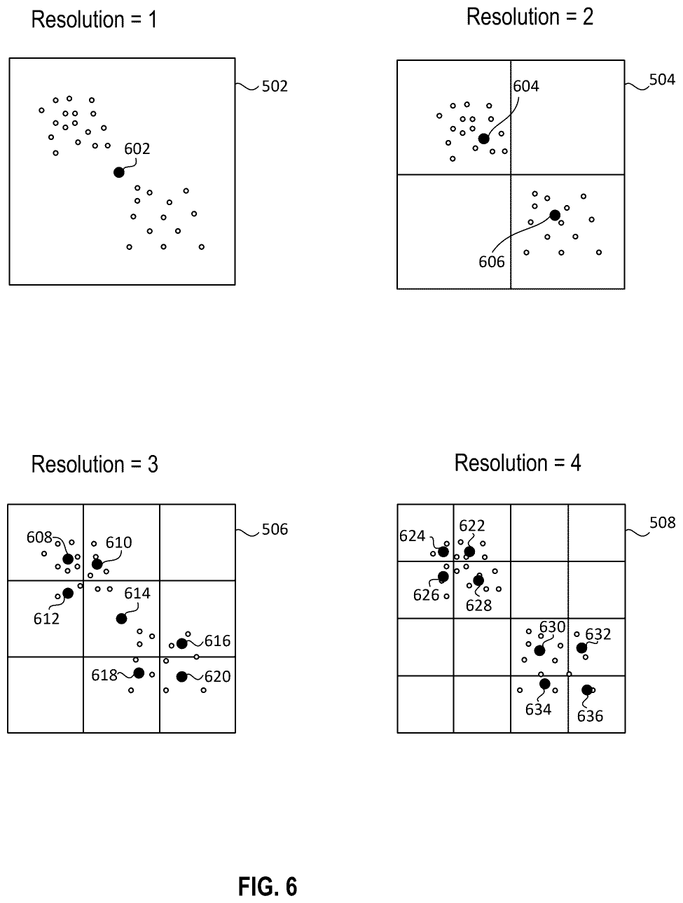

In step 428, for each embedding space with a different cover, the connected-component network module 306 generates secondary coverings for each set to identify the lower dimensional projection with the lowest resolution and nonoverlapping secondary coverings. In one example, a centroid is determined for each set within the covering. The centroid is determined based on the data within that set as discussed herein. This process is discussed with regard to FIG. 6.

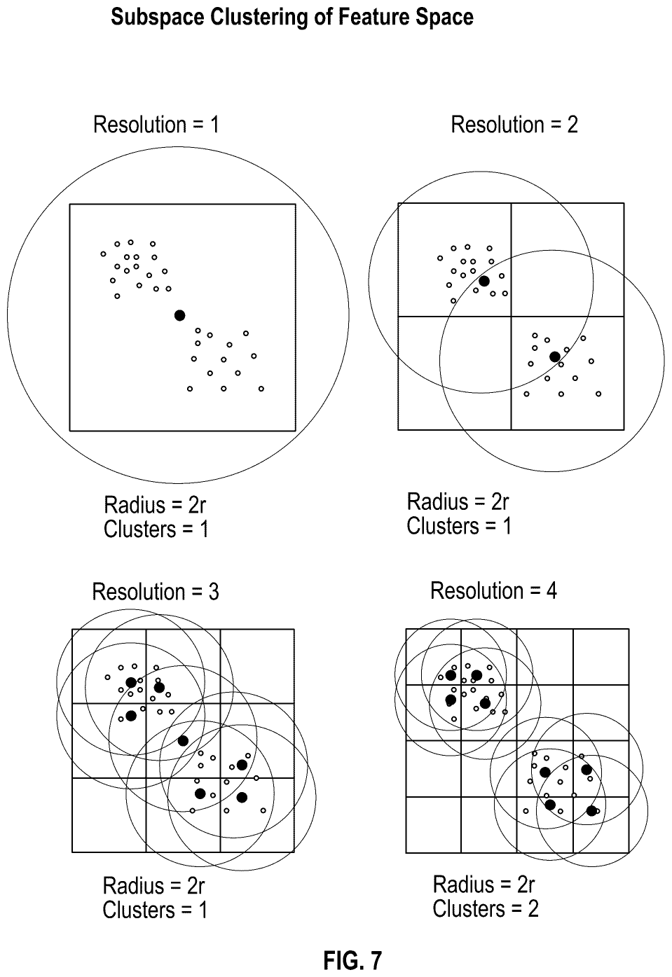

Brief centroid secondary coverings generated using the centroid at the center of the secondary covering. The secondary covering covers the particular set of data points. The connected-component network module 306 determines if there is overlap between the two secondary coverings (e.g., if there are separate clusters). A branch point is identified based on the embedding space with the lowest resolution that has at least two data sets with nonoverlapping secondary covers. This process is further discussed with regard to FIG. 7.

In some embodiments, to generate the first component-connected architecture, dimensionality-reduced feature sets are used to create a local transpose of the isolated features to derive local relationships of the objects within the feature space. A hierarchical representation of the objects may be generated using a local transpose embedding coordinates that feed into the object space hierarchical understanding to create topological summaries of hierarchical information. The topological summaries of hierarchical information may provide explanation information. The explanation information suggests or explains relationships within the underlying data.

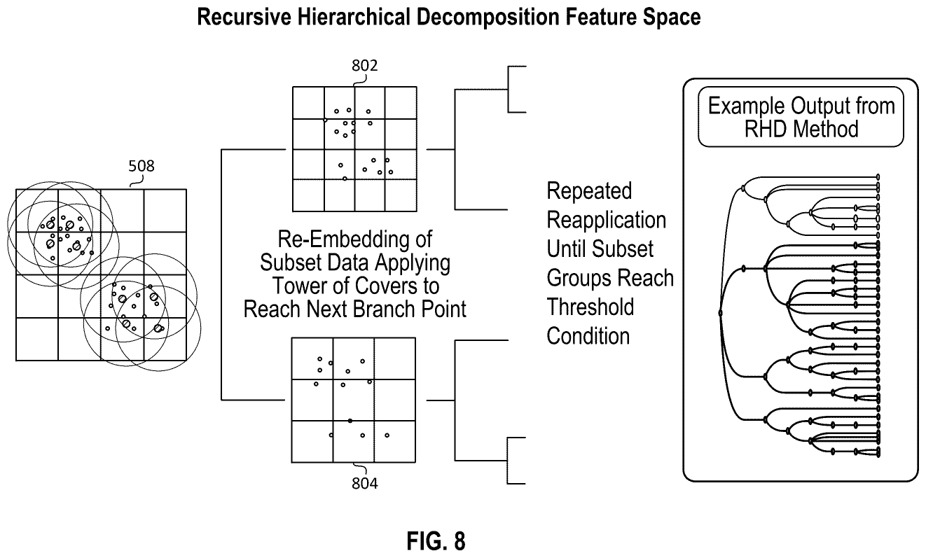

In step 430, the connected-component network module 306 generates a branch point of the hierarchy based on the projection with the lowest resolution and nonoverlapping secondary covering. The connected-component network module 306 generates at least two subsets based on the branch point. This process is further discussed with regard to FIG. 8.

In step 432, the connected-component network module 306 determines if a hierarchical threshold is met to terminate the network generation process. It will be appreciated that there may be any number of thresholds to generate the network generation process as discussed herein. The network will continue to be generated with additional branch points and subsets until the hierarchical threshold is met.

If the hierarchical threshold is not met, the method continues to step 434. In step 434, in a manner similar to that of step 426, for each subset of the branch, the connected-component network module 306 applies different covers to each subset to identify the lowest resolution with nonoverlapping secondary coverings. The method continues to step 428 as applied to each subset from the branch point.

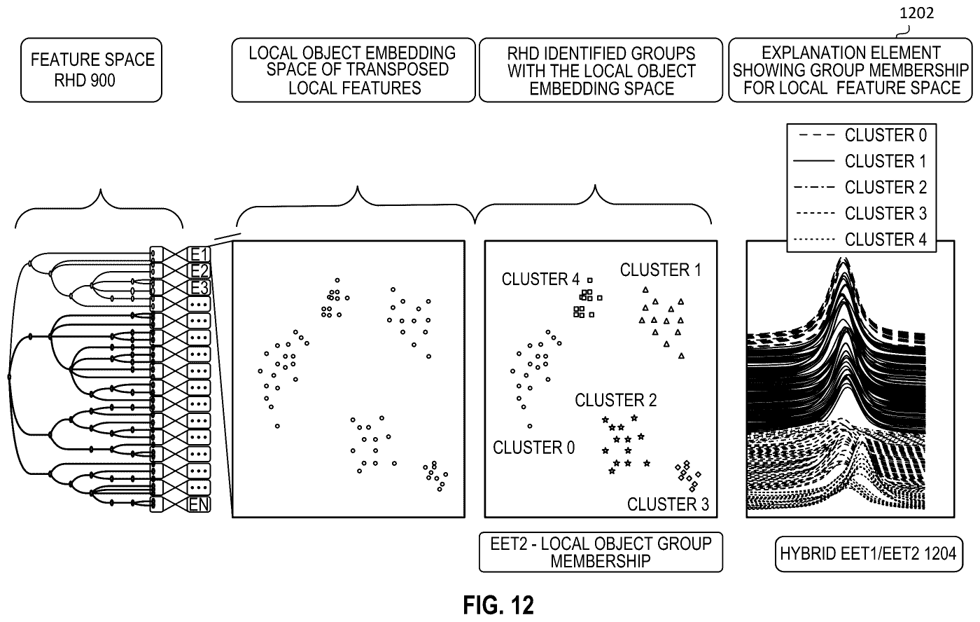

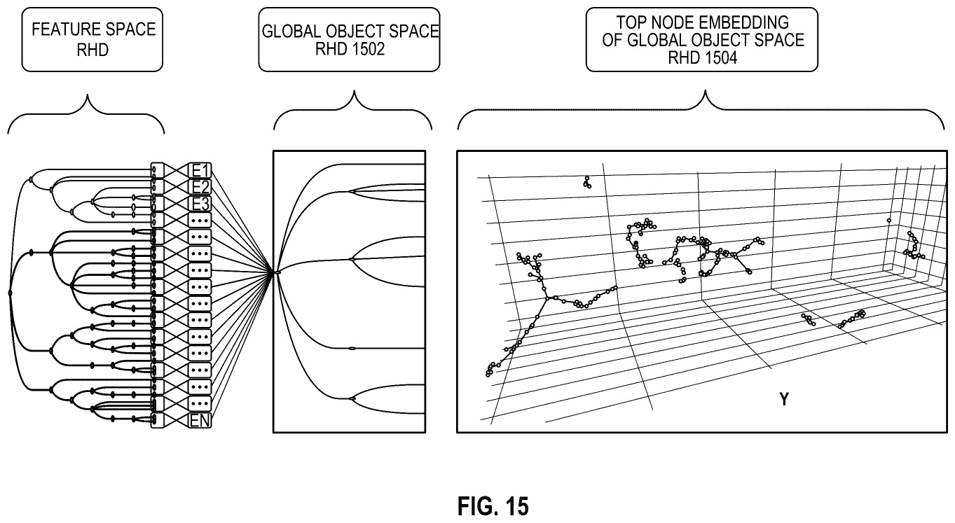

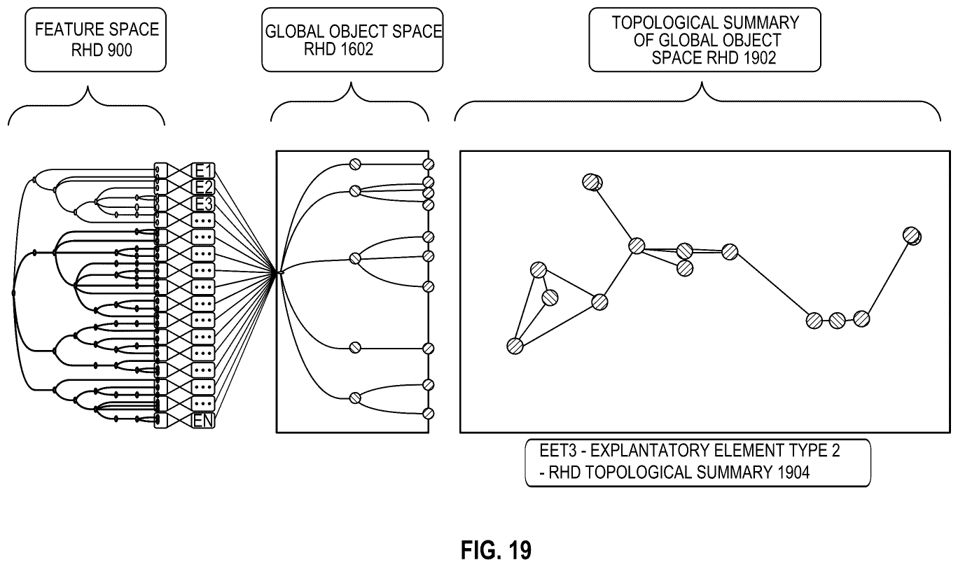

If the hierarchical threshold is met, then the method continues to step 436. In step 436, the connected-component network module 306 and/or the visualization module 316 may optionally generate a report visualization of the resulting data space (e.g., feature or object, local or global) of a connected-component architecture (e.g., the feature space RHD 900 of FIG. 9, the leaf node feature embedding space 1002, explanation element showing group membership from local feature space 1202 in FIG. 12, the top note embedding global object space RHD 1504 in FIG. 15, the global object space RHD 1502 in FIG. 15, the topological summary of global object space RHD 1902 in FIG. 19, and/or the like).

FIG. 5 depicts an initial approximation of the recursive hierarchical decomposition (RHD) of the dataset in some embodiments. Although the term “recursive” is used with respect to the RHD, it will be appreciated that a series of covers may be applied to the same data projection (e.g., the same embedding space) to identify non-overlapping secondary coverings. The process may not be recursive in other aspects as will be shown herein.

In FIG. 5, the initial approximation of the RHD begins through transformation of a high-dimensional data space into a lower dimension projection using any generic dimensionality reduction method combining metric and filter spaces (e.g., Euclidean, cosine, correlation, t-sne, umap, mds, pca, or the like). In one example, the feature space embedding module 304 utilizes a metric and/or filter functions (e.g., spaces) to transform high dimensional data received from the data source into a lower dimensional projection.

Following embedding, the feature space decomposition module 308 may apply a uniform (or non-uniform) cover to the embedding. FIG. 5 depicts a variety of different uniform covers at different resolutions that cover the same data space. Graph 502 depicts a cover (e.g., a square) with a resolution of one that covers the projected data points. Graph 504 depicts a cover of a resolution of 2 (e.g., 2² or 4 uniform squares or sets) covering the data space. Graph 506 depicts a cover of a resolution of 3 (e.g., 3² or 9 uniform squares or sets) covering the data space. Graph 508 depicts a cover of a resolution of 3 (e.g., 4² or 16 uniform squares or sets) covering the data space.

It will be appreciated that a single data space utilizing covers of a specific resolution can be utilized in conjunction with systems of methods discussed herein. Ultimately, in some embodiments, any number of different resolutions may be utilized. Although FIG. 5 depicts square sets, it will be appreciated that the sets of the coverings may be of any shape or combination of shapes (e.g., different intervals and/or sizes).

For 2- and 3-component embeddings, a uniform embedding can be applied as squares, rectangles, or voxels where resolution is defined by the maximum and minimum components in their respective projection space. It is not necessary to preserve any relationship between individual component resolution values and they can be treated as independent parameters. For ease, FIG. 5 depicts the embedded data covered by a uniform square cover at multiple resolutions, although it will be appreciated that any cover at any resolution may be utilized.

The cover will assist with the clustering of the feature space for recursive hierarchical decomposition. FIG. 6 depicts a tower of covers utilizing stepwise resolution increases in some embodiments. The covering of the data includes a subset or plurality of subsets of the data used to compute a centroid of the component values. The centroid may be calculated in any number of ways. In one example, a centroid is calculated based on an average of the data within the individual set of the cover.

In graph 502 of FIG. 6, the centroid is at the center of the data space. In this example, the centroid is represented as point 602 and is calculated based on the data points mapped to the data space (e.g., the metric space). In graph 504 of FIG. 6, for the cover has a resolution of 2, the centroid is calculated based on the data within the individual set (e.g., the individual portion of the cover). In this example, there are two individual sets that are empty (i.e., devoid of mapped data points), and as a result, do not have a centroid. Centroid 604 and centroid 606 are based on the data points contained in their particular sets, respectively. For example, centroid 604 is based on data points contained within its particular set (i.e., the square) but not the data points in any other set of the same space. Similarly, centroid 606 is based on data points contained within its particular set (i.e., the square) but not the data points in any other set.

In graph 506, the data space is divided into nine sets (e.g., graph 506 has a resolution of three). Two of the nine sets have no data points mapped to those individual spaces and therefore have no centroids. Centroids 608, 610, 612, 614, 616, 618, and 620 are each based on the data points within their respective sets.

In graph 508, the data space is divided into 16 sets (e.g., graph 508 has a resolution of four). Eight of the 16 coverings have no data points mapped to those individual spaces and therefore have no centroids. Centroids 622, 624, 626, 628, 630, 632, 634, and 636 are each based on the data points within the respective sets.

FIG. 7 depicts subspace clustering of feature space in some embodiments. Branch points for the non-overlapping connected neighborhood graphs may be identified based on identification of non-overlapping connected neighborhood graphs at the lowest resolution.

In various embodiments, following centroid determination, a circle with a radius of fixed length is centered on each centroid creating a secondary covering. The radius may, for example, be the distance from the centroid to cover the set (e.g., a corner of that set as depicted). Each circle can be parameterized to include a single radius, or a plurality of radii, of differing lengths that scale proportionally to the resolution size.

In FIG. 7, each data space (e.g., graph 502, 504, 506, and 508) is covered by a secondary covering defined by a radius with the respective centroid as the center.

In other words, FIG. 7 demonstrates covering of the embedded space over 4 resolutions. At resolution=1, 2, and 3, non-empty sets result in a single connected component due to a minimum of one centroid being common to a fully connected intersection. At resolution=4, two non-overlapping connected neighborhood graphs (e.g., there are two non-overlapping secondary coverings) are created resulting in a branch point within the topological hierarchy.

Graph 502 in FIG. 7 depicts a single secondary covering that covers the entire embedded space. The secondary covering is based on a radius from the centroid 602 and extends across the covering (which in this case, there is a resolution of one, includes the entire embedded space). As a result, a single cluster (i.e., a cluster=1) is identified.

Graph 504, which has a resolution of two, includes two secondary coverings based on the two centroids 604 and 606, respectively. Since these secondary coverings overlap, a branch point is not identified. Like graph 502, graph 504 has a single cluster (i.e., a cluster=1).

Graph 506 has a resolution of three. As discussed herein, each centroid (e.g., centroid 608, 610, 612, 614, 616, 618, and 620) is the center of its own respective secondary covering. Since these secondary coverings overlap, a branch point is not identified. Like graphs 502 and 504, graph 506 has a single cluster (i.e., a cluster=1).

Graph 508 has a resolution of four. Each centroid (e.g., centroids 622, 624, 626, 628, 630, 632, 634, and 636) is the center of its own respective secondary covering. Here, there are at least two secondary coverings that do not overlap and a branch point is identified. In this example, there are two clusters (i.e., clusters=2).

FIG. 8 depicts a recursive hierarchical decomposition (e.g., a first connected-component network) of the feature space in some embodiments. At each branch point, two or more distinct subsets of the embedded data are created. Each subset is individually re-embedded utilizing a common metric/filter combination. The tower of covers approach may be again deployed (e.g., applying covers of increasing resolutions as show in FIGS. 5 and 6) upon the subset embedding until an additional branch point is detected. The process is repeatedly applied until the terminal subsets of data meet a threshold. Examples of thresholds can be minimum group size, entropy or variance of the resulting subset, or other methodology that creates a terminal stopping point.

FIG. 8 depicts graph 508 with two distinct subsets of the embedded data 802 and 804. Each subset is individually re-embedded utilizing a metric, filter, or a combination of a metric and a filter.

The process repeats itself to identify new branch points for each distinct subset. In this example, the process discussed with respect to FIGS. 4A, 4B, 5-7 repeats for each distinct subset of embedded data until a new branch point is identified and new distinct subsets are created. The process can repeat again until the threshold is reached.

For example, for each of the subsets of embedded data (e.g., embedded data 802 and 804), a range of resolutions may be used to divide the embedded data space into individual sets, centroids may be determined for sets that contain data points, secondary coverings may be identified based on the centroids, and branch points determined based on non-overlapping secondary coverings to create at subsets of embedded data. The process can continue when that particular subset of embedded data is again divided into sub-subsets of embedded data and the process can continue.

FIG. 8 further depicts an example output from the RHD method showing the branch points, and process of re-embedding of subset data and applying the “tower of covers” approach to reach the next branch point.

FIG. 9 depicts a reference frame context in some embodiments. Within the initial layer of the deep topological neural network (DTNN), highly similar features are discovered across the objects. These features relate back to a reference frame with which the features are defined. FIG. 9 depicts how a set of intensity measurements of an NMR spectra can be visualized within the total NMR spectral reference frame deriving an Explanatory Element Type 1 (EET1 908).

FIG. 9 depicts a first leaf 902 (e.g., a lowest subset of any number of elements) derived from the process of the tower of covers discussed herein) of the feature space RHD 900 (e.g., the first connected-component network). The first leaf feature embedding space 904 depicts the embedded space that corresponds to the first leaf 902. The first leaf feature embedding space 904 includes isolated feature subsets 1A-IN. In this example, the EET1 908 is a section of the spectra that corresponds to the feature subset of the first leaf 902 (e.g., the terminal subset at the lowest level).

FIG. 10 depicts a second layer of the network (e.g., DTNN) in some embodiments. The isolated feature sets of high similarity (defined through a RHD using any general metric/filter combination) can be locally transposed to create a data array of objects.

In FIG. 10, similar to FIG. 9, the feature space RHD 900 includes first leaf 902. The leaf node feature embedding space 1002 depicts isolated features subsets F1A-FIN of that first leaf 902. The local transpose module 312 transposes the segment features of the leaf node feature embedding space with related objects. A sample table 1004 depicting objects 1-N as rows and isolated features F1A-FIN as columns is depicted in FIG. 10. The local object embedding space using transposed local features is depicted in graph 1006.

Here, the isolated features become the columns and the objects become the rows. A subsequent embedding of the data array illustrates distinct groupings and embedding positions. The local object space is distinct in that it can create a highly localized similarity estimation of the local features (e.g., the local features only).

FIG. 11 depicts the optional creation of metafeatures to explain segmentation in some embodiments. FIG. 11 depicts the feature space RHD 900 and leaves (e.g., leaf 902) as well as the local object embedding space of transposed local features for each leaf (e.g., leaf 902 corresponds to the local object embedding space of transposed local features 1102 for that particular leaf).

In addition to embedding coordinates, the local object embedding space may be further processed to create metafeatures that explain and describe segmentation, anomaly/outlier, and/or local hierarchy of the embedding distributions. Here, the RHD method described herein is utilized to identify unique groups within the local object space embedding (e.g., the RHD identified groups with the local object embedding space 1104). The RHD identified groups with the local object embedding space 1104 includes clusters 0-4 (e.g., the EET2 1106, which is the explanatory element type 2, local object group membership).

FIG. 12 depicts the explanation element showing group membership for a local feature space in some embodiments. FIG. 12 includes elements from FIG. 11, including the feature space RHD 900 and leaves (e.g., leaf 902), the local object embedding space of transposed local features for each leaf, as well as the RHD identified groups with the local object embedding space 1104 includes clusters 0-4 (e.g., the EET2 1106 which is the explanatory element type 2, local object group membership). FIG. 12 further depicts the explanation element showing group membership for the local feature space 1202. The line graph in FIG. 12 depicts line graphs for hybrid EET1/EET2 1204.

FIG. 13 depicts the utilization of local embedding coordinates as novel features across the local transposed elements in some embodiments. The local object space embedding components further establish features for feed-forward network propagation. Embedding coordinates (e.g., x, y, and z coordinates) of each feature of the local object embedding space of transposed local features 1302 are utilized across the local transposed elements to create a new data array unifies the object space understanding. In the example of FIG. 13, the embedding features are shown for the three components of the embedding. Feed-forward embedding features can include any number of individual components from any metric/filter similarity understanding.

The local object embedding space of transposed local features 1302 includes groups of object embedding features E1ₓ, E1_{y}, and E1_{z} (the coordinates of E1).

Although coordinates x, y, and z are shown by example in FIG. 13, it will be appreciated that any coordinate system may be used. Similarly, although a three-coordinate system is depicted in FIG. 13, any number of dimensions may be used for coordinates to be included in the local transposed elements to create a new data array for unification of the object space understanding.

The table 1304 depicts the rows of objects 1-N with additional features (e.g., columns) including the coordinates of each feature for that related objects.

FIG. 14 depicts local clustering group information that is encoded as membership to hierarchically defined groups in some embodiments. FIG. 14 depicts local clustering group information that is encoded as membership to hierarchically defined groups in some embodiments. Graph 1402 depicts groups (i.e., hierarchically groups) that are hierarchically grouped metafeatures. In this example, graph 1402 includes grouped circular items that are associated as MF1, root triangular objects associated as MF2, grouped star objects associated as MF3 grouped diamond-shaped objects associated as MF4, and grouped square items that are associated as MF5. Explainable element metafeatures (e.g., MF1-5) are then added to table 1304 which depicts the rows of objects 1-N with additional features (e.g., columns) including the coordinates of each feature and explainable element metafeatures.

Insights and explainable elements can be further appended to the data array (e.g., table 1304) that captures embedding features for feed-forward modeling. FIG. 14 depicts that clustering group information is encoded as membership to the hierarchically defined groups (MF1, MF2, MF3). In addition, overall membership of the locally transposed group metafeatures can be annotated.

FIG. 15 depicts creation of an RHD summary in some embodiments. The summary of the RHD process can be created at the top-node embedding level of the RHD 1504 (e.g., the top node embedding of global object space RHD 1504). In some embodiments, a maximal spanning tree is created from the individual leaf-nodes of the global object space RHD. The distances and connectivity of the maximal spanning tree may be subsequently applied to the individual objects within the top-node embedding deriving distinct class understanding.

In various embodiments, the explainable machine learning system 204 may generate a visualization. A visualization may include a graph, report, interactive display, or the like depicting one or more leaf and/or subset centroids determined by methods described herein.

In FIG. 15, for example, the top node embedding of global object space RHD 1504 may be expected in a visualization as shown in the figure. In various embodiments, the visualization may show the feature space RHD 900, the global object space RHD 1502, and/or are the top node embedding global object space RHD 1504.

Some embodiments described herein permit manipulation of the data from the visualization. For example, portions of the data which are deemed to be interesting from the visualization can be selected and converted into database objects, which can then be further analyzed. Some embodiments described herein permit the location of data points of interest within the visualization, so that the connection between a given visualization and the information the visualization represents may be readily understood.

FIG. 16 depicts leaf node centroids of global object space RHD 1604 in some embodiments. For each fully connected leaf node group, the subset of data can be represented by placing a centroid at the relevant position. Centroids in the global object space RHD 1604 are depicted as large or circular objects, such as centroids 1606, 1608, and 1610 (as associated with centroids of the global object space RHD 1602).

The centroid may be calculated in a manner described by other centroids herein or in any number of ways. Size of the node (e.g., that represents the centroid) may, in some embodiments, may represent group size of the subset (not shown here).

In some embodiments, the global object space RHD 1602 (e.g., including the leaf centroids) and/or leaf node centroids of global object space RHD 1604 may be depicted in the visualization.

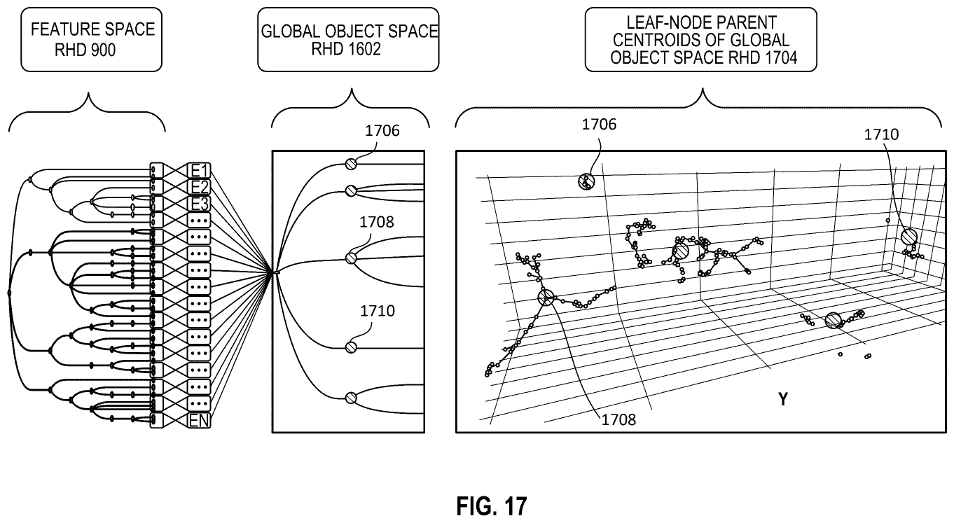

FIG. 17 depicts subset node centroids of global object space RHD 1704 in some embodiments. Working up the RHD, a centroid can be overlaid within the embedding space that approximates the relevant centroid position for each subset of data contained within the local branch. Centroids in the global object space RHD 1704 (which may correspond to the global object space RHD 1604) are depicted as large or circular objects, such as centroids 1706, 1708, and 1710 (as associated with centroids of the global object space RHD 1602).

Similar to the centroids depicted in FIG. 16, the centroids may be calculated in a manner described by other centroids herein or in any number of ways. Size of the node (e.g., that represents the centroid) may, in some embodiments, may represent group size of the subset.

In some embodiments, the global object space RHD 1602 (e.g., including the subset centroids) and/or subset node centroids of global object space RHD 1704 may be depicted in the visualization. In various embodiments, both the leaf node centroids depicted in the global object space RHD 1602 and the subset node centroids depicted in the global object space RHD 1704 may be depicted in the visualization.

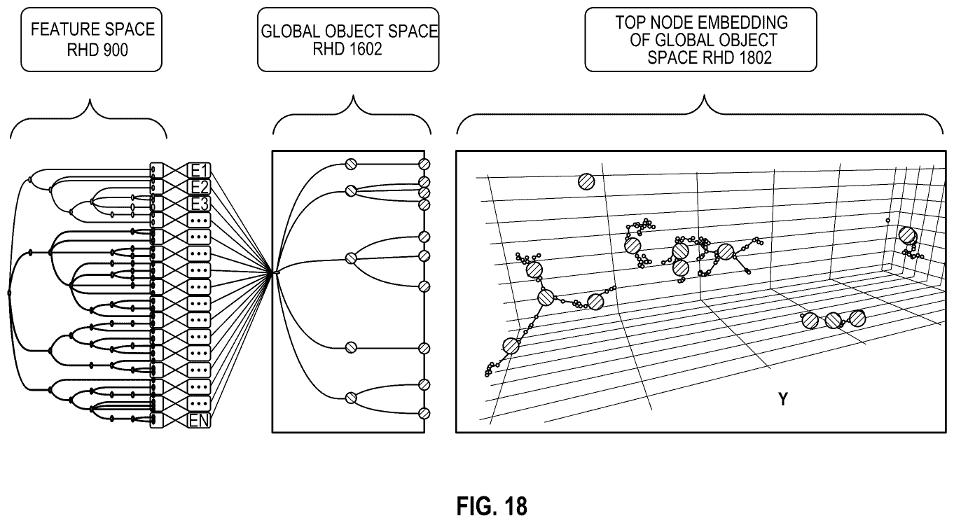

FIG. 18 depicts leaf and subset centroid placements within the embedding for each layer of the RHD in some embodiments. In FIG. 18, leaf and subset centroids are differentiated by illustrated texture (lines in different directions) and depicted in the global object space RHD 1604.

In some embodiments, the global object space RHD 1602 (e.g., including the subset centroids and leaf centroids) and/or centroids of the top node embedding of global object space RHD 1802 may be depicted in the visualization.

FIG. 19 depicts a topological summary of global object space RHD 1902 in some embodiments. The topological hierarchical decomposition shows a topological summary illustrating fully connected graph network. In this example, individual branches of the RHD summary are connected via their nearest distance of the underlying leaf nodes.

In some embodiments, the topological summary is complete when all underlying leaf node centroids are connected. Leaf nodes of the same branch node may be connected to each other and the first branch node to which it belongs. In various embodiments, leaf nodes may be connected based on a comparison of a distance metric between two or more objects or centroids of a different leaf node.

In some embodiments, the global object space RHD 1602 (e.g., including the subset centroids and leaf centroids) and/or centroids of the topological summary of global object space RHD 1902 may be depicted in the visualization.

FIG. 20 depicts an interactive visualization of the topological summary in some embodiments. In various embodiments, the topological summary can be interactively inspected. In some embodiments, Selection of a node from the summary can call the associated global object space leaf node.

The interactive visualization allows the user to observe and explore relationships in the data. In various embodiments, the interactive visualization allows the user to select nodes from the visualization. The user may then access the underlying data of the selected node (e.g., the centroid) and/or perform further analysis (e.g., statistical analysis) on the underlying data or on data as grouped within the global object space (e.g., global object space RHD selected group 2002).

In various embodiments, the user may interact with the interactive visualization depicting the topological summary of global object space RHD 1902 by selecting a centroid. In response to the selection, the interactive visualization may display the global object space RHD selected group 2002 which includes the subset of data identified by the methods discussed herein (e.g., the data for the selected centroid associated with the similar centroid of the global object space RHD 1602). It will be appreciated that the user may select any number of centroids to obtain additional diagrams graphs with the like. In various embodiments the user may be able to select one or more points or edges depicted in the global object space RHD selected group (e.g., global object space RHD select group 2002) to access the underlying data (e.g., the data from the underlying tables).

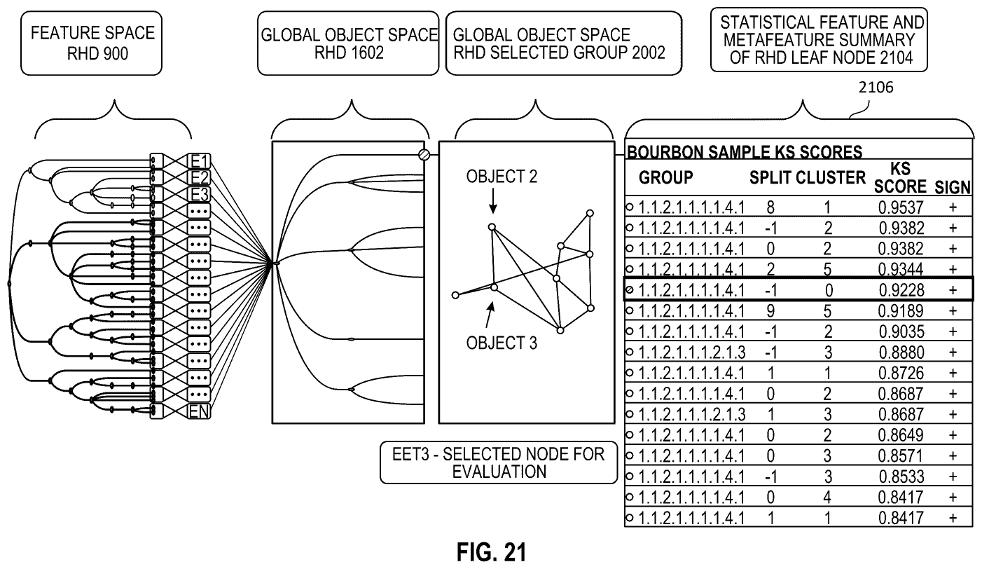

FIG. 21 depicts a statistical feature and metafeature summary of the RED leaf node in some embodiments. The object space RHD may autonomously subset the data into individual groups through the recursive RHD process. The group subset at each node within the RHD can be statistically analyzed to understand unique features that induce segmentation. Object 2 and 3, which shared a common metafeature group assignment from a local object space model also segment together within the global object space RHD 1602. The group as a whole can be analyzed statistically to identify unique features of the RHD isolated group (e.g., within the statistical feature and metafeature summary of RHD leaf node 2104).

In the interactive visualization, a user may make a selection within the interactive visualization to depict the statistical feature and metafeature summary of RHD leaf node 2104 (e.g., table of visualization 2106). In this example, the statistical analysis includes bourbon sample KS scores. The specific feature space group can be selected for explanation visualization.

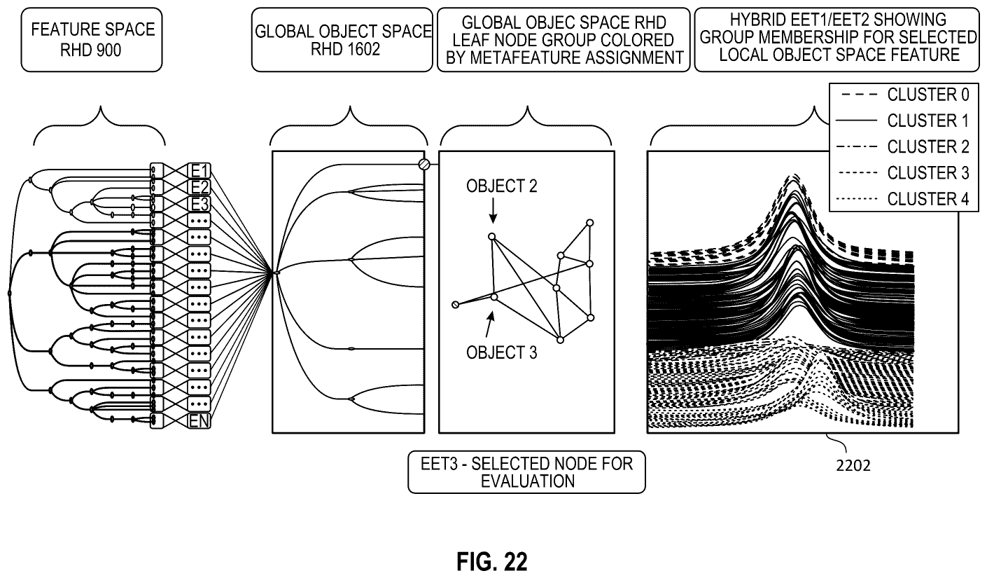

FIG. 22 depicts the hybrid EET1/EET2 showing group membership for selected local object space feature(s) in some embodiments. A global object space RHD leaf node can be colored by the underlying selected statistical features. FIG. 2202 depicts the hybrid EET1/EET2 local object space group membership as a defining feature for the selected group. Similarly, the global object space RHD can be colored by membership of metafeature group cluster assignment (blue=member of cluster 0, red=not a member of cluster 0).

In various embodiments, the visualization module 316 and/or the communication module 302 may track all transformations, and beddings, data, centroids, visualizations, and or the like and save the information a longer audit file. It will be appreciated that each step of the process from receiving of data, generating any of the connected-component networks, to projections/embeddings, identification of centroids, identification of branch points, identification of meta-features, data array creation, and/or the like can be tracked and stored for further explain ability and audit-ability. In various embodiments, a user (e.g., from a user device) may perform analysis and review the audit regarding the process for identifying inherent relationships, explanations, and the like. These audits may be useful to confirm steps, add clarity, identify areas of improvement or error, and strengthen acceptance of any conclusions.

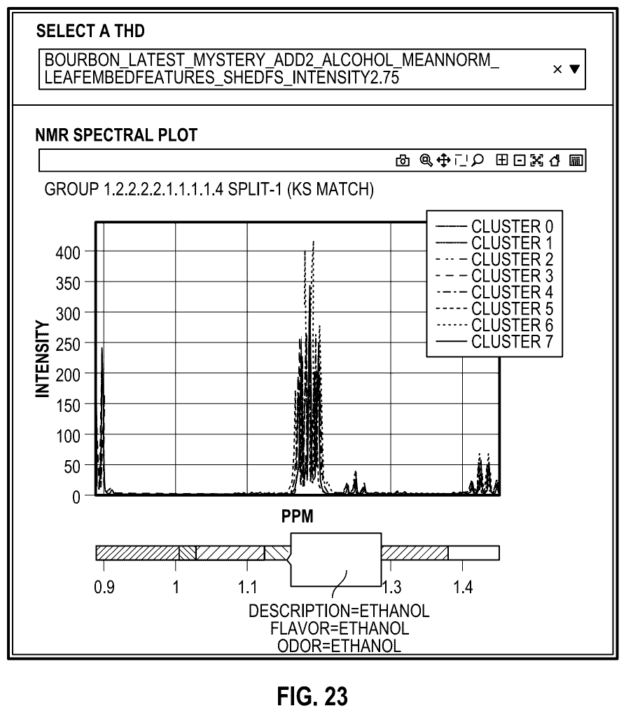

FIG. 23 depicts an interactive visualization in some embodiments. FIG. 23 depicts an example graphical user interface (GUI) for exploring unique feature sets that distinguish bourbons (e.g., using methods and/or systems described herein).

In one example of a process using methods and systems described herein is applied to bourbon analysis (e.g., analysis of bourbon). In prior analysis (unrelated to systems discussed herein) based on flavor tests, wheat bourbon's have been determined to beat rye bourbons, 12 month stave seasoning beats 6-month stave seasoning, coarse grain is preferred over average/tight, hundred 25 entry proof beats 105 entered proof, ripped warehouse beats concrete, bottom half of tree beats top half of the tree, harvest location be beats harvest location A, and char number four char number three. Barrel #80 was identified as the most preferred which was a ride bourbon, 125 entry proof, concrete warehouse, number four char, seasoned 12 month staves, bottom half of tree, and low rings per inch. In the prior analysis however, there are huge variations across customer reviews, sensory profiles, and customer preferences and general (even in expert panels).

In this example, the methodologies described herein may be applied to:
develop analytical chemistry machine learning pipelines that can develop and exploit novel patterns within the data,
develop sensory analysis methods that provide proper normalization segmentation and conductivity of metadata features across data sets, and
create highly integrated approach that enables deeper and faster identification of complex interactions that influence bourbon taste and customer preference.

The method outlined in FIG. 1 may be applied to the 80+ chemical compounds that are detected, quantified, and correlated with SOP variables and customer reviews. The data may be derived in part from gas chromatograph analysis of different bourbons. Gas chromatograph data shows that SOP bourbons are largely stratified based on five variables and to a lesser extent across experimental variables. The five variables include recipe, installation date-stave seasoning, entry proof, entry weight, and harvest location. AI approaches link customer scoring and chemical composition both globally (e.g., using chemical compounds) and at the individual chemical compound level. In this example, hundred and nine SOP barrels are included in the analysis.

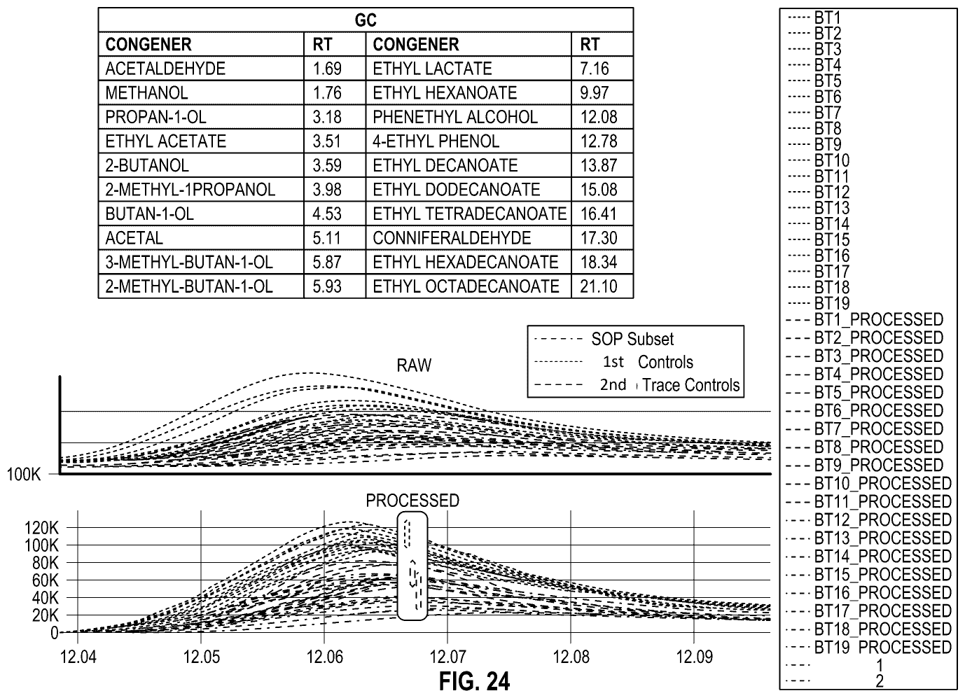

FIG. 24 is an example of a feature description for bourbons that is derived from the feature space RHD. Here, a specific range of the feature space is isolated. The user can interrogate specific traces pre- and post normalization and embeddings that may be colored by specific meta-features.

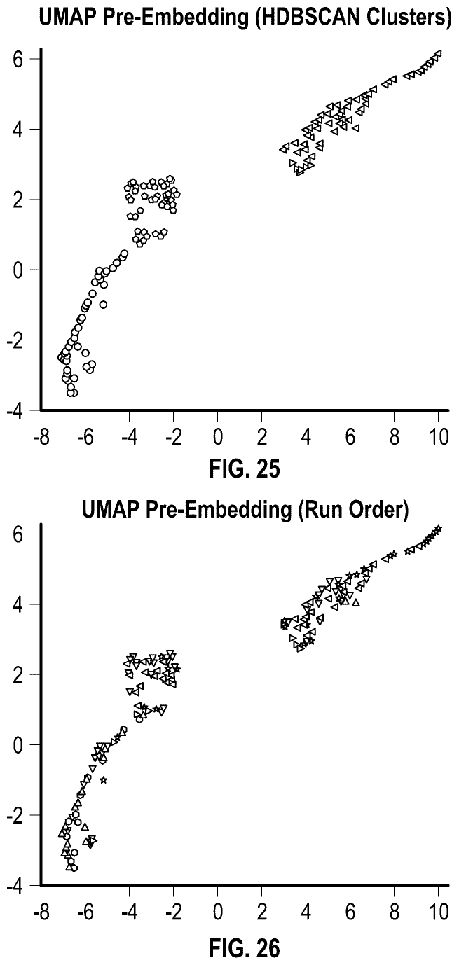

FIG. 25 depicts an example UMAP pre-embedding (HDBSCAN clusters).

FIG. 26 depicts an example UMAP pre-embedding (run order).

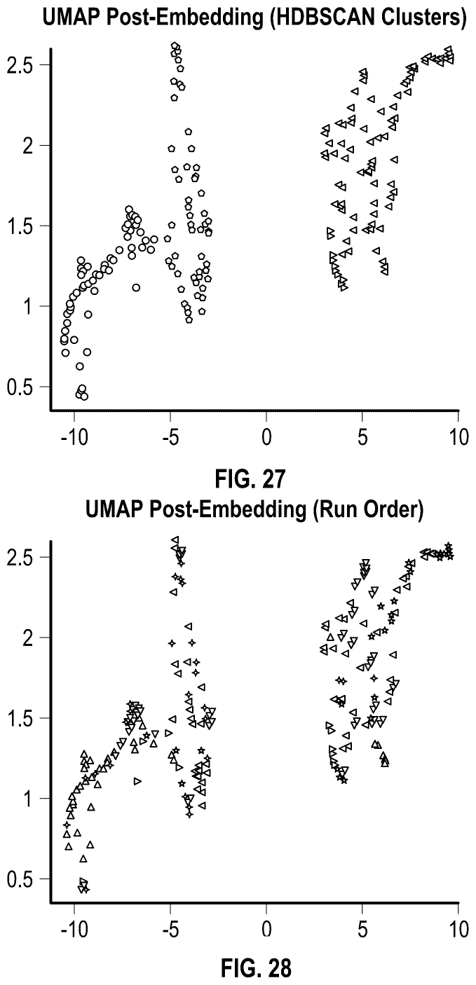

FIG. 27 depicts an example UMAP post-embedding (HDBSCAN clusters).

FIG. 28 depicts an example UMAP post-embedding (run order).

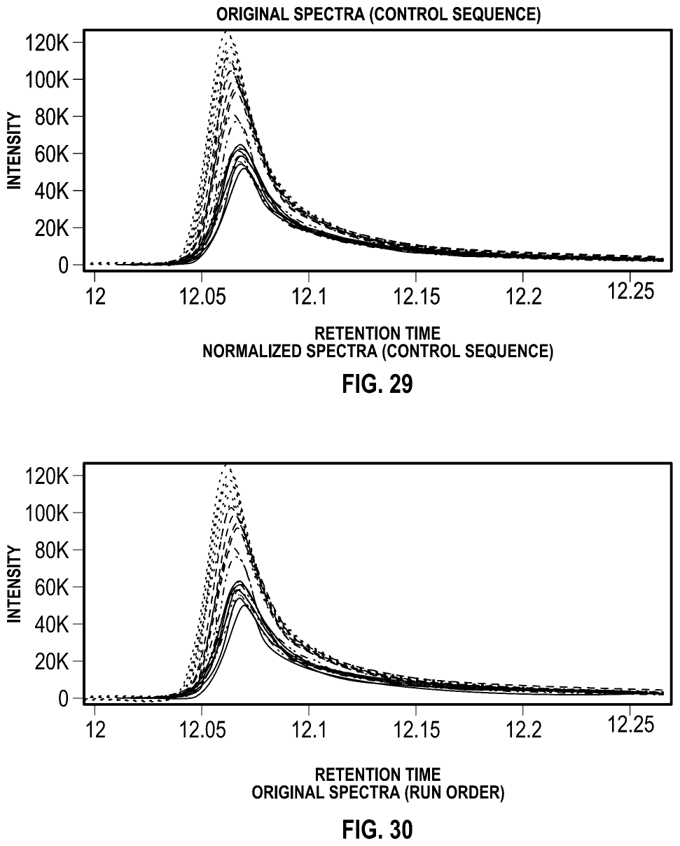

FIG. 29 depicts an example original spectra (control sequence). In this example, intensity is along the y-axis and retention time normalized spectra is along the x-axis.

FIG. 30 depicts an example retention time normalized spectra (run order) along the x-axis and intensity along the y-axis.

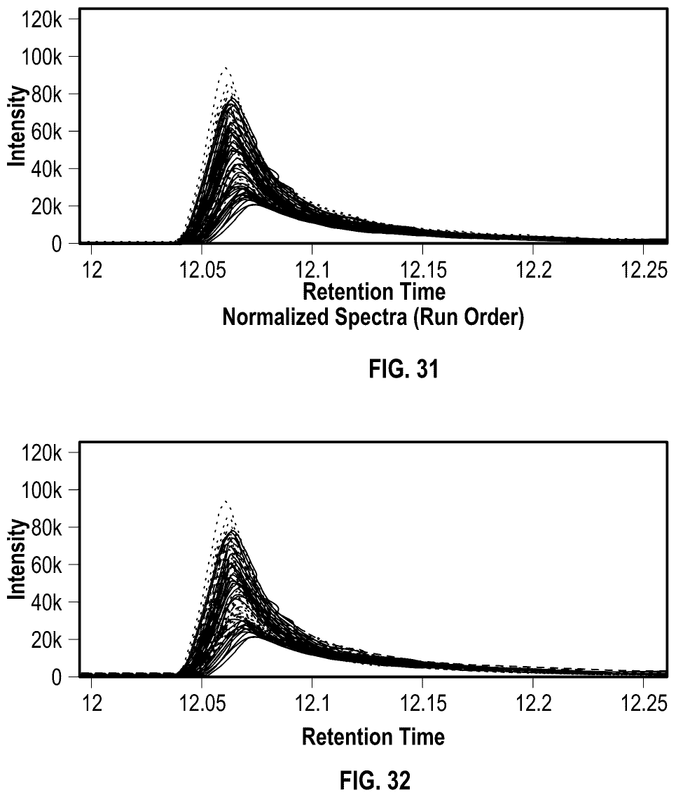

FIG. 31 depicts an example retention time normalized spectra (run order) along the x-axis and intensity along the y-axis.

FIG. 32 depicts an example retention time along the x-axis and intensity along the y-axis.

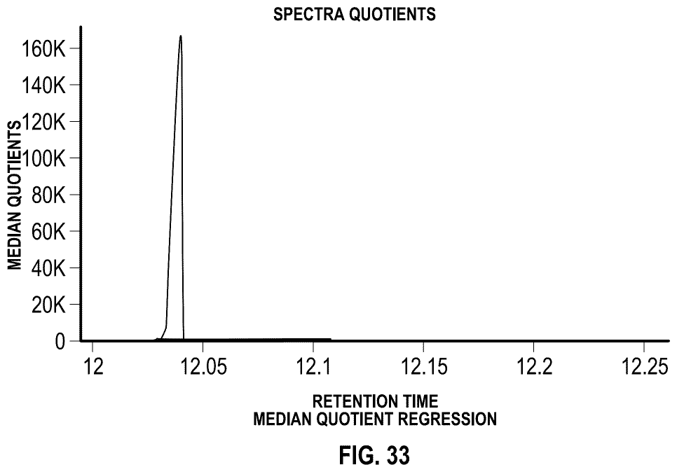

FIG. 33 depicts example spectra quotients (e.g., from the gas chromatograph). Median quotients are along the y-axis and the retention time (median quotient regression) is along the x-axis.

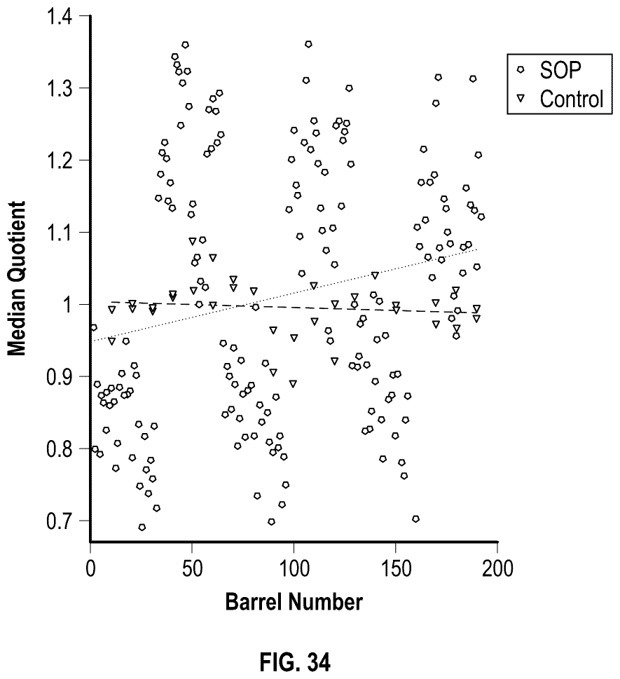

FIG. 34 depicts an example graph of SOP and control with the median quotient along the y-axis and the barrel number (e.g., for the specific barrel of bourbon) along the x-axis.

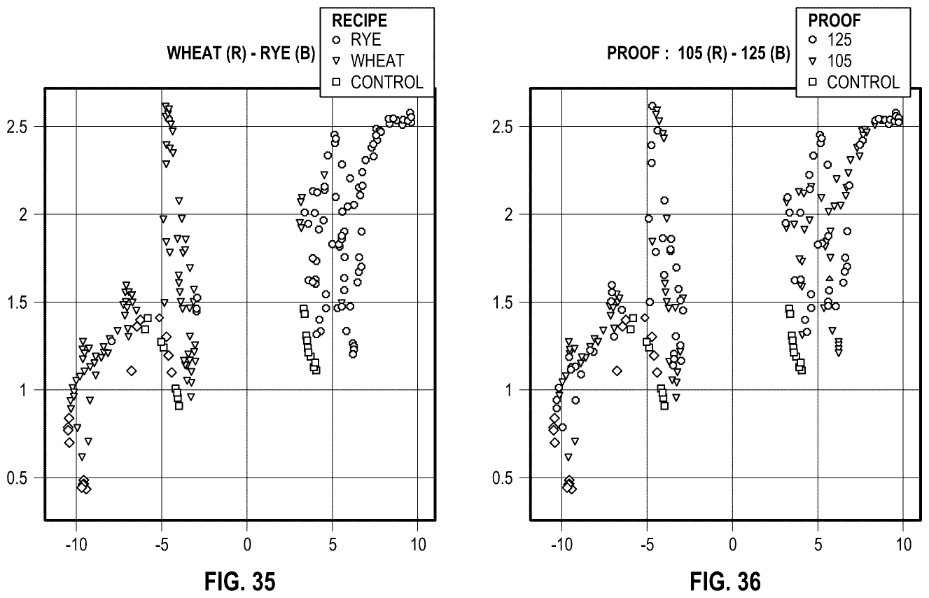

FIG. 35 depicts an example wheat to rye graph.

FIG. 36 depicts a proof 105 to proof 125 graph.

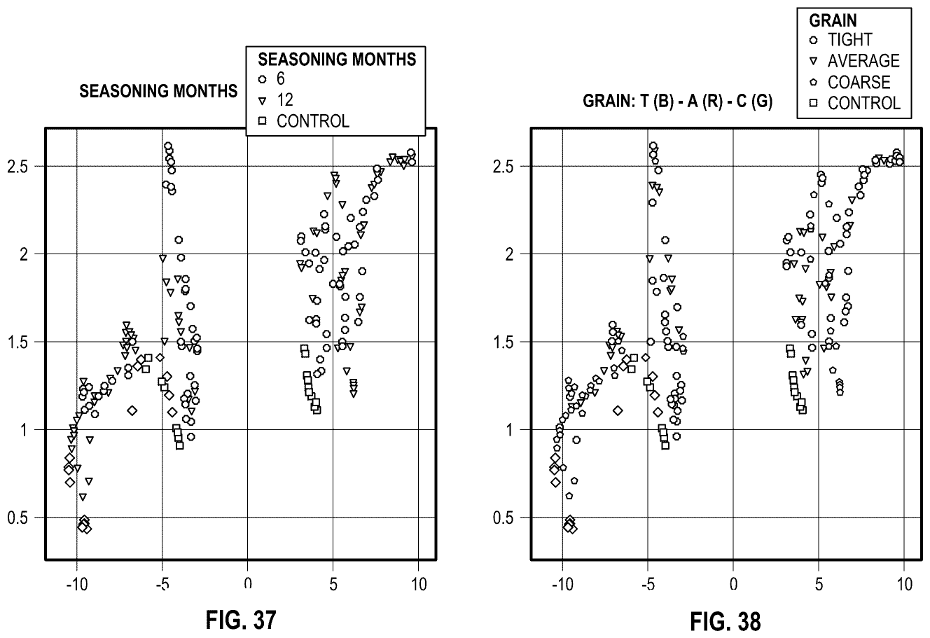

FIG. 37 depicts an example graph for seasoning of staves (e.g., comparison of 6 to 12 months).

FIG. 38 depicts an example graph of grain comparison (e.g., tight, average, coarse, and control).

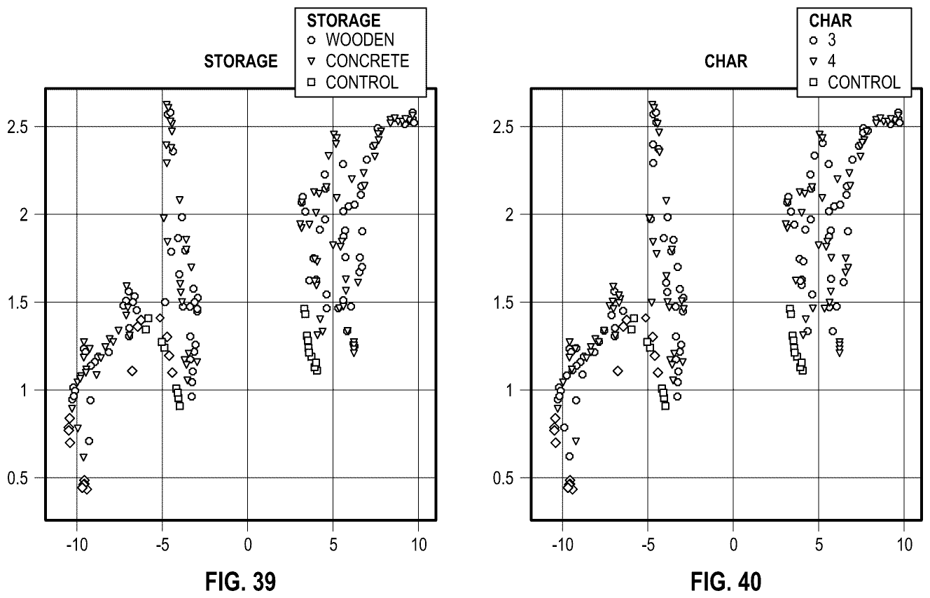

FIG. 39 depicts an example storage graph for comparison of wooden to concrete).

FIG. 40 depicts an example char graph for comparing type #3 char to type #4 char.

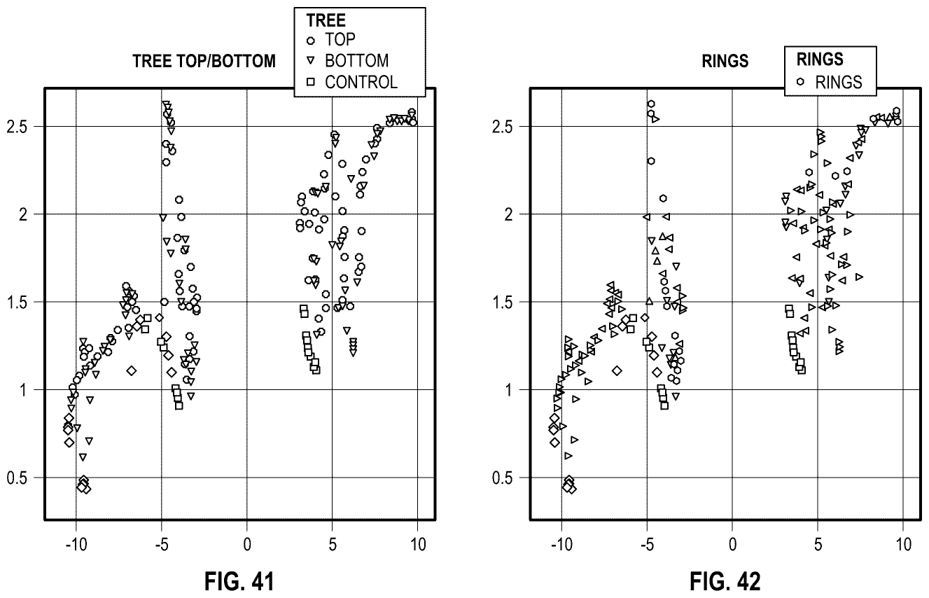

FIG. 41 depicts an example tree graph for comparison of top of tree to bottom of tree. FIG. 42 depicts an example ring graph for comparison of the number of rings.

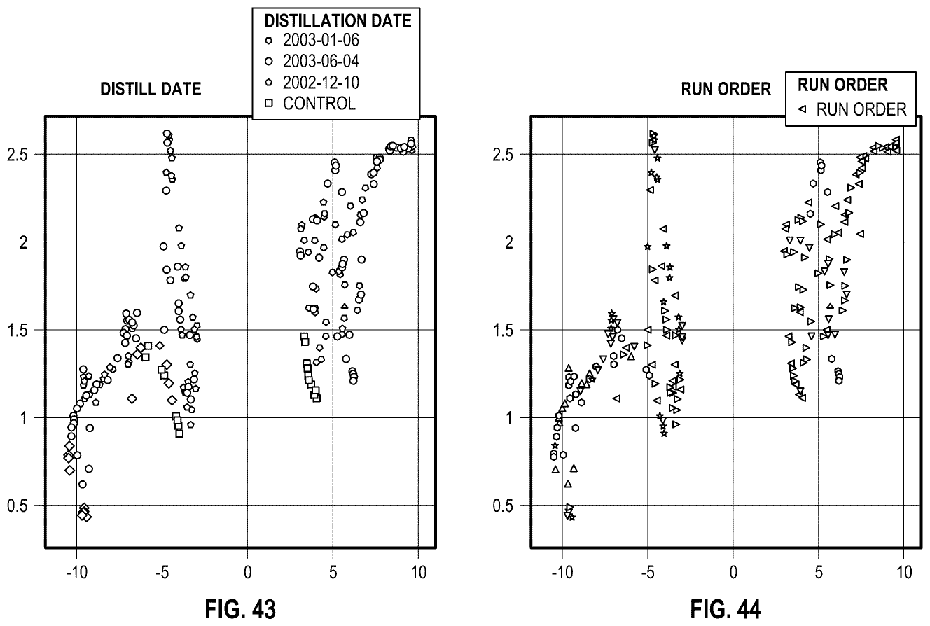

FIG. 43 depicts an example distill graph for comparison of different distillation dates.

FIG. 44 depicts a run order graph for a comparison of different run orders.

FIG. 45 depicts a block diagram of an example digital device 4500 according to some embodiments. The digital device 4500 is shown in the form of a general-purpose computing device. The digital device 4500 includes at least one processor 4502, RAM 4504, communication interface 4506, input/output device 4508, storage 4510, and a system bus 4512 that couples various system components including storage 4510 to the at least one processor 4502. A system, such as a computing system, may be or include one or more of the digital device 4500.

System bus 4512 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 4500 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 4502 is configured to execute executable instructions (for example, programs). In some embodiments, the at least one processor 4502 comprises circuitry or any processor capable of processing the executable instructions.

In some embodiments, RAM 4504 stores programs and/or data. In various embodiments, working data is stored within RAM 4504. The data within RAM 4504 may be cleared or ultimately transferred to storage 4510, such as prior to reset and/or powering down the digital device 4500.

In some embodiments, the digital device 4500 is coupled to a network, such as the communication network 112, via communication interface 4506.

In some embodiments, input/output device 4508 is any device that inputs data (for example, mouse, keyboard, stylus, sensors, etc.) or outputs data (for example, speaker, display, virtual reality headset).

In some embodiments, storage 4510 can include computer system readable media in the form of non-volatile memory, such as read only memory (ROM), programmable read only memory (PROM), solid-state drives (SSD), flash memory, and/or cache memory. Storage 4510 may further include other removable/non-removable, volatile/non-volatile computer system storage media. By way of example only, storage 4510 can be provided for reading from and writing to a non-removable, non-volatile magnetic media. The storage 4510 may include a non-transitory computer-readable medium, or multiple non-transitory computer-readable media, which stores programs or applications for performing functions such as those described herein. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 4512 by one or more data media interfaces. As will be further depicted and described below, storage 4510 may include at least one program product having a set (for example, at least one) of program modules that are configured to carry out the functions of embodiments of the invention. In some embodiments, RAM 4504 is found within storage 4510.

Programs/utilities, having a set (at least one) of program modules, such as the computer vision pipeline system 104, may be stored in storage 4510 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with the digital device 4500. Examples include, but are not limited to microcode, device drivers, redundant processing units, and external disk drive arrays, RAID systems, tape drives, and data archival storage systems, etc.

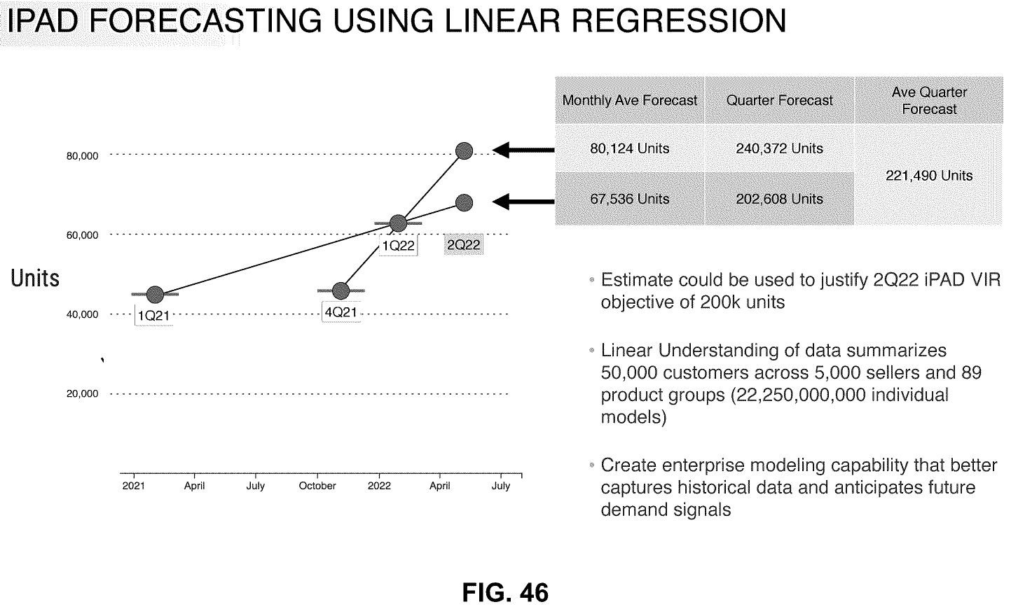

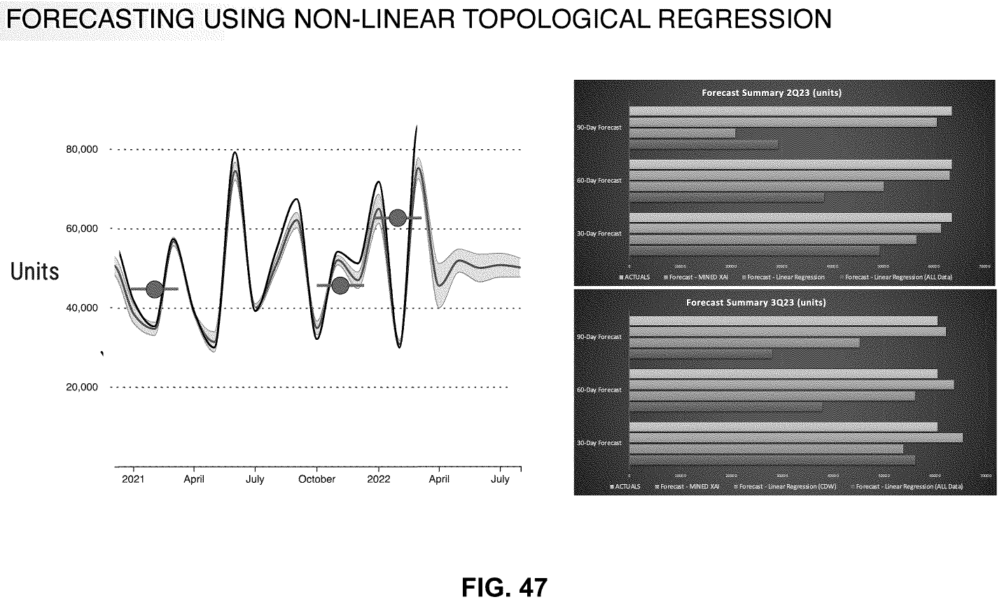

FIG. 46 is an example of IPAD forecasting for sales using a linear regression in the prior art. FIGS. 46 and 47 are examples of how methods in the prior art (e.g., regressions, recurrent neural nets, LSTMs, and the like) fail to capture non-linearities. Systems and methods of some embodiments capture non-linearities in data and can create improved forecasting.

The graph in FGI. 46 shows unit sales data across multiple quarters, with data points marked by circles connected by black lines. The vertical axis displays units ranging from approximately 20,000 to 80,000, while the horizontal axis spans from first quarter period 1Q21 through second quarter period 2Q22. The trend line demonstrates an overall upward trajectory in sales, with particularly steep growth observed in the final two data points.

FIG. 46 also includes a table displaying specific forecast values derived from the linear regression analysis. The Monthly Average Forecast is 80,124 Units and 67,536 units, while the Quarter Forecast reaches 240,372 Units and 202,608 units. The average quarter forecast is 221,490 Units.

Three conclusions include:
1. The forecast data could be used to justify a 2Q22 iPad Volume Incentive Rebate (VIR) objective of 200,000 units.
2. The linear understanding of the data summarizes 50,000 customers across 5,000 sellers and 89 product groups. This results in a total of 22,250,000,000 individual models.
3. There is an aim to create enterprise modeling capability for better capturing historical data and anticipating future demand signals.

FIG. 47 is a continued example of forecasting using non-linear topological regression in the prior art. This graph displays a time series of unit sales data from 2021 through July 2022. The line represents actual sales data, accompanied by a shaded area indicating forecast bounds or confidence intervals. The data exhibits a cyclical pattern with several peaks and troughs, demonstrating significant volatility in sales performance. Peak values reach around 80,000 units, while troughs dip to approximately 30,000-40,000 units. Three red dots with horizontal lines are marked on the graph, likely indicating specific reference points or notable events.

These figures highlight the limitations of linear regression in capturing the non-linearities present in the sales cycle, which the topological approach aims to address. The non-linear method appears to better account for the complex patterns and fluctuations in the sales data, potentially offering more accurate forecasting capabilities.

The forecast summary 2Q23 bar graph in FIG. 47 displays comparative forecasts for three time horizons: 30-day, 60-day, and 90-day. Each time horizon shows four different bars representing actual sales units and three forecasting methods: the true data (first bar), an example MINED XAI's approach (discussed herein-second bar), Linear Regression (third bar), and Linear Regression with ALL Data (fourth bar). The bars are arranged horizontally, with the actual sales units. The MINED XAI forecast bars are closest in length to the actual sales units, while the other two forecasting methods in the prior art indicate inaccurate forecasts.

Similarly, the forecast summary 3Q23 bar graph follows a similar structure to the 2Q23 graph, presenting forecasts for the same three time horizons and four categories. In this graph, the actual sales units is the first bar, an example MINED XAI's approach (discussed herein) is the second bar, Linear Regression is the third bar, and Linear Regression with ALL Data is the fourth bar. As before, the MINED XAI forecast bars remain closest to the actual sales units, while the Linear Regression and Linear Regression with ALL Data bars show greater variation from the actuals.

While two methods for linear and nonlinear regression are compared in FIGS. 46 and 47, it will be appreciated that other methods may be utilized such as recurrent neural nets, LSTMs, and/or other transformers. These systems do not capture nonlinearities in the sale cycle.

As such, the prior art regression systems, due to their inability to accurately capture the non-linearities in the sales cycle, may obscure the underlying data patterns, leading to erroneous forecasts. This technological limitation may result in a cascade of operational challenges, including poor inventory control, inaccurate ordering, and ultimately higher costs for businesses relying on these forecasting methods.

The inaccuracies inherent in these regression-based forecasting systems may also lead to misattribution of forecast errors. In some cases, external factors may be blamed for discrepancies between forecasts and actual sales performance, when in reality, these discrepancies may stem from the forecasting system's inability to accurately model complex, non-linear sales patterns. This misattribution may further compound the problem by diverting attention and resources away from addressing the root cause of forecast inaccuracies.

By contrast, a forecasting system that more accurately captures the non-linearities may represent a significant improvement over prior art regression systems. Such a system may solve a problem caused by computer technology itself-namely, the limitations of linear regression models when applied to complex, real-world data. By providing more accurate forecasts, this improved system may enable better inventory management, more precise ordering, and potentially lower operational costs.

Moreover, a more accurate forecasting system may allow businesses to better distinguish between genuine external factors affecting sales performance and artifacts of the forecasting process itself. This improved clarity may lead to more informed decision-making and a better understanding of true market dynamics.

In essence, by addressing the technological limitations of prior art regression systems, a more accurate forecasting method may not only improve the forecasting process itself but also enhance various aspects of business operations that rely on these forecasts. This technological improvement may thus have far-reaching implications for inventory management, cost control, and strategic planning in various industries.

As such, a topological approach using THDs discussed here may be utilized to capture and create forecast that are more accurate than the prior art. The THD approach discussed herein may, for example, capture non-linearities more accurately thereby enabling improved forecasting. As shown in FIG. 47, MINED XAI allows for a more accurate forecast as compared to the regression methods.

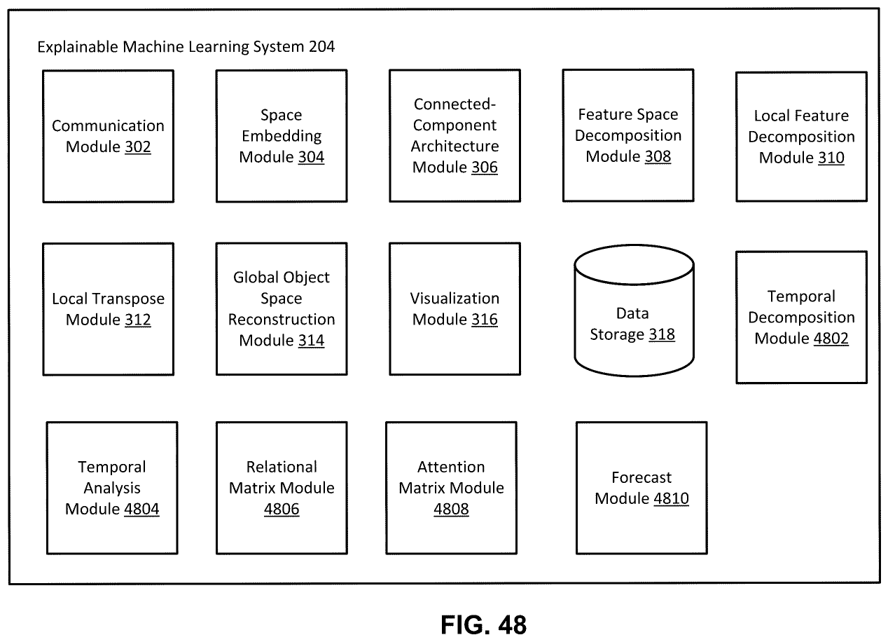

FIG. 48 depicts a block diagram of an explainable machine learning system 204 in some embodiments. The explainable machine learning system 204 comprises a communication module 302, a space embedding module 304, a connected-component network module 306, a feature space decomposition module 308, a local feature decomposition module 310, a local transpose module 312, a global object space reconstruction module 314, a visualization module 316, a data storage 318, a temporal decomposition module 4802, a temporal analysis module 4804, a relational matrix module 4806, an attention matrix module 4808, and a forecast module 4810.

The explainable machine learning system 204 may incorporate these modules to process and analyze temporal data, establish relationships between different time periods, apply attention mechanisms, and generate forecasts. The temporal decomposition module 4802 may break down time series data into various components. The temporal analysis module 4804 may examine patterns and trends across different time scales. The relational matrix module 4806 may create matrices representing relationships between different data points or time periods. The attention matrix module 4808 may generate attention weights to focus on relevant information. The forecast module 4810 may utilize the processed information to produce predictions or forecasts.

The elements of the explainable machine learning system 4800 may be similar to the explainable machine learning system 204 described in FIG. 3 in some embodiments. For example, THDs as described herein may be applied to forecasting.

Similar to FIG. 3, the communication module 302 of the explainable machine learning system 4800 may facilitate data exchange between the explainable machine learning system 204 and external systems or data sources. This module may handle input/output operations and data formatting.

The space embedding module 304 may transform input data into a suitable representation for further processing. This module may apply various embedding techniques to capture relevant features of the data.

The connected-component network module 306 may analyze relationships between different components of the data. This module may identify clusters or groups within the dataset.

The feature space decomposition module 308 may break down complex data structures into simpler, more manageable components. This module may help in understanding the underlying patterns in the data.

The local feature decomposition module 310 may focus on analyzing specific subsets or regions of the data. This module may provide detailed insights into localized patterns.

The local transpose module 312 may perform transformations on local features to prepare them for global analysis. This module may help in integrating local information into the broader context.

The global object space reconstruction module 314 may combine local features to create a comprehensive representation of the entire dataset. This module may help in understanding overall patterns and relationships.

The visualization module 316 may generate graphical representations of the data and analysis results. This module may aid in interpreting complex information through visual means.

The data storage 318 may serve as a repository for input data, intermediate results, and final outputs. This module may support efficient data retrieval and management throughout the analysis process.

The temporal decomposition module 4802 may create a series of windows of a particular unit of time in order to divide received temporal information. For example, the temporal information may be sales information for a plurality of customers that purchase a variety of products. The customers may be customers of any number of sales entities that sell any number of products. The temporal aspect of the temporal information is that the data includes an indication of time.

In some embodiments, the communication module 302 may receive the temporal information (e.g., information with temporal data) from any number of internal or external sources. The communication module 302communication module 302 may receive an indication of an initial time. The initial time (e.g., T₀) is any time. In some embodiments, the communication module 302communication module 302 may receive a unit time indicator (e.g., one month, one day, one minute, one year, or the like) to use to create windows of different lengths.

In various embodiments, the temporal decomposition module 4802 temporal decomposition module 4802 generates historical and future windows. It will be appreciated that “historical” refers to information that occurs or is associated with a date or time before the initial time and “future” refers to information that occurs or is associated with a date or time after the initial time. In one example, the “future” for future windows is not in the future of the present time. For example, the initial time may be Jan. 1, 2023 and future windows include sales information that occurred after that initial time and/or date.

The temporal analysis module 4804 analyzes and performs matrix multiplication across different relational and attention matrices discussed herein.

The relational matrix module 4806 may generate any number of relational “key” matrices based on distance metrics as applied to embeddings in past THDs associated with historical windows created by the temporal decomposition module 4802. Similarly, the relational matrix module 4806 may generate any number of relational “key” matrices based on distance metrics as applied to embeddings in future THDs associated with future windows created by the temporal decomposition module 4802.

The attention matrix module 4808 generates past window customer attention matrices that identify entity membership of groups across historical time subsets based on embeddings in past THDs associated with historical windows created by the temporal decomposition module 4802. Similarly, the attention matrix module 4808 generates future window customer attention matrices that identify entity membership of groups across future time subsets based on embeddings in future THDs associated with historical windows created by the temporal decomposition module 4802.

The forecast module 4810 may generate forecasts based on the matrix multiplication of the temporal analysis module 4804. In some embodiments, the visualization module 316 generates a dashboard displaying the information. For example, when the temporal information includes sales information, the dashboard may display customers purchasing habits and products purchased on before and after the initial date and/or forecasts of product purchases, inventory for the product(s), future orders for inventory of the product purchases and/or the like.

In various embodiments, the forecast module 4810 compares forecasts to thresholds to indicate if demand is higher or lower than the threshold and provides an alert to a user (e.g., text, SMS text, app alert, email, phone call, and/or the like) indicating that demand is higher or lower than the threshold (e.g., which may indicate that stock is insufficient or that too much product is at hand).

In some embodiments, the forecast module 4810 evaluates manufacturer or distributor incentives for sales of one or more products. It will be appreciated that there may be any number of incentives for different products. The incentives may also have expiration dates that, after which, the incentives are no longer offered. Incentives may include a cost savings or a bonus. In various embodiments, the forecast module 4810evaluates the different incentives based on the forecasted demand and sends alerts to a user when forecasted demand is at or above a threshold for a particularly favorable incentive. For example, the forecast module 4810 may determine optimizations of incentives based on forecasted demand and provide an alert to alert the user that effort to increase sales of products already at sufficient demand will produce even more incentives for that product. Alternately, even if the incentives are high but the demand is forecasted to be low based on the analysis herein, the forecast module 4810 may not generate an alert in favor of higher revenue generated by incentives that may not be as high but have better forecasted demand thereby optimizing revenue generation.

It will be appreciated that the forecast module 4810 may operate in real time in that the forecast module 4810 may evaluate incentives in view of forecasted demand and provide alerts to maximize or improve revenue before an incentive expiration date associated with the preferred or optimized incentives.

In some embodiments, the forecast module 4810 may receive a plurality of incentive offers from a plurality of manufacturers for volume sales of a plurality of products. In this example, each of the incentives of the plurality of incentives may offer a bonus for sales of at least one product of the plurality of products. One or more of the incentives may have an expiration date each of which expires after a particular time. In this example, the forecast module 4810 may identify forecasted demand for a product applicable to or associated with the volume-based incentives. The forecast module 4810 may compare forecasted demand for different products and compare overall incentives for a particular number of different products with high forecasted demand relative to the forecasted demand of the different products. Based on the comparisons, the forecast module 4810 may generate and provide an alert to a user when forecasted demand for at least one of the plurality of products is higher than other products of the plurality of products before a particular expiration date expires and when the overall incentive if above an incentive threshold.

In some embodiments, the forecast module 4810 may provide evaluate inventory levels for one or more products based on the forecasts and generate an alert to a user when inventory is above a particular threshold or below a particular threshold based on forecasting to enable the user to purchase or not purchase one or more products based on forecasted demand such that inventory levels are not critically low or extremely high relative to demand.

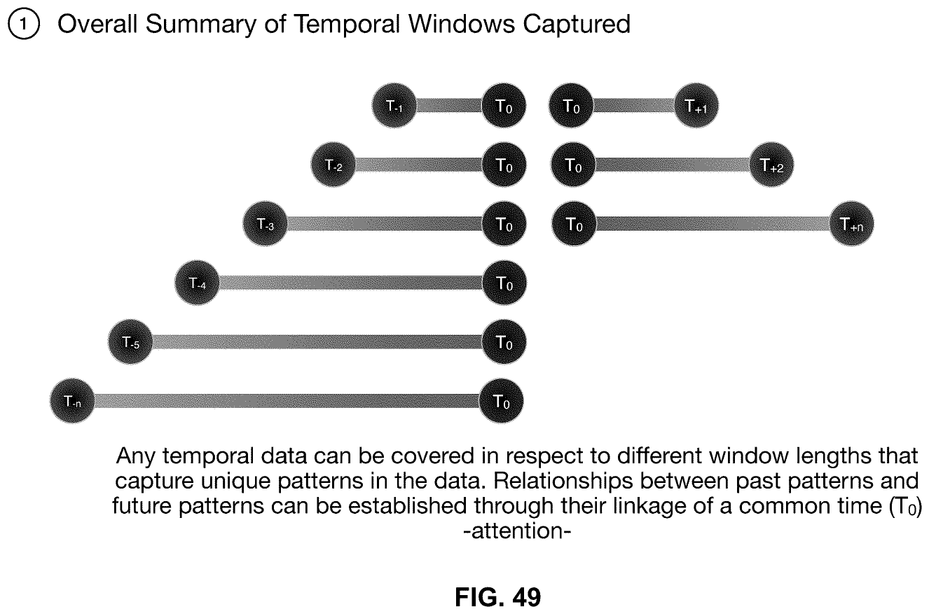

FIG. 49 is a diagram of an overall summary of temporal windows captured in some embodiments. In various embodiments, the temporal decomposition module 4802 may receive temporal data from various sources. Temporal data may include any data with a time dimension, such as sales data, weather data, manufacturing data, economic data, or analytical data. The module may also receive an indication of a particular time point, referred to as T₀.

In processing the temporal data, the temporal decomposition module 4802 may generate multiple time windows. These windows may include future time windows and historical time windows, all anchored around the specified TO point. TO may be any point in time and is not limited to a current time (although it could be a current time). In one example, TO is a current time or any historical time.

For future time windows, the module may create windows that start at T₀ and extend forward in time. Each of these windows may have a different duration in length, potentially capturing different future time horizons. For example, the module may generate windows such as T₀ to T+1, T₀ to T+2, and so on. For example, T₀ (i.e., the initial time) may be a particular time and date, while T+1 is a duration of time since T₀ (e.g., 3 days since T₀). In this example, T+2 is a longer duration of time since T₀ (e.g., 6 days since T₀). It will be appreciated that the future time windows refer to the chronological time after T₀ where there is data/information.

Similarly, for historical time windows, the module may create windows that end at T₀ and extend backward in time. These windows may also vary in length, allowing for analysis of historical data over different time scales. Examples of such windows may include T−1 to T₀, T−2 to T₀, and so forth. For example, while T−1 is a duration of time ending at T₀ (e.g., 3 days until T₀). In this example, T−2 is a longer duration of time ending at T₀ (e.g., 6 days until T₀).

Any temporal data can be covered in respect to different window lengths that capture unique patterns in the data. Relationships between past patterns and future patterns can be established through their linkage of a common time T₀).

The number of historical and future time windows generated by the module may differ, depending on the specific requirements of the analysis or the nature of the temporal data being processed.

In some implementations, the temporal decomposition module 4802 may generate output in the form of structured time windows. For instance, given a dataset of sales information spanning several months and a specified T₀, the module may produce a set of future and past windows. These windows may be defined by their start and end dates, capturing different temporal spans relative to T₀.

The temporal decomposition performed by this module may serve as a foundation for subsequent analysis by other components of the explainable machine learning system 204. By breaking down temporal data into various windows, the module may enable more nuanced analysis of patterns and trends across different time scales, potentially improving the accuracy and interpretability of forecasts generated by the system.

In some embodiments, the historical time windows preserves temporally occurring sequence of features that terminates in T₀. The historical time windows may represent prior experiences that lead to understanding at T₀. It will be appreciated that that the shape of the time sequence may provide further context of prior outcomes. Historical time windows may have different lengths, may overlap, and may be of differing resolutions.

Future time windows may temporarily preserve occurring sequence of features that start in the initial time T₀. The future time windows may represent future experiences from the T₀ understanding. The shape of the future time sequences may provide further context for future outcomes. Future time windows may have different lengths, may overlap, and may be of differing resolutions.

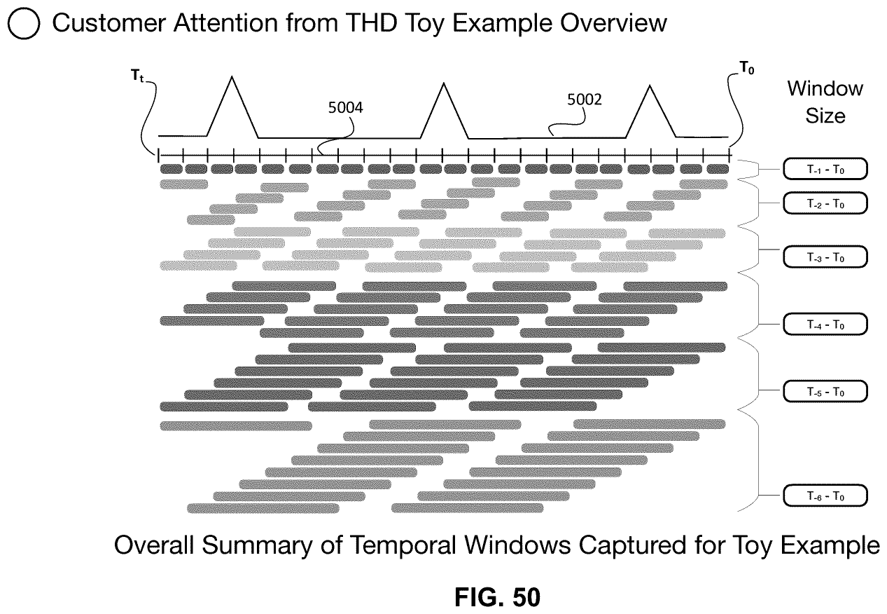

FIG. 50 is another example of window sizes based on a THD toy example overview in some embodiments. In some embodiments, windows of different durations (e.g., lengths of time) are anchored at a central point, T₀ (which can be in the past or present). The temporal decomposition module 4802 may generate:
Historical windows: End at T₀ and extend backward (e.g., T−1 to T₀, T−2 to T₀ . . . T−N to T₀), and
Future windows: Start at T₀ and extend forward (e.g., T₀ to T+1, T₀ to T+2 . . . T+X to T₀).
   Where N and X are any positive integer. N may be the same or different than X.

Regarding historical time windows, each historical window covers a longer duration than the one before and contains multiple overlapping sets. Each set has a fixed duration equal to the full span of that time window. Sets shift backward incrementally (e.g., by 1 unit of time), producing overlapping windows.

Similarly, regarding future time windows, each future window covers a longer duration than the one before and contains multiple overlapping sets. Each set has a fixed duration equal to the full span of that time window. Sets shift forward incrementally (e.g., by 1 unit of time), producing overlapping windows.

In various embodiments:
Each window set (e.g., of T−4 to T₀) overlaps with adjacent windows of the same type.

Shorter time window sets (e.g., T−1 to T₀) are nested within or fully contained in longer window sets (e.g., T−2 to T₀, T−3 to T₀).

The time periods themselves are sequential, equal-sized, and non-overlapping, forming the atomic units from which longer windows are constructed. Scalability: The window length and number of sets increase with the value of N in T−N to T0.

In FIG. 50, historical time windows are displayed. The signal 5002 is displayed at the top of the figure. The signal 5002 continues over time. Time periods 5004 are identified below the signal 5002. The time periods 5004 are sequential and divided into sets of data, each of equal length (e.g., equal duration of time). The sets of data of time periods 5004 do not overlap with each other and completely cover the data for a particular time period beginning at a particular time and ending at T₀. Each set is the same size as (T−1 to T₀) in this example.

In this example, the temporal decomposition module 4802 may break down time data into windows. the temporal decomposition module 4802 may receive a particular time (e.g., T₀) and a particular historical end time (e.g., Tt).

Each set for each time window contains a portion of the signal data based on the signal 5002 in this example. The first historical time window is (T−1)−T₀ and covers multiple sets, each set including the same duration of time ((T−1)−T₀) and covers all of the data from a particular historical time period to T₀. Each set is of the same duration. In this example, each time period of the time periods 5004 match a particular set of (T−1)−T₀.

The second time window is (T−2)−T₀ includes a plurality of different sets of a different duration than that of (T−1)−T₀. In this example, (T−2)−T₀ is the same duration as two sets of the time periods 5004. Each set of (T−2)−T₀ may overlap (at least partially) with another set of (T−2)−T₀. In this example, the first four sets include a duration (e.g., a length) of (T−2)−T₀. The first set starts with T−2 and ends at T₀. The second set starts at (T−2)−1 and ends at T₀−1. The third set starts at (T−2)−2 and ends at T₀−2, and the fourth set starts at (T−2)−3 and ends at T₀−3). The next four sets continue the pattern. There may be any number of sets. covering the time range. It will be appreciated that each set contains data that overlaps (at least partially) another set within (T−2)−T₀. Similarly, the data in each set of (T−1)−T₀ is contained within at least one set of (T−2)−T₀ or is contained in at least two sets of (T−2).

The third time window is (T−3)−T₀ includes a plurality of different sets of a different duration than that of (T−1)−T₀ and (T−2)−T₀. In this example, (T−3)−T₀ is the same duration as three sets of the time periods 5004. Each set of (T−3)−T₀ may overlap (at least partially) with another set of (T−3)−T₀. In this example the first four sets include a duration (e.g., a length) of (T−3)−T₀. The first set starts with T−3 and ends at T₀. The second set starts at (T−3)−1 and ends at T₀−1. The third set starts at (T−3)−2 and ends at T₀−2, and the fourth set starts at (T−3)−3 and ends at T₀−3). The next four sets continue the pattern. There may be any number of sets. covering the time range. It will be appreciated that each set contains data that overlaps (at least partially) another set within (T−3)−T₀. Similarly, the data in each set of (T−1)−T₀ is contained within at least one set of (T−3)−T₀ or is contained in at least two sets of (T−2).

The fourth time window is (T−4)−T₀ includes a plurality of different sets of a different duration than that of (T−1)−T₀, (T−2)−T₀, and (T−3)−T₀. In this example, (T−4)−T₀ is the same duration as four sets of the time periods 5004. Each set of (T−4)−T₀ may overlap (at least partially) with another set of (T−4)−T₀. In this example, the first five sets include a duration (e.g., a length) of (T−4)−T₀. The first set starts with T−4 and ends at T₀. The second set starts at (T−4)−1 and ends at T₀−1. The third set starts at (T−4)−2 and ends at T₀−2, the fourth set starts at (T−4)−3 and ends at T₀−3), and the fifth set starts with (T−4)−4 and ends at T₀−4. The next five sets continue the pattern. There may be any number of sets. covering the time range. It will be appreciated that each set contains data that overlaps (at least partially) another set within (T−4)−T₀. Similarly, the data in each set of (T−4)−T₀ is contained within at least one set of (T−3)−T₀ or is contained in at least two sets of (T−2).

The fifth time window is (T−5)−T₀ includes a plurality of different sets of a different duration than that of (T−1)−T₀, (T−2)−T₀, (T−3)−T₀, and (T−4)−T₀. In this example, (T−5)−T₀ is the same duration as six sets of the time periods 5004. Each set of (T−5)−T₀ may overlap (at least partially) with another set of (T−5)−T₀. In this example, the first six sets include a duration (e.g., a length) of (T−5)−T₀. The first set starts with T−5 and ends at T₀. The second set starts at (T−5)−1 and ends at T₀−1. The third set starts at (T−5)−2 and ends at T₀−2, the fourth set starts at (T−5)−3 and ends at T₀−3), the fifth set starts with (T−5)−4 and ends at T₀−4, the sixth set starts with (T−5)−5 and ends at T₀−5. The next six sets continue the pattern. There may be any number of sets. covering the time range. It will be appreciated that each set contains data that overlaps (at least partially) another set within (T−5)−T₀. Similarly, the data in each set of (T−5)−T₀ is contained within at least one set of (T−3)−T₀ or is contained in at least two sets of (T−2).

The sixth time window is (T−6)−T₀ includes a plurality of different sets of a different duration than that of (T−1)−T₀, (T−2)−T₀, (T−3)−T₀, (T−4)−T₀, and (T−5)−T₀. In this example, (T−6)−T₀ is the same duration as eight sets of the time periods 5004. Each set of (T−6)−T₀ may overlap (at least partially) with another set of (T−6)−T₀. In this example, the first eight sets include a duration (e.g., a length) of (T−6)−T₀. The first set starts with T−6 and ends at T₀. The second set starts at (T−6)−1 and ends at T₀−1. The third set starts at (T−6)−2 and ends at T₀−2, the fourth set starts at (T−6)−3 and ends at T₀−3), the fifth set starts with (T−6)−4 and ends at T₀−4, the sixth set starts with (T−6)−5 and ends at T₀−5, the seventh set starts with (T−6)−6 and ends at T₀−6, and the eight set starts with (T−6)−7 and ends at T₀−7. The next eight sets continue the pattern. There may be any number of sets. covering the time range. It will be appreciated that each set contains data that overlaps (at least partially) another set within (T−6)−T₀. Similarly, the data in each set of (T−6)−T₀ is contained within at least one set of (T−3)−T₀ or is contained in at least two sets of (T−2).

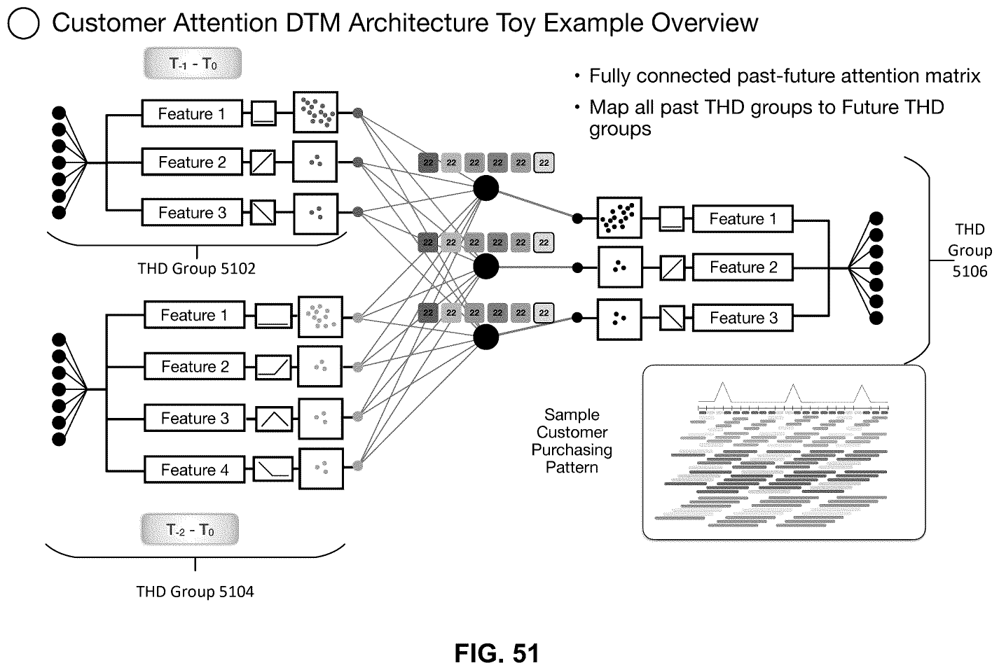

FIG. 51 is an example of a DTM architecture in a toy example overview. Here, two separate THDs are generated. The first THD is of the first time set (T1−T₀) and the second THD is of the second time set (T2−T₀) which are used to create a forecast. In this example, the forecast is a fully connected past-future attention matrix to map THD groups of the past to future THD groups.

In this example, these time windows are shown in FIG. 50 and the signal being analyzed is signal 5002 (FIG. 51 further depicts FIG. 50 and is labeled “sample customer purchasing pattern.” For the time sets (T1−T₀), feature 1 is a straight line, feature 2 is a rising line, and feature 3 is a descending line. The time sets (T2−T₀) have a longer duration than (T1−T₀) so encompass more information of the signal. As a result, the features contained in sets based on the longer time windows have more information. In this example, for the time sets (T2−T₀), feature 1 is a straight line, feature 2 is a straight line followed by an incline, feature 3 is an incline followed by a decline, and feature four is a decline followed by a straight line.

These features of the different time sets are observable in FIG. 50. In some embodiments, longer time sets (e.g., those above the smallest time sets) include features that include information that is similar or overlaps each other. FIG. 51 depicts an example customer attention DTM architecture toy example overview in some embodiments. FIG. 51 depicts an example sample customer purchasing pattern which refers to FIG. 50. In FIG. 51, THD group 5102 refers to a THD created based on past time set T−1 to T₀ (e.g., that refers to the highest level of sets depicted in FIG. 50). There are three features represented in THD group 5102. THD group 5104 refers to a THD created based on past time set T−2 to T₀ (e.g., the second highest level of sets depicted in FIG. 50).

As discussed herein, a THD is defined as a topological hierarchical decomposition (THD). The process described with regard to FIGS. 4A and 4B is applied to the sets T−1 to T₀ to generate THD group 5102, Similarly, the process described with regard to FIGS. 4A and 4B is applied to the sets T−2 to T₀ to generate THD group 5104.

THD group 5102 includes three features for the signal line 5002. THD group 5102 includes four features of the signal line 5002 (having a wider window, the sets contain more information).

THD group 5106 is a future window. For example, THD group 5106 may be based on T₀ to T+1.

FIG. 51 depicts a full connected network with the middle of FIG. 51 depicting connections with each set of all the past sets of FIG. 50 (e.g., not limited to the first two sets of T−1 to T₀ and T−2 to T₀). The three leaf nodes of the future (THD group 5106) may be connected to all leaf nodes of the past windows (e.g., leaf nodes of T−1 to T₀ (THD group 5102) and leaf nodes of T−2 to T₀ (THD group 5104). The center figure indicates how many past windows may be connected from the windows identified in FIG. 50.

It will be appreciated that if there was no understanding of the topological network distributions, then a fully connected network like that depicted in FIG. 51 may be generated, and then supervision may be applied to remove or reweight edges.

Alternately, if there is an understanding of the topological network distributions, certain edges may be removed (e.g., to remove edges between past to future states that are not possible).

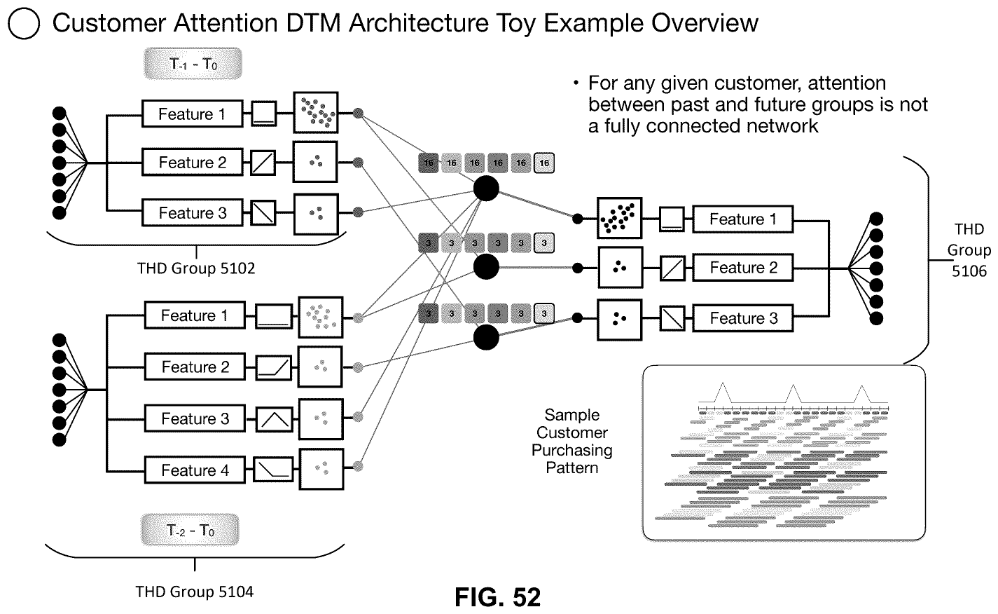

For example, FIG. 52 depicts the same THD groups 5102, 5104, and 5106 but with certain edges removed in order to eliminate edges that otherwise would be connected between impossible future states. As such, for a given customer, in this example, attention between past and future groups is not fully connected. As such, the overhead, speed, and/or scalability may be greatly increased by removing these edges (e.g., as compared to a fully connected network approach as discussed regarding FIG. 51).

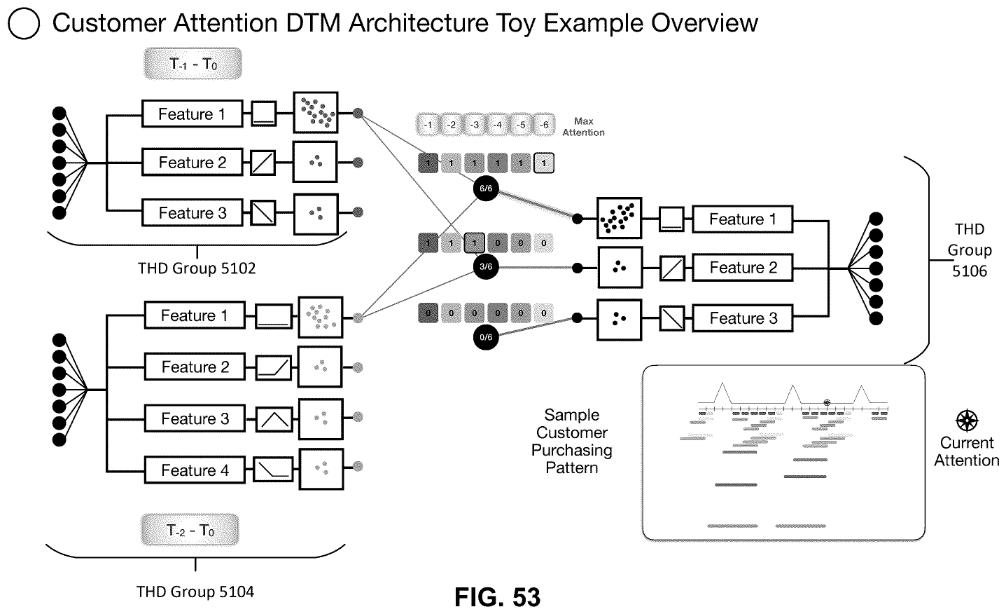

FIG. 53 depicts the same THD groups 5102, 5104, and 5106 in an example that illustrates attention in one example. In this example, a value of one has been normalized to softmax. As such, anytime there is a connection between two states, even if it was some normalized value of point two, a value of one is applied. If there is no connection, a value of zero is applied. In this figure, connections exist where they are labeled as “one” or no connection exists where they are labeled as “zero) (e.g., see middle of FIG. 53).

Since there are strong connections of the “flat” features depicted in FIG. 53 from THD groups 5102 and 4104 to possible future of feature 1 (a value of six), the forecast indicates the immediate future as flat.

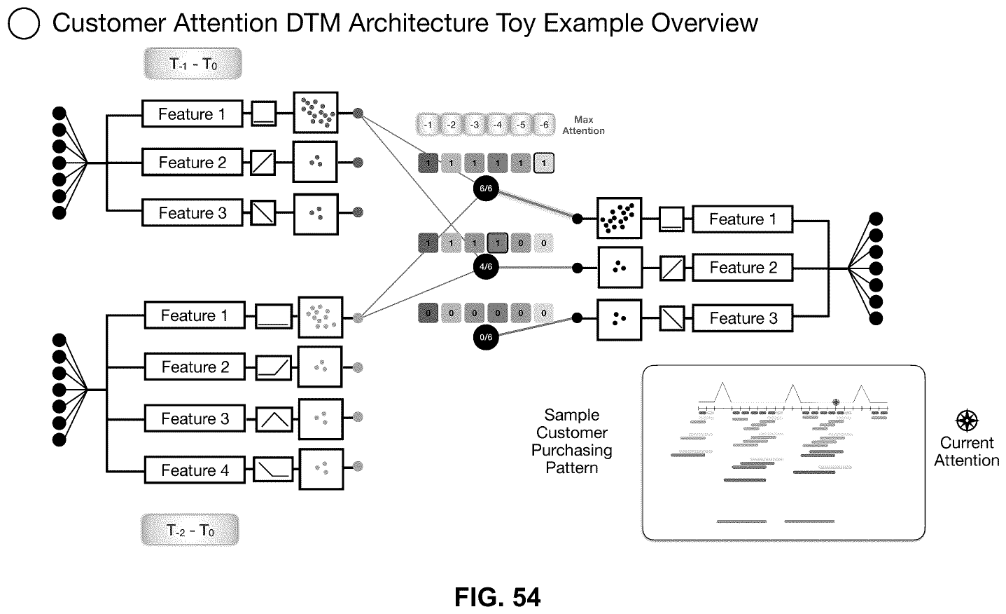

FIG. 54 depicts the same THD groups 5102, 5104, and 5106 in an example that illustrates attention in a step forward in time relative to the future time in FIG. 53. In this example, the sample customer purchasing pattern indicates that current attention is one step forward relative to the current attention indicated in FIG. 53.

Again, the “flat” features of THD groups 5102 and 5104 indicate a “one” where there is an edge and a “zero” where there is no edge. There is still full attention across all features to forecast that at this future attention point the line should be flat. However, there is an increase in attention in the secondary feature of the rising edge. There is still six out of six attention for the first future feature and only four out of six for the secondary future feature. As such, based on weighting, comparison, or other mathematical/statistical techniques, the future forecast remains straight.

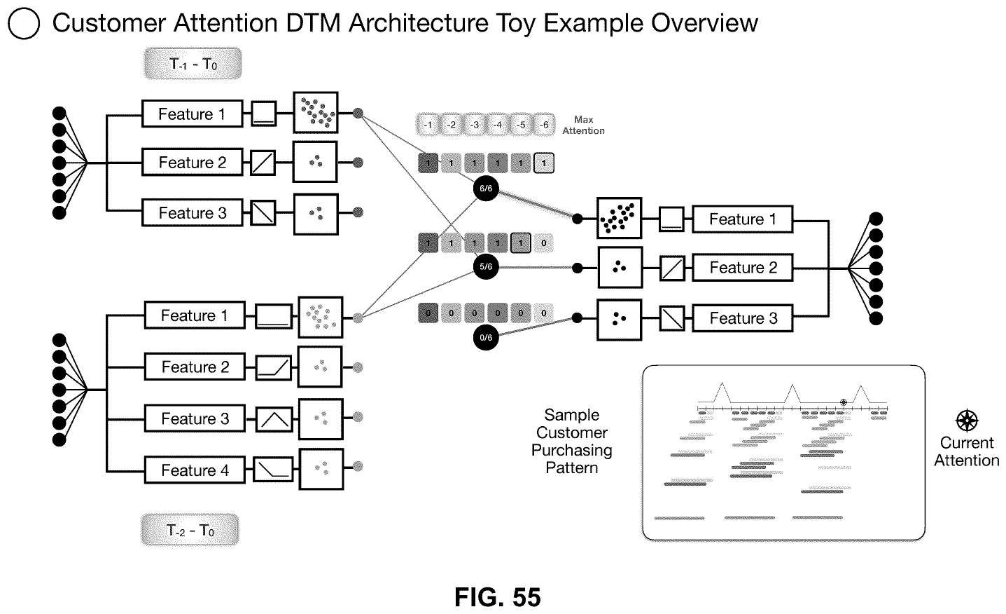

FIG. 55 depicts the same THD groups 5102, 5104, and 5106 in an example that illustrates attention in a step forward in time relative to the future time in FIG. 54 (and two steps forward relative to FIG. 53).

Again, the “flat” features of THD groups 5102 and 5104 indicate a “one” where there is an edge and a “zero” where there is no edge. There is still full attention across all features to forecast that at this future attention point the line should be flat. However, there is a further increase in attention in the secondary feature of the rising edge. There is still six out of six attention for the first future feature and only five out of six for the secondary future feature. As such, based on weighting, comparison, or other mathematical/statistical techniques, the future forecast remains straight.

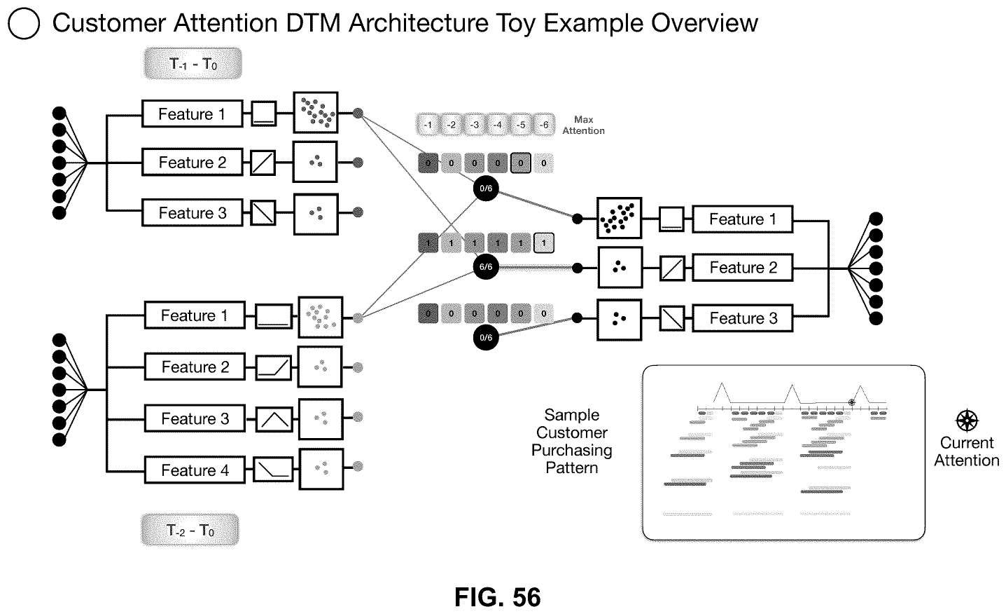

FIG. 56 depicts the same THD groups 5102, 5104, and 5106 in an example that illustrates attention in a step forward in time relative to the future time in FIG. 55 (and three steps forward relative to FIG. 53). In this example, the attention is point is at the start of a rising line.

Here, the “flat” features of THD groups 5102 and 5104 indicate a “one” where there is an edge and a “zero” where there is no edge. There is now no attention across all features that are associated with a flat line. Attention across features connected to the rising line (e.g., feature 2 of the future THD) is now at full attention and there is no attention to the future feature 3 indicating a falling line. There is six out of six attention for the second future feature. As such, based on weighting, comparison, or other mathematical/statistical techniques, the future forecast is a rising line.

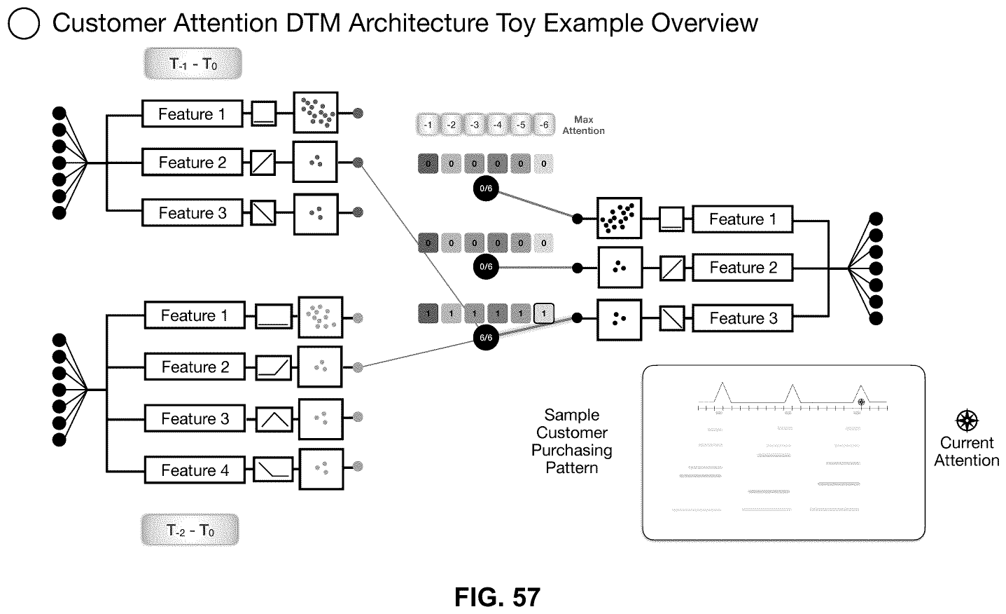

FIG. 57 depicts the same THD groups 5102, 5104, and 5106 in an example that illustrates attention in a step forward in time relative to the future time in FIG. 56 (and four steps forward relative to FIG. 53). In this example, the attention is point is at the start of a declining line.

As discussed herein, the “flat” features of THD groups 5102 and 5104 indicate a “one” where there is an edge and a “zero” where there is no edge. There is no attention across all features that are associated with a flat line or a rising line. Attention across features connected to the declining line (e.g., feature 3 of the future THD) is now at full attention and there is no attention. There is six out of six attention for the second future feature. As such, based on weighting, comparison, or other mathematical/statistical techniques, the future forecast is a declining line.

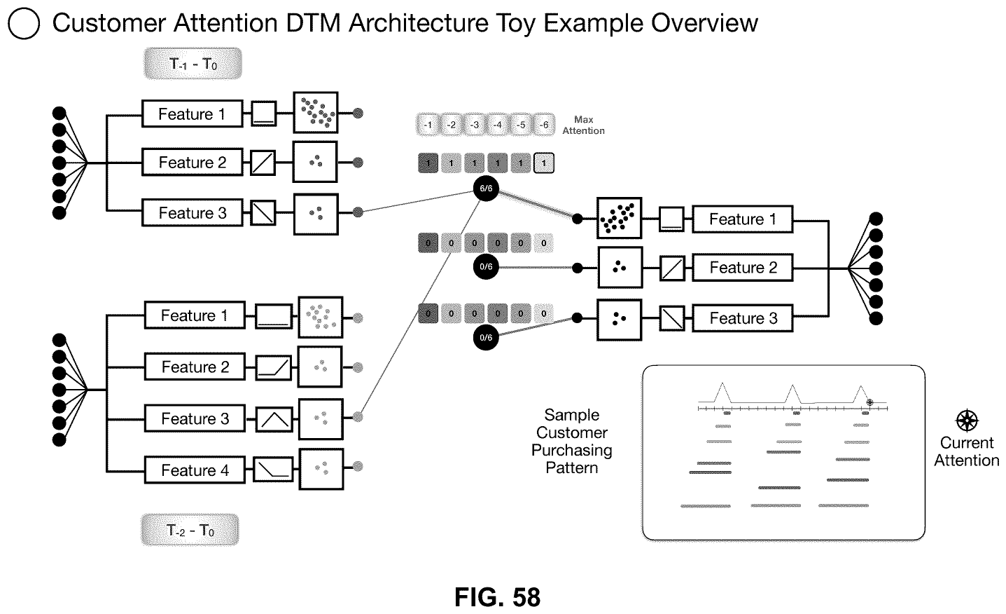

FIG. 58 depicts the same THD groups 5102, 5104, and 5106 in an example that illustrates attention in a step forward in time relative to the future time in FIG. 57 (and five steps forward relative to FIG. 53). In this example, the attention is point is at the start of a flat line.

As discussed herein, the “flat” features of THD groups 5102 and 5104 indicate a “one” where there is an edge and a “zero” where there is no edge. There is full attention across all features that are associated with a flat line. Attention across features connected to the rising line and declining lines (e.g., features 2 and 3 of the future THD) have no attention. There is six out of six attention for the first future feature. As such, based on weighting, comparison, or other mathematical/statistical techniques, the future forecast is a flat line.

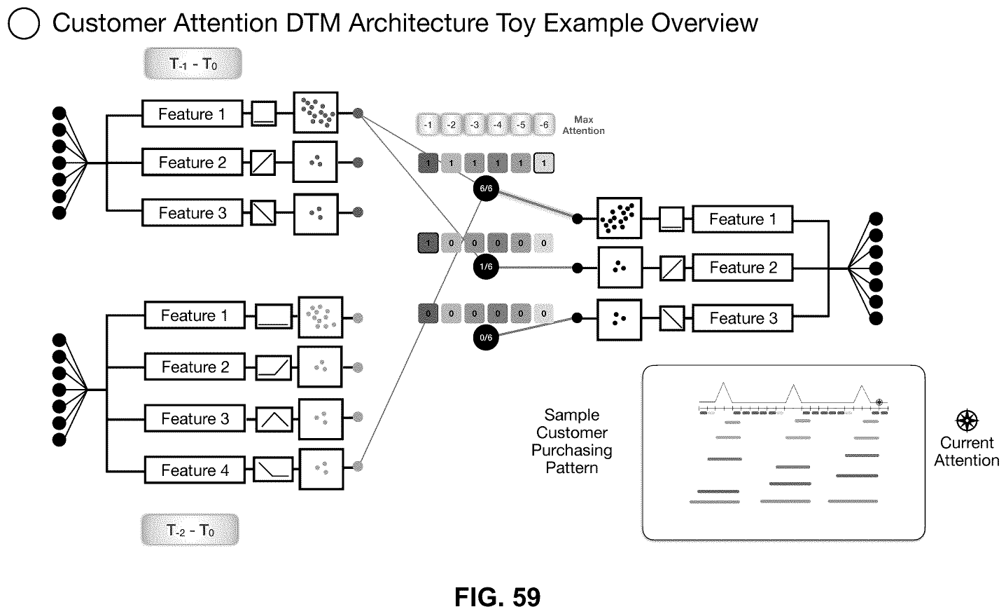

FIG. 59 depicts the same THD groups 5102, 5104, and 5106 in an example that illustrates attention in a step forward in time relative to the future time in FIG. 58 (and six steps forward relative to FIG. 53). In this example, the attention is point is at the continuation of the flat line.

As discussed herein, the “flat” features of THD groups 5102 and 5104 indicate a “one” where there is an edge and a “zero” where there is no edge. There is full attention across all features that are associated with a flat line. Attention across features connected to the rising line is one out of six and there is no attention to the declining line. There is six out of six attention for the first future feature. As such, based on weighting, comparison, or other mathematical/statistical techniques, the future forecast is a flat line.

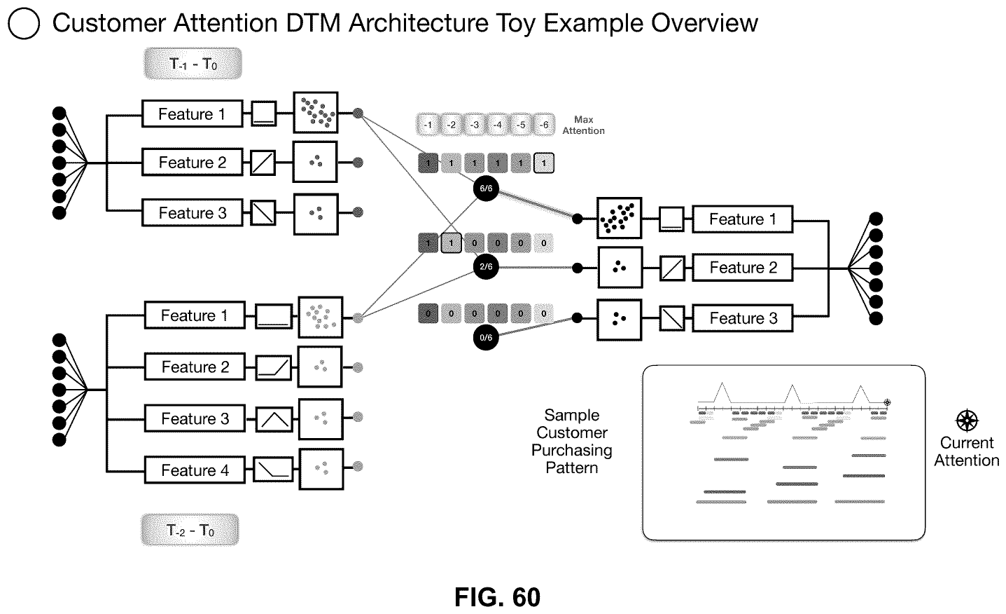

FIG. 60 depicts the same THD groups 5102, 5104, and 5106 in an example that illustrates attention in a step forward in time relative to the future time in FIG. 59 (and seven steps forward relative to FIG. 53). In this example, the attention is point is at the continuation of the flat line.

As discussed herein, the “flat” features of THD groups 5102 and 5104 indicate a “one” where there is an edge and a “zero” where there is no edge. There is full attention across all features that are associated with a flat line. Attention across features connected to the rising line is two out of six and there is no attention to the declining line. There is six out of six attention for the first future feature. As such, based on weighting, comparison, or other mathematical/statistical techniques, the future forecast is a flat line.

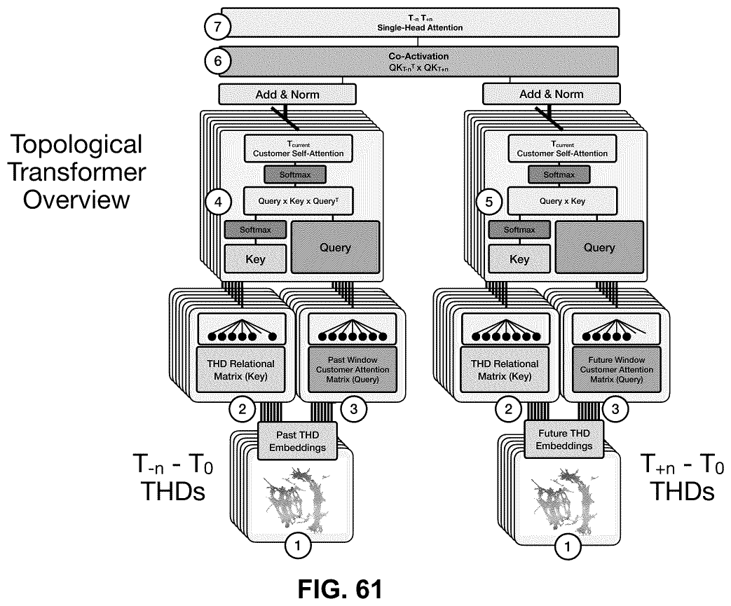

FIG. 61 is a flow chart for topological transformation used for forecasting in some embodiments. In various embodiments, temporal data is received from any number of sources (e.g., internal and/or external sources). As used herein, the term “temporal data” refers to any data that includes a time and/or date component. Temporal data may, for example, encompass information associated with specific moments, periods, or sequences in time. Temporal data may include, but is not limited to, time series data, event logs, timestamps, historical records, sales data, manufacturing data, design data, economic data, or any other data points that have a chronological aspect or ordering. The time component in temporal data can be represented in various formats, such as discrete time points, intervals, or continuous time scales, depending on the nature of the data and its intended use in analysis or modeling.

After the time data is received, an initial point, T₀ of time is selected. T₀ may be received from a user or from storage. As discussed herein, T₀ is not necessarily the current point in time when the analysis is conducted. T₀ may be any point in time from the present to the past. Forecasts will be made at some time after T₀. Historical data is any data before T₀.

In various embodiments, time units may be identified by a user or determined by the explainable machine learning system 204. A time unit is the unit of time that will be used to create historical time windows a future time windows. A time unit may be, for example, seconds, minutes, hours, days, weeks, months, years, or any repeatable time unit. In one example, temporal data may include sales data, T₀ may be set for today, and time units may be defined as monthly (e.g., one set of T−1 to T₀ would be one month ago until today and one set of T₀ and T−2 to T₀ would be two months ago until today).

The temporal decomposition module 4802 may, in some embodiments, generate historical time windows and future time windows based on the received temporal data. For example, the temporal decomposition module 4802 may generate a set of historical time windows for different window sizes.

For example, the temporal decomposition module 4802 may generate two sequences of historical time windows:
Sequence One: a set of historical time windows of length u (u being a time unit) starting at T₀−(n)(u), where n is a positive integer starting at 0.
Sequence Two: a set of historical time windows of length 2u, starting at T₀−(n)(u).

It will be appreciated that there may be any number of sequences corresponding to the different length time windows (e.g., 3u, 4u, 5u, and the like).

Returning to FIG. 50, the figure depicts an example of historical time windows that may be generated by the temporal decomposition module 4802. In FIG. 50, there are six sequences, including, where u is a time unit and n is a positive integer starting at 0:
Sequence One: a set of historical time windows of length u, starting at T₀−(n)(u).
Sequence Two: a set of historical time windows of length 2u, starting at T₀−(n)(u).
Sequence Three: a set of historical time windows of length 3u, starting at T₀−(n)(u).
Sequence Four: a set of historical time windows of length 4u, starting at T₀−(n)(u).
Sequence Five: a set of historical time windows of length 5u, starting at T₀−(n)(u).
Sequence Six: a set of historical time windows of length 6u, starting at T₀−(n)(u).

In various embodiments, the temporal decomposition module 4802 may similarly generate future time windows. In various embodiments, the temporal decomposition module 4802 generates any number of sets of future time windows (e.g., T+n−T₀) where n is a discrete number of time units. There may be any number of sets of future time windows. For example, the temporal decomposition module 4802 may generate:
Sequence One: a set of future time windows of length u, starting at T+ (n)(u)+T₀.
Sequence Two: a set of future time windows of length 2u, starting at T+ (n)(u)+T₀.

In step 1 of FIG. 61, the explainable machine learning system 204 may generate a THD for each set of historical time windows and each set of future time windows. For example, the explainable machine learning system 204 may apply the method discussed regarding FIGS. 4A and 4B using the first sequence of historical time windows of length u, and again apply the method discussed regarding FIGS. 4A and 4B using the second sequence of historical time windows of length 2U to create a first and second THD for the two sets of historical time windows.

For example, the explainable machine learning system 204 may create past topological hierarchical decompositions for the first set of historical time subsets by projecting the information to a first embedding based on at least one metric, determining a first lowest cover resolution of the first embedding that identifies non-overlapping secondary coverings based on sets within one of the covers of the first embedding, identifying a branch point of a first connected-component network based on the non-overlapping secondary coverings, generating subsets from the branch point based on the non-overlapping secondary coverings, if a network generation threshold has not been met, then for each subset from the branch point, determining a second lowest cover resolution that identifies non-overlapping secondary coverings based on the sets within one of the covers of a particular subset to identify a new branch point and new subsets from that branch point of the first connected-component network, for each leaf of the connected-component network, identify embeddings of a feature space and generate a local object embedding space using a transposition of segmented features with related objects, adding coordinates of objects within each leaf of the local object embedding to a data array, projecting array data from the data array to a second embedding, determining a third lowest cover resolution of the second embedding that identifies non-overlapping secondary coverings based on sets within one of the covers of the second embedding, identifying a branch point of a second connected-component network based on the non-overlapping secondary coverings, generating subsets from the branch point based on the non-overlapping secondary coverings, if a network generation threshold has not been met, then for each subset from the branch point, determining a second lowest cover resolution that identifies non-overlapping secondary coverings based on the sets within one of the covers of a particular subset to identify a new branch point and new subsets from that branch point of the second connected-component network, and generating at least one past topological hierarchical decomposition.

In step 1 of FIG. 61, the explainable machine learning system 204 may generate a THD for each set of future time windows using information after the initial time in a similar manner. For example, the explainable machine learning system 204 may apply the method discussed regarding FIGS. 4A and 4B using the first sequence of future time windows of length u, and again apply the method discussed regarding FIGS. 4A and 4B using the second sequence of future time windows of length 2U to create a first and second THD for the two sets of future time windows.

Each THD embedding creates a hierarchy. In some embodiments, the objects space where the features are the features identified by a particular THD on the feature space I used to create a THD relationship matrixes and past window customer matrixes.

In step 2 of FIG. 61, a THD relational matrix (referred to herein as a “key”) is created for each THD. It will be appreciated that THDs have hierarchy and there may be a termination in different leaf nodes or termination in different parts of the THD and proximity within the hierarchy has a relationship. That information may be preserved by constructing a key.

In step 3 of FIG. 61, for every customer to forecast (the THD may have a single or two or more customers in this example), one or more past window customer attention matrixes are created (referred to herein as a “query”).

In step 4, the key(s) and query(s) are merged in a manner that is similar to a transformer by utilizing matrix multiplication (e.g., query×key×query). Using this approach, the system may optionally indicate where terminate in the THD and their relationship to each other. The end result is to create a customer attention understanding.

Across all windows, they may be added and normalized to create a decoder.

The encoder is the same approach looking at the future. Similar to past embeddings, future embeddings get converted into a THD. Those future THDs may be interpreted two ways: One is the relationship of the different nodes to each other (e.g., key matrix). The other is the attention (e.g., query matrix). These matrices are merged together in step 5, future windows are added and normalized and a customer attention future understanding is created.

In step 5, the customer attention future understandings are added and normalized.

In step 6, the customer attention past and future understandings are merged (e.g., QKT−NT×QK T+n)

In step 7, the forecast is created (e.g., T−n T+n single head attention).

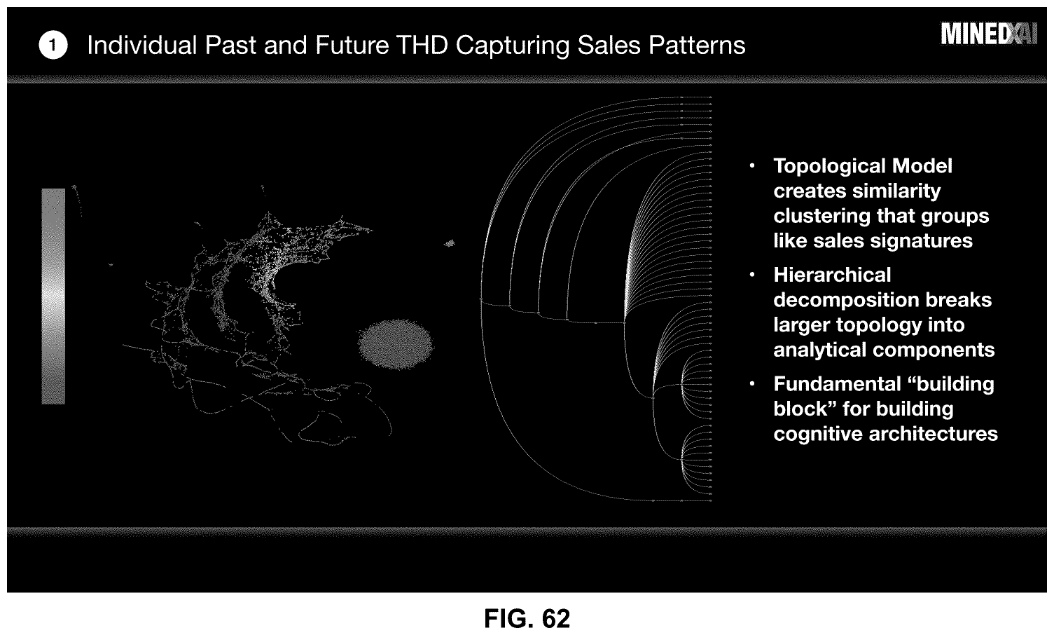

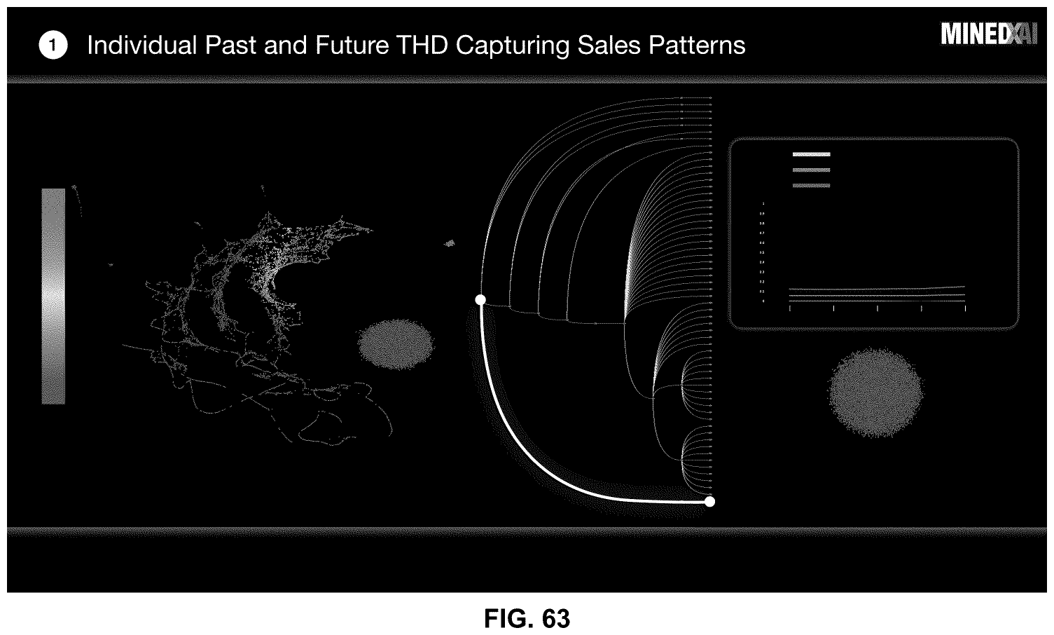

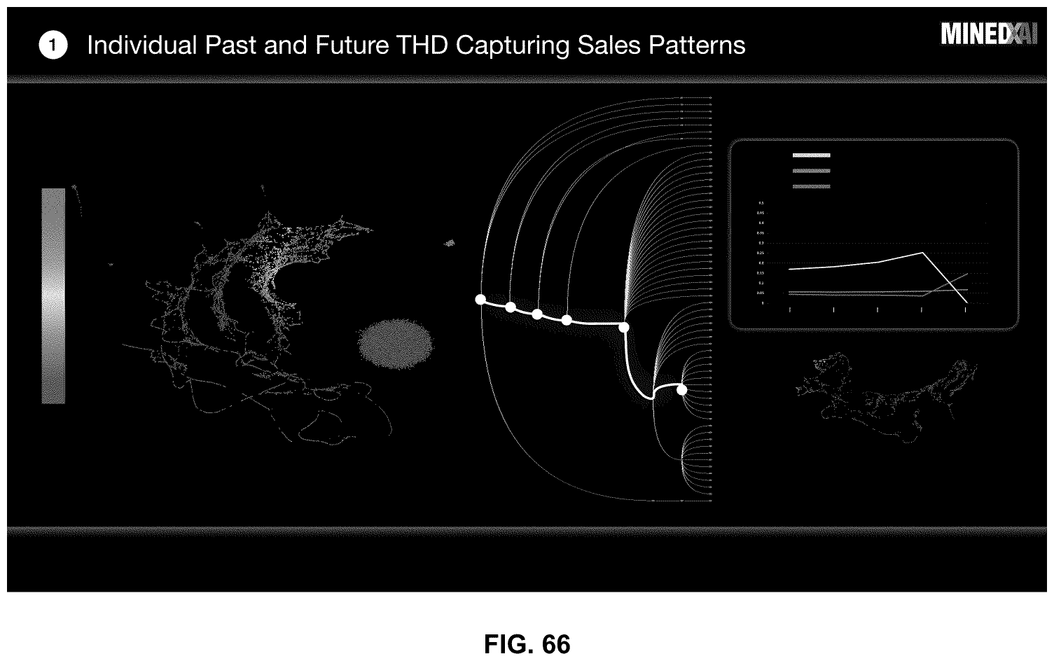

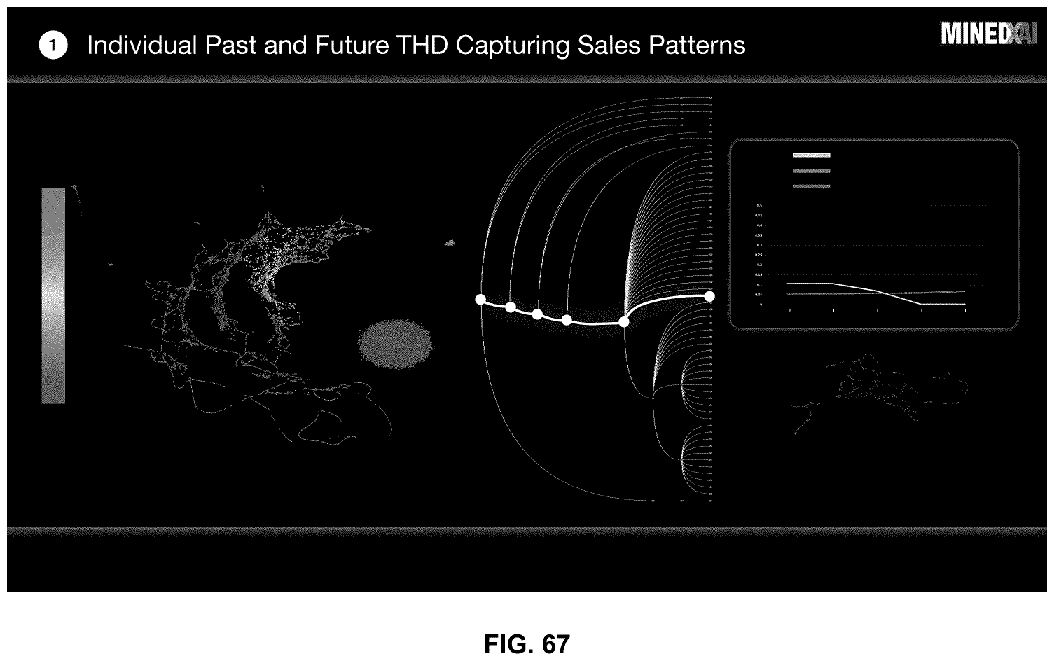

FIG. 62 depicts an example of individual historical and future THDs capturing sales patterns in some embodiments. In this example, the topological model creates similarity clustering that groups like sales signatures. Hierarchical decomposition may break larger topology into analytical components (as discussed herein). In examples of FIG. 62-67, patterns are being captured.

FIG. 63 depicts individual past and future THDs that capture sales patterns in one example. In this example, the brighter line is a significant signal indicating that customers are not buying anything.

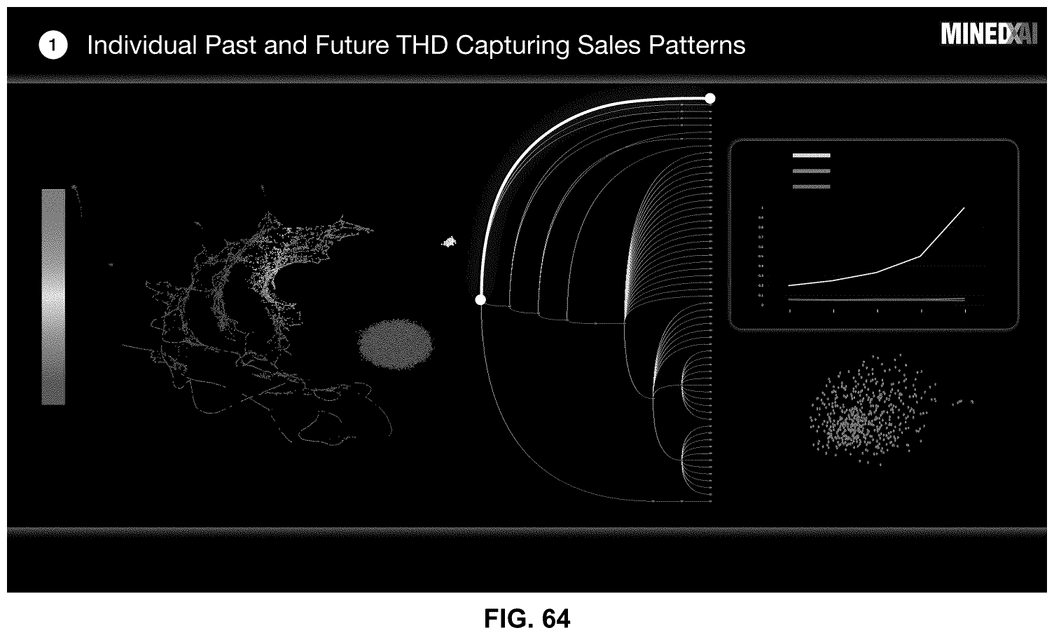

FIG. 64 depicts individual past and future THDs with a different signal in this example. For this branch, there is an indication of people who did not buy four weeks ago but are buying more as T₀ approaches.

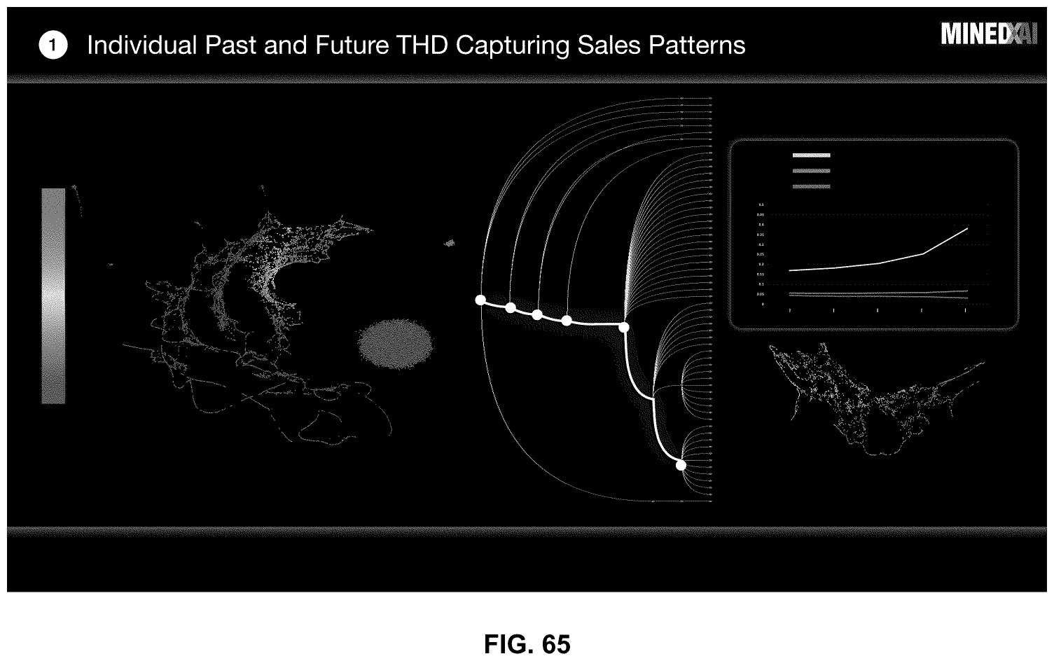

FIGS. 65 through 67 depicts different branches and different averages of purchasing as time approaches T₀ in some embodiments.

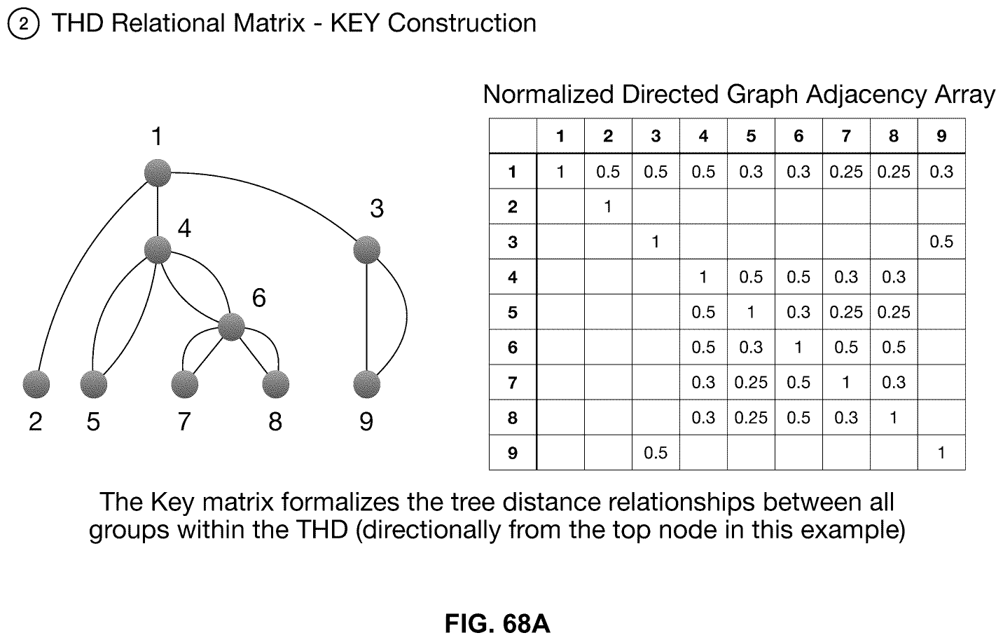

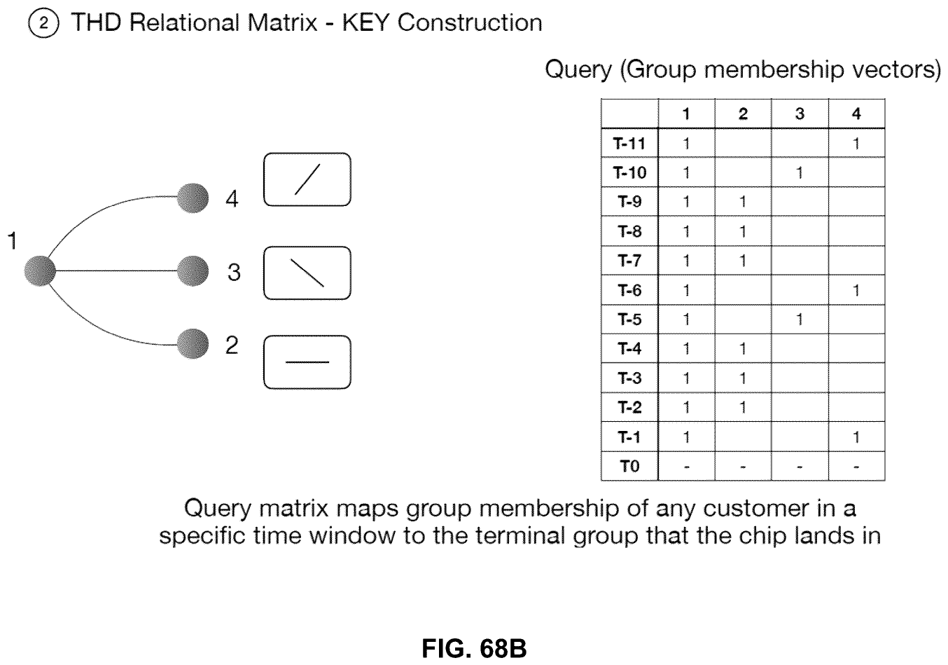

FIG. 68A depicts a THD relationship matrix (e.g., a “key”) construction in one example. The key matrix may formalize the tree distance relationships between all groups within the THD. In this example, directionality is from the top node. The directed graph adjacency array (e.g., the key matrix) in this example depicts directed paths between nodes in the network depicted in FIG. 68A.

In some embodiments, the directed graph adjacency array provides a way to weight the THD itself so forecasts can be understood. In various embodiments, the relational matrix module 4806 generates the directed graph adjacency array shows the relationship between each node. In some embodiments, there is a restriction the paths cannot go up to the top node and back down to something else. In other embodiments, there are no such restrictions.

In this example, for each node, the relational matrix module 4806 determines the number of paths to each other nodes within the restriction. The relational matrix module 4806 may include, in some embodiments, a value indicating that a node connects to itself as well as other nodes. For example, the directed graph adjacency array of FIG. 68A shows, for example, node 9 is from node 9 to 9 and 9 to 3, so 9 to 3 has a value of 2.

FIG. 68A depicts the key construction optionally normalized. In this example, the relational matrix module 4806 includes a string of ones across the diagonal because the relational matrix module 4806 counts itself as a node, so the identify matrix remains 1 (e.g., from node 1 to node 1, node 2 to node 2, and so forth). This key matrix characterizes an edge differently with respect to some kind of function (e.g., a distance is defined on a graph and the distance weights the graph).

Step 2 is performed to generate a THD relational matrix for the past THDs and the future THDs (i.e., the future being chronologically after the initial time T₀ and not necessarily the future before any data is known).

FIG. 68B depicts another example of the THD relational matrix construction for the toy example. In this example, the query matrix maps group membership of any customer in a specific time window to the terminal group that the window is in.

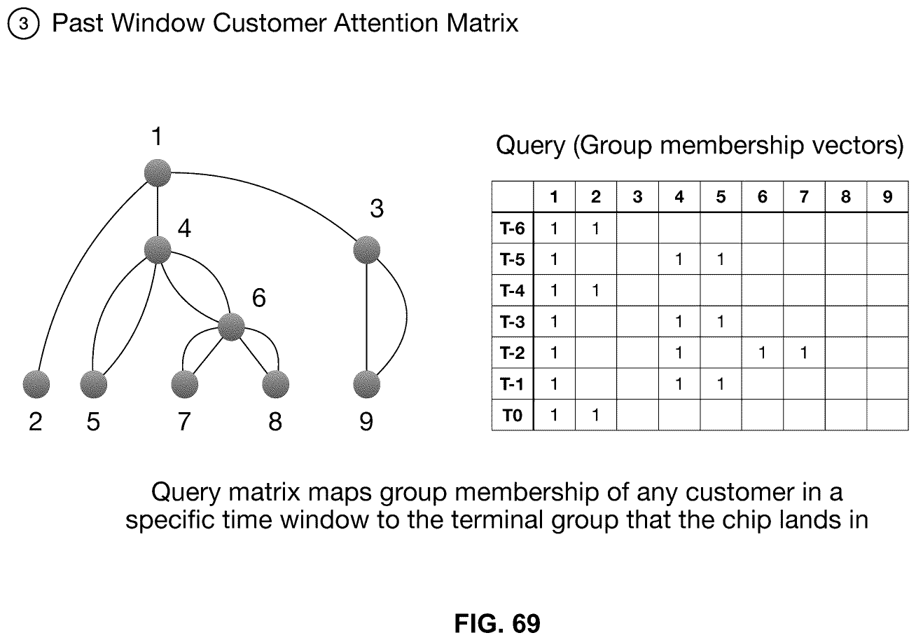

FIG. 69 depicts a past window customer attention matrix in some embodiments. The query matrix maps group membership of any customer in a specific time window to the terminal group that the time window lands in. In various embodiments, the query matrix is an index.

The attention matrix module 4808 generates the past attention matrix (query matrix) from the same THDs used to generate the past key matrix. In this example, a particular customer is examined and a group membership is assigned to that customer over the historical time windows (e.g., through the rows from T₀ to T−6). All time points start in node 1, so they get all “ones” in the query matrix. This captures an activation for the customer in the overall sets of historical windows.

It will be appreciated that the query matrix indicates where the data is in the THD and the nodes traverses. T−4 and T−6 may be most similar to T−0 based on the query depicted in FIG. 69.

Similarly, the attention matrix module 4808 generates the future attention matrix (query matrix) from the same THDs used to generate the future key matrix. In this example, a particular customer is examined and a group membership is assigned to that customer over the historical time windows (e.g., through the rows from T₀ to T+6). All time points start in node 1, so they get all “ones” in the query matrix. This captures an activation for the customer in the overall sets of future windows.

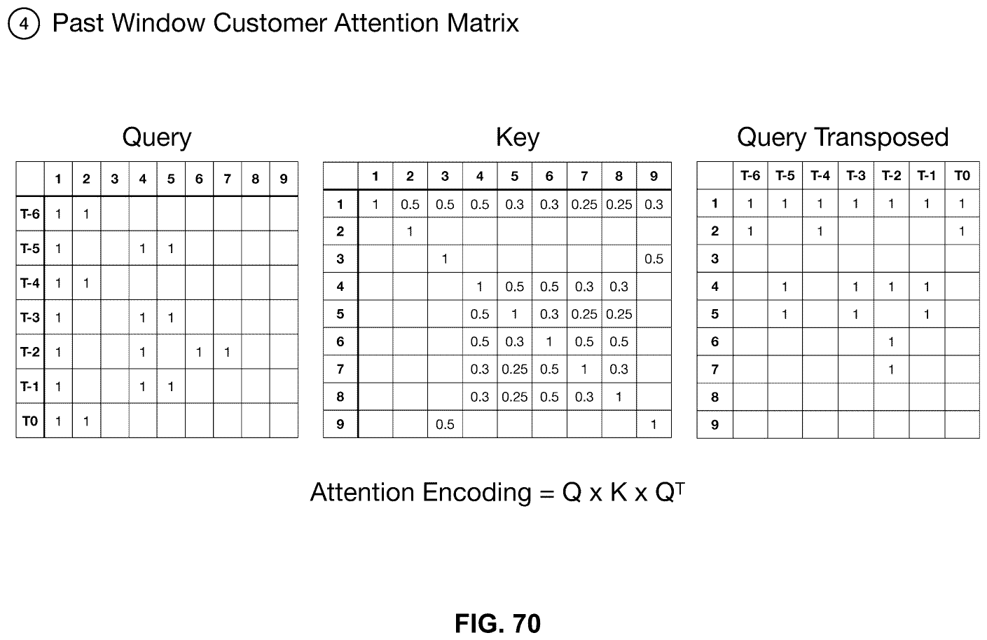

FIG. 70 is an attention encoding in some embodiments. In this example, the temporal analysis module 4804 generates attention encoding matrix in some embodiments. The attention encoding matrix in this example is step 4 in FIG. 60.

In some embodiments, the temporal analysis module 4804 generates the past attention encoding matrix by applying matrix multiplication of the past query matrix to the past key matrix and again to the transpose of the past query matrix.

As depicted in FIG. 70, the past attention encoding matrix Qₚ×Kₚ×Qₚ^{t}, where Qₚ is the past query matrix, Kₚ is the past key matrix, and Qₚt is the transpose of the past query matrix. In some embodiments, the past key matrix Kₚ is the THD relationship matrix after the application of softmax. Similarly, in some embodiments, a softmax is applied to the past encoding matrix.

Similarly, in some embodiments, in step 5 as depicted in FIG. 6, the temporal analysis module 4804 generates the future attention encoding matrix by applying matrix multiplication of the future query matrix to the future key matrix and again to the transpose of the future query matrix.

As depicted in FIG. 70, the future attention encoding matrix Q_{f}×K_{f}×Q_{f}^{t}, where Q_{f} is the future query matrix, K_{f} is the future key matrix, and Q_{f} is the transpose of the future query matrix. In some embodiments, the future key matrix K_{f} is the THD relationship matrix after the application of softmax. Similarly, in some embodiments, a softmax is applied to the future encoding matrix.

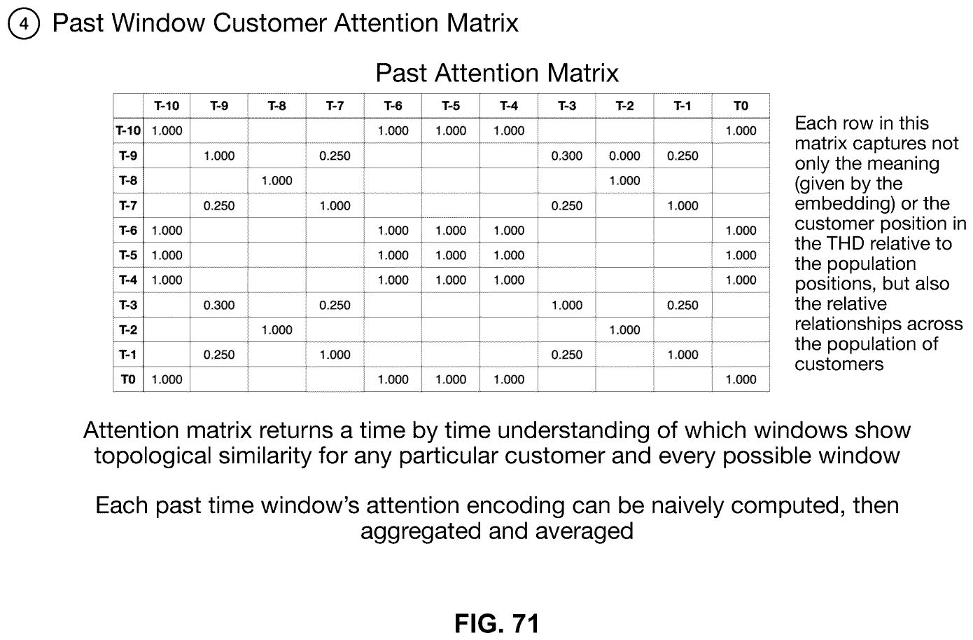

FIG. 71 depicts an example of a past attention matrix in some embodiments. The past attention matrix may, in this example, return a time by time understanding of which windows show topological similarity for a particular customer and possible windows (e.g., every possible window although this is not required). In some embodiments, each past time window's attention encoding can be naively computed, then aggregated and averaged.

In various embodiments, each row in the past attention matrix captures not only the meaning (e.g., given by the embedding provided by the past THDs) or the customer position in the THD relative to the population positions, but also the relative relationships across the population of customers.

It will be appreciated that the future attention matrix may be very similar in terms of the information being provided after the initial time T0 (i.e., the future attention matrix will differ from the past attention matrix in terms of actual values).

Like the past attention matrix may, the future attention matrix may return a time by time understanding of which windows show topological similarity for a particular customer and possible windows (e.g., every possible window although this is not required). In some embodiments, each past time window's attention encoding can be naively computed, then aggregated and averaged.

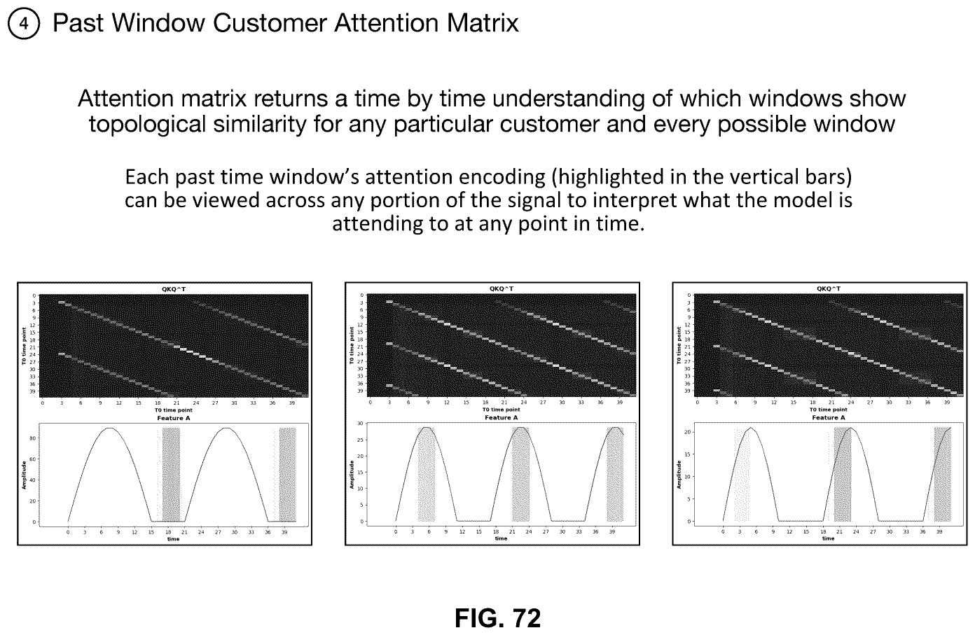

FIG. 72 depicts a past window customer attention matrix in another example. In this example, the attention matrix returns a time by time understanding of which windows show topological similarity for any particular customer and every possible window. Each past time window's attention encoding (highlighted in the vertical bars of FIG. 72) can be viewed across any portion of the signal to interpret what the model is attending to at any point in time.

In various embodiments, each row in the future attention matrix captures not only the meaning (e.g., given by the embedding provided by the future THDs) or the customer position in the THD relative to the population positions, but also the relative relationships across the population of customers.

In some embodiments, heat maps may be generated to demonstrate explainability of where the attention is focused (e.g., in the bar graphs).

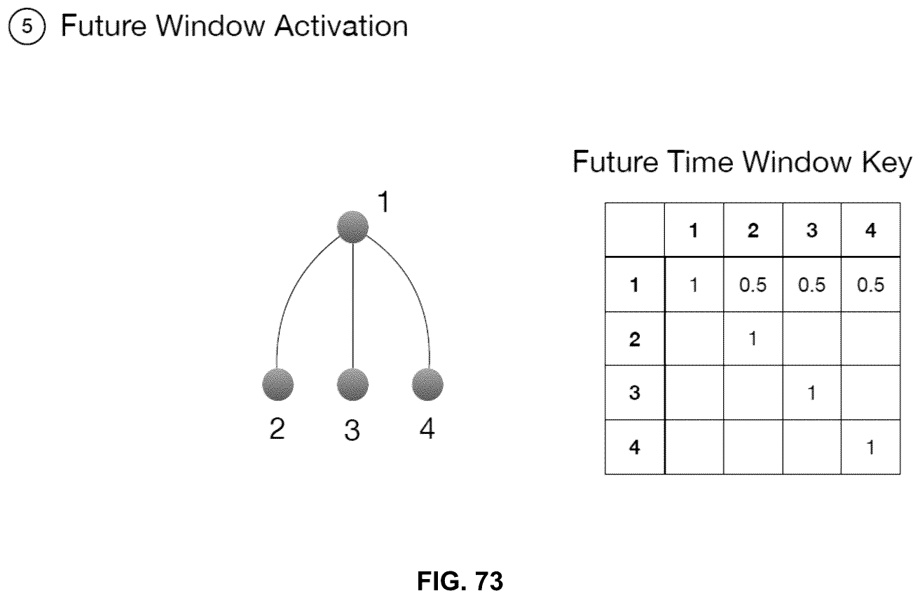

FIG. 73 depicts a future window activation in step 5 of FIG. 61 in one example. In this toy example, the future time window key is depicted for the simple network depicted.

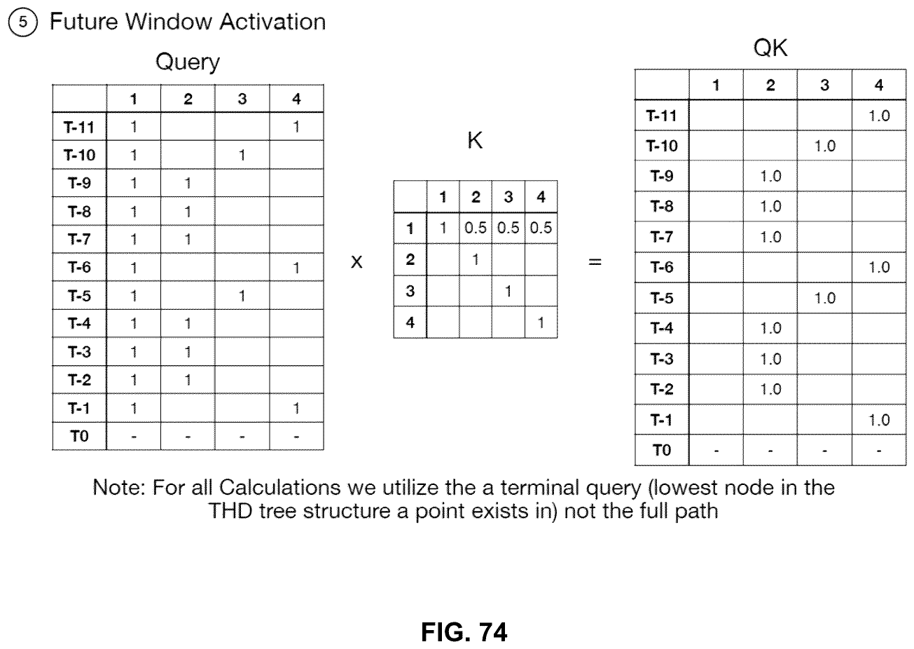

FIG. 74 depicts a future window activation utilizing the future attention encoding matrix Q_{f}×K_{f}, where Q_{f} is the query, Kris from FIG. 73. Using matrix multiplication, the end result is QK. It will be appreciated that, in some embodiments, for all calculations a terminal query (e.g., lowest node in the THD tree structure the point exists in) was utilized and not the full path.

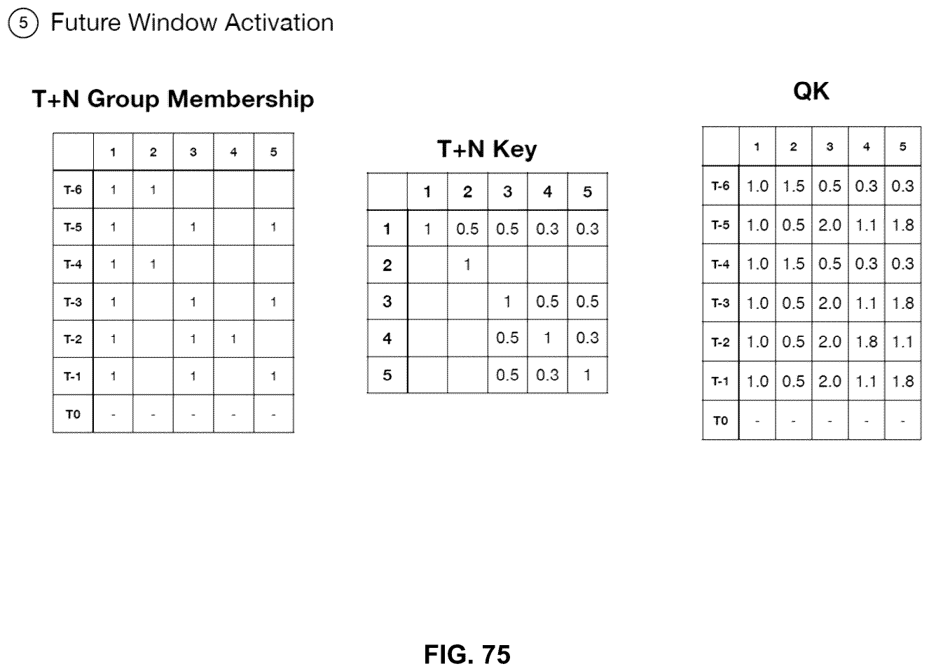

FIG. 75 depicts another future window activation utilizing the matrix Q_{f}×K_{f}, where Q_{f} is the query T+N group membership, and K_{f} is T+N key. Using matrix multiplication, the end result is QK.

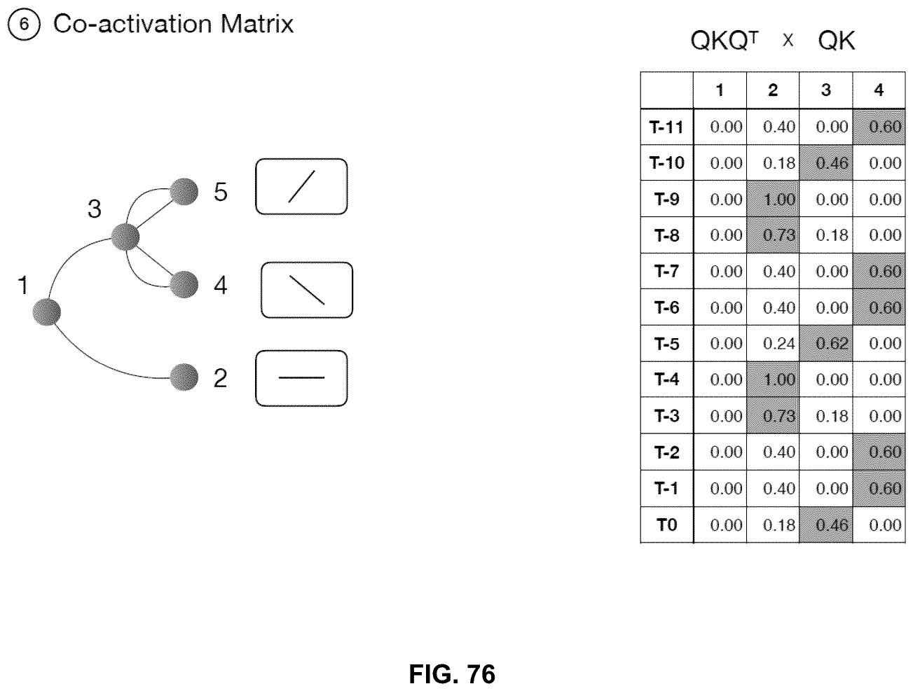

FIG. 76 is an example of a co-activation matrix for the toy example in some embodiments. Here, QKQT×QK results in the coactivation matrix. In other words, the QKQT is the transpose of the past window activation and QK is the future window activation from steps 4 and 5 of the FIG. 61.

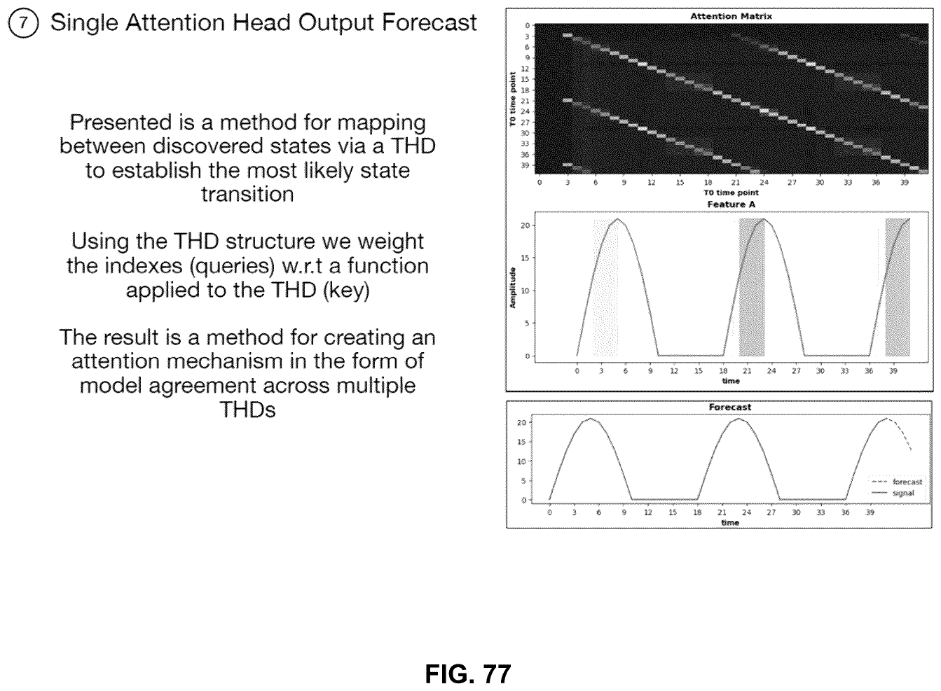

FIG. 77 depicts a single attention head output forecast which may be applied to forecast results after the initial time. The single attention head output forecast, in this example is presented as a method for mapping between discovered states using a THD to establish the most likely state transition. Using the THD structure, the indexes (e.g., queries) are weighted with regard to a function applied to the THD key. The result is a method for creating an attention mechanism in the form of model agreement across multiple THDs.

In various embodiments, the forecasting may be used in many different contexts and situations. For example, the forecasting may capture demand signal at the lowest level available (product×seller×customer) across virtually any time-scale. The forecasting may easily interrogate divergences from forecasts for missed or gained sales opportunities. Further, in some embodiments, forecasts can be delivered across each component of the sales chain providing real-time insights, such as propensity information, and targeting specific product/customer subsets.

In some embodiments, as in many examples discussed herein, forecasting may be applied to supply chain management and demand planning. As such, stockouts, overstock, and low accuracy may be avoided. Systems and methods described herein may be applied to SKU-level forecasting, supplier conversations, scenario planning, and inventory optimization.

The relational matrix module 4806 generates the key matrix based on the embeddings of the past THDs generated in step 1 depicted in FIG. 60.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program or data for use by or in connection with an instruction execution system, apparatus, or device.

A transitory computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further, any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled”, “couplable”, “operably coupled”, “communicably coupled” and the like to other components. Such description or illustration should be understood as indicating that such components may cooperate or interact with each other, and may be in direct or indirect physical, electrical, or communicative contact with each other.

Components may be described or illustrated as “configured to”, “adapted to”, “operative to”, “configurable to”, “adaptable to”, “operable to” and the like. Such description or illustration should be understood to encompass components both in an active state and in an inactive or standby state unless required otherwise by context.

It may be apparent that various modifications may be made, and other embodiments may be used without departing from the broader scope of the discussion herein. Therefore, these and other variations upon the example embodiments are intended to be covered by the disclosure herein.

1. A non-transitory computer-readable medium comprising executable instructions, the executable instructions being executable by one or more processors to perform a method, the method comprising:
receiving information with temporal data, initial time, and a time unit, the temporal data including any information with time data over a duration;
generating historical time windows including a first set of historical time subsets each of a first length, and a second set of historical time subsets each of a second length, the second length being longer than the first length, the information contained in both the first set of historical time subsets being duplicated in the second set of historical time subsets, the first set of historical time subsets including a consecutive number of non-overlapping historical time subsets ending in the initial time, each of the first set of historical time subsets being of the first length equal to the time unit, the second set of historical time subsets including overlapping historical time subsets ending in the initial time, the first subset of the second set of historical time subsets ending at the initial time and the second subset of the second set of historical time subsets ending at the duration of a time unit before the initial time, the information contained in the first subset and the second subset of the second set of historical time subsets including at least one unit of duplicate information, the historical time windows including information being chronologically before the initial time;
generating future time windows including a first set of future time subsets each of the first length, the first set of future time subsets including a consecutive number of non-overlapping future time subsets beginning at the initial time, each of the first set of future time subsets being of the first length equal to the time unit, the first set of future time subsets including information being chronologically after the initial time;
creating past topological hierarchical decompositions for the first set of historical time subsets and the second set of historical time subsets;
creating future topological hierarchical decompositions for the first set of future time subsets;
creating a past directed graph adjacency array using weights derived from a distance as applied to embeddings from the past topological hierarchical decompositions, and creating a future directed graph adjacency array using weights derived from the distance as applied to embeddings from the future topological hierarchical decompositions;
generating a past window customer attention matrix identifying entity membership of groups across historical time subsets using the embeddings from the past topological hierarchical decompositions, and generating a future window customer attention matrix identifying the entity membership of groups across future time subsets using the embeddings from the future topological hierarchical decompositions;
performing matrix multiplication to multiply the past window customer attention matrix to the past directed graph adjacency array and a transpose of the past window customer attention matrix to create a past customer self-attention array;
performing the matrix multiplication to multiply the future window customer attention matrix to the future directed graph adjacency array and a transpose of the future window customer attention matrix to create a future customer self-attention array;
performing matrix multiplication of the past customer self-attention array to the future customer self-attention array; and
providing a dashboard forecasting demand after the initial time.

2. The non-transitory computer-readable medium of claim 1, wherein the information with temporal data includes a plurality of customers over time as well as customer purchasing of a plurality of products, the dashboard forecasting demand including a forecast of demand based on purchasing decisions over time before and after the initial time.

3. The non-transitory computer-readable medium of claim 2, further comprising generating and providing an alert to a user when inventory is above a particular threshold or below a particular threshold based on forecasting to enable the user to purchase or not purchase one or more products based on forecasted demand such that inventory levels are not critically low or extremely high relative to demand.

4. The non-transitory computer-readable medium of claim 2, further comprising:
receiving incentive offers from a manufacturer of at least one product, the incentive offering a bonus for sales of the at least one product;
generating and providing an alert to a user when forecasted demand for the at least one product is at or above an incentive threshold to enable the user to make changes to further increase sales of the at least one product.

5. The non-transitory computer-readable medium of claim 2, further comprising:
receiving a plurality of incentive offers from a plurality of manufacturer for volume sales of a plurality of products, each of the incentives of the plurality of incentive offers offering a bonus for sales of at least one product of the plurality of products, at least a subset of the plurality of incentive offers including different expiration dates after which a particular incentive is no longer available;
for each of the plurality of incentive offers, identifying forecasted demand for an applicable product of the plurality of products;
comparing forecasted demand for different products; and
generating and providing an alert to a user when forecasted demand for at least one of the plurality of products is higher than other products of the plurality of products before a particular expiration date expires.

6. The non-transitory computer-readable medium of claim 2, further comprising:
receiving a plurality of incentive offers from a plurality of manufacturer for volume sales of a plurality of products, each of the incentives of the plurality of incentive offers offering a bonus for sales of at least one product of the plurality of products, at least a subset of the plurality of incentive offers including different expiration dates after which a particular incentive is no longer available;
for each of the plurality of incentive offers, identifying forecasted demand for an applicable product of the plurality of products;
comparing forecasted demand for different products;
comparing overall incentive for a particular number of different products with high forecasted demand relative to forecasted demand of the different products; and
generating and providing an alert to a user when forecasted demand for at least one of the plurality of products is higher than other products of the plurality of products before a particular expiration date expires and when the overall incentive if above an incentive threshold.

7. The non-transitory computer-readable medium of claim 1, wherein creating past topological hierarchical decompositions for the first set of historical time subsets comprising:
projecting the information to a first embedding based on at least one metric;
determining a first lowest cover resolution of the first embedding that identifies non-overlapping secondary coverings based on sets within one of the covers of the first embedding;
identifying a branch point of a first connected-component network based on the non-overlapping secondary coverings;
generating subsets from the branch point based on the non-overlapping secondary coverings;
if a network generation threshold has not been met, then for each subset from the branch point, determining a second lowest cover resolution that identifies non-overlapping secondary coverings based on the sets within one of the covers of a particular subset to identify a new branch point and new subsets from that branch point of the first connected-component network;
for each leaf of the connected-component network, identify embeddings of a feature space and generate a local object embedding space using a transposition of segmented features with related objects;
adding coordinates of objects within each leaf of the local object embedding to a data array;
projecting array data from the data array to a second embedding;
determining a third lowest cover resolution of the second embedding that identifies non-overlapping secondary coverings based on sets within one of the covers of the second embedding;
identifying a branch point of a second connected-component network based on the non-overlapping secondary coverings;
generating subsets from the branch point based on the non-overlapping secondary coverings;
if a network generation threshold has not been met, then for each subset from the branch point, determining a second lowest cover resolution that identifies non-overlapping secondary coverings based on the sets within one of the covers of a particular subset to identify a new branch point and new subsets from that branch point of the second connected-component network; and
generating at least one past topological hierarchical decomposition.

8. The non-transitory computer-readable medium of claim 1, further comprising generating secondary coverings by determining, for each set that has data within the cover, a centroid and determining a radius based on the centroid that covers at least that particular set.

9. The non-transitory computer-readable medium of claim 8, wherein the centroid for a particular set is determined based on the data within that particular set.

10. A system comprising at least one processor and memory containing instructions, the instructions being executable by the at least one processor to:
receive information with temporal data, initial time, and a time unit, the temporal data including any information with time data over a duration;
generate historical time windows including a first set of historical time subsets each of a first length, and a second set of historical time subsets each of a second length, the second length being longer than the first length, the information contained in both the first set of historical time subsets being duplicated in the second set of historical time subsets, the first set of historical time subsets including a consecutive number of non-overlapping historical time subsets ending in the initial time, each of the first set of historical time subsets being of the first length equal to the time unit, the second set of historical time subsets including overlapping historical time subsets ending in the initial time, the first subset of the second set of historical time subsets ending at the initial time and the second subset of the second set of historical time subsets ending at the duration of a time unit before the initial time, the information contained in the first subset and the second subset of the second set of historical time subsets including at least one unit of duplicate information, the historical time windows including information being chronologically before the initial time;
generate future time windows including a first set of future time subsets each of the first length, the first set of future time subsets including a consecutive number of non-overlapping future time subsets beginning at the initial time, each of the first set of future time subsets being of the first length equal to the time unit, the first set of future time subsets including information being chronologically after the initial time;
create past topological hierarchical decompositions for the first set of historical time subsets and the second set of historical time subsets;
create future topological hierarchical decompositions for the first set of future time subsets;
create a past directed graph adjacency array using weights derived from a distance as applied to embeddings from the past topological hierarchical decompositions, and creating a future directed graph adjacency array using weights derived from the distance as applied to embeddings from the future topological hierarchical decompositions;
generate a past window customer attention matrix identifying entity membership of groups across historical time subsets using the embeddings from the past topological hierarchical decompositions, and generating a future window customer attention matrix identifying the entity membership of groups across future time subsets using the embeddings from the future topological hierarchical decompositions;
perform matrix multiplication to multiply the past window customer attention matrix to the past directed graph adjacency array and a transpose of the past window customer attention matrix to create a past customer self-attention array;
perform the matrix multiplication to multiply the future window customer attention matrix to the future directed graph adjacency array and a transpose of the future window customer attention matrix to create a future customer self-attention array;
perform matrix multiplication of the past customer self-attention array to the future customer self-attention array; and
provide a dashboard forecasting demand after the initial time.

11. The system of claim 10, wherein the information with temporal data includes a plurality of customers over time as well as customer purchasing of a plurality of products, the dashboard forecasting demand including a forecast of demand based on purchasing decisions over time before and after the initial time.

12. The system of claim 11, the instructions being further executable by the at least one processor to generate and provide an alert to a user when inventory is above a particular threshold or below a particular threshold based on forecasting to enable the user to purchase or not purchase one or more products based on forecasted demand such that inventory levels are not critically low or extremely high relative to demand.

13. The system of claim 11, the instructions being further executable by the at least one processor to:
receive incentive offers from a manufacturer of at least one product, the incentive offering a bonus for sales of the at least one product; and
generate and provide an alert to a user when forecasted demand for the at least one product is at or above an incentive threshold to enable the user to make changes to further increase sales of the at least one product.

14. The system of claim 11, the instructions being further executable by the at least one processor to:
receive a plurality of incentive offers from a plurality of manufacturer for volume sales of a plurality of products, each of the incentives of the plurality of incentive offers offering a bonus for sales of at least one product of the plurality of products, at least a subset of the plurality of incentive offers including different expiration dates after which a particular incentive is no longer available;
for each of the plurality of incentive offers, identify forecasted demand for an applicable product of the plurality of products;
compare forecasted demand for different products; and
generate and provide an alert to a user when forecasted demand for at least one of the plurality of products is higher than other products of the plurality of products before a particular expiration date expires.

15. The system of claim 11, the instructions being further executable by the at least one processor to:
receive a plurality of incentive offers from a plurality of manufacturer for volume sales of a plurality of products, each of the incentives of the plurality of incentive offers offering a bonus for sales of at least one product of the plurality of products, at least a subset of the plurality of incentive offers including different expiration dates after which a particular incentive is no longer available;
for each of the plurality of incentive offers, identify forecasted demand for an applicable product of the plurality of products;
compare forecasted demand for different products;
compare overall incentive for a particular number of different products with high forecasted demand relative to forecasted demand of the different products; and
generate and provide an alert to a user when forecasted demand for at least one of the plurality of products is higher than other products of the plurality of products before a particular expiration date expires and when the overall incentive if above an incentive threshold.

16. The system of claim 10, wherein the instructions being executable by the at least one processor to create past topological hierarchical decompositions for the first set of historical time subsets comprises the instructions being executable by the at least one processor to:
project the information to a first embedding based on at least one metric;
determine a first lowest cover resolution of the first embedding that identifies non-overlapping secondary coverings based on sets within one of the covers of the first embedding;
identify a branch point of a first connected-component network based on the non-overlapping secondary coverings;
generate subsets from the branch point based on the non-overlapping secondary coverings;
if a network generation threshold has not been met, then for each subset from the branch point, determine a second lowest cover resolution that identifies non-overlapping secondary coverings based on the sets within one of the covers of a particular subset to identify a new branch point and new subsets from that branch point of the first connected-component network;
for each leaf of the connected-component network, identify embeddings of a feature space and generate a local object embedding space using a transposition of segmented features with related objects;
add coordinates of objects within each leaf of the local object embedding to a data array;
project array data from the data array to a second embedding;
determine a third lowest cover resolution of the second embedding that identifies non-overlapping secondary coverings based on sets within one of the covers of the second embedding;
identify a branch point of a second connected-component network based on the non-overlapping secondary coverings;
generate subsets from the branch point based on the non-overlapping secondary coverings;
if a network generation threshold has not been met, then for each subset from the branch point, determine a second lowest cover resolution that identifies non-overlapping secondary coverings based on the sets within one of the covers of a particular subset to identify a new branch point and new subsets from that branch point of the second connected-component network; and
generate at least one past topological hierarchical decomposition.

17. The system of claim 10, the instructions being further executable by the at least one processor to:
generate secondary coverings by determining, for each set that has data within the cover, a centroid and determining a radius based on the centroid that covers at least that particular set.

18. The system of claim 17, wherein the centroid for a particular set is determined based on the data within that particular set.

19. A method comprising:
receiving information with temporal data, initial time, and a time unit, the temporal data including any information with time data over a duration;
generating historical time windows including a first set of historical time subsets each of a first length, and a second set of historical time subsets each of a second length, the second length being longer than the first length, the information contained in both the first set of historical time subsets being duplicated in the second set of historical time subsets, the first set of historical time subsets including a consecutive number of non-overlapping historical time subsets ending in the initial time, each of the first set of historical time subsets being of the first length equal to the time unit, the second set of historical time subsets including overlapping historical time subsets ending in the initial time, the first subset of the second set of historical time subsets ending at the initial time and the second subset of the second set of historical time subsets ending at the duration of a time unit before the initial time, the information contained in the first subset and the second subset of the second set of historical time subsets including at least one unit of duplicate information, the historical time windows including information being chronologically before the initial time;
generating future time windows including a first set of future time subsets each of the first length, the first set of future time subsets including a consecutive number of non-overlapping future time subsets beginning at the initial time, each of the first set of future time subsets being of the first length equal to the time unit, the first set of future time subsets including information being chronologically after the initial time;
creating past topological hierarchical decompositions for the first set of historical time subsets and the second set of historical time subsets;
creating future topological hierarchical decompositions for the first set of future time subsets;
creating a past directed graph adjacency array using weights derived from a distance as applied to embeddings from the past topological hierarchical decompositions, and creating a future directed graph adjacency array using weights derived from the distance as applied to embeddings from the future topological hierarchical decompositions;
generating a past window customer attention matrix identifying entity membership of groups across historical time subsets using the embeddings from the past topological hierarchical decompositions, and generating a future window customer attention matrix identifying the entity membership of groups across future time subsets using the embeddings from the future topological hierarchical decompositions;
performing matrix multiplication to multiply the past window customer attention matrix to the past directed graph adjacency array and a transpose of the past window customer attention matrix to create a past customer self-attention array;
performing the matrix multiplication to multiply the future window customer attention matrix to the future directed graph adjacency array and a transpose of the future window customer attention matrix to create a future customer self-attention array;
performing matrix multiplication of the past customer self-attention array to the future customer self-attention array; and
providing a dashboard forecasting demand after the initial time.
